(19) United States
(12) Patent Application Publication
(10) Pub. No.: US 2024/0344981 A1
(43) Pub. Date: Oct. 17, 2024

(54) SYSTEMS AND METHODS FOR SINGLE-MOLECULE FRET ANALYSIS LEVERAGING BAYESIAN NON-PARAMETRICS

(71) Applicant: Arizona Board of Regents on Behalf of Arizona State University, Tempe, AZ (US)

(72) Inventors: Steve Presse, Scottsdale, AZ (US); Ayush Saurabh, Tempe, AZ (US); Ioannis Sgouralis, Knoxville, TN (US); Mohamadreza Fazel, Temp, AZ (US); Matthew Safar, Phoenix, AZ (US)

(21) Appl. No.: 18/615,608

(22) Filed: Mar. 25, 2024

Related U.S. Application Data
(60) Provisional application No. 63/454,590, filed on Mar. 24, 2023.

(51) Int. Cl. G01N 21/64

(52) U.S. Cl. CPC G01N 21/6408; G01N 21/6456; G01N 2021/6441

(57) ABSTRACT

A unified conceptual framework for single molecule Förster Resonance Energy Transfer (smFRET) analysis of a macromolecular system from single photon arrivals leverages Bayesian nonparametrics. This unified framework addresses the following key physical complexities of an smFRET experiment, including: 1) fluorophore photophysics; 2) continuous time dynamics of the labeled system with large timescale separations between photophysical phenomena such as excited photophysical state lifetimes and events such as transition between system states; 3) unavoidable detector artefacts; 4) background emissions; 5) unknown number of system states; and 6) both continuous and pulsed illumination. In particular, a second order hidden Markov model (HMM) with Bayesian nonparametrics (BNP) are provided on account of items 1, 2 and 5, respectively.

### CROSS-REFERENCE TO RELATED APPLICATIONS

This is a U.S. Non-Provisional Patent Application that claims benefit to U.S. Provisional Patent Application Ser. No. 63/454,590 filed 24 Mar. 2023, which is herein incorporated by reference in its entirety.

### GOVERNMENT SUPPORT

This invention was made with government support under R01 GM130745 and R01 GM134426 awarded by the National Institutes of Health. The government has certain rights in the invention.

### FIELD

The present disclosure generally relates to molecule state and parameter estimation, and in particular, to a system and associated method for single molecule Förster Resonance Energy Transfer (smFRET) analysis from single photon arrivals leveraging Bayesian non-parametrics.

### BACKGROUND

smFRET is a widely used technique for studying kinetics of molecular complexes. However, smFRET data analysis methods currently require specifying a priori the dimensionality of the underlying physical model (the exact number of kinetic parameters). Such approaches are inherently limiting given the typically unknown number of physical configurations a molecular complex may assume.

It is with these observations in mind, among others, that various aspects of the present disclosure were conceived and developed.

### BRIEF DESCRIPTION OF THE DRAWINGS

The present patent or application file contains at least one drawing executed in color. Copies of this patent or patent application publication with color drawing(s) will be provided by the Office upon request and payment of the necessary fee.

FIG. 1 is a graphical representation showing example smFRET data collected at a donor channel and an acceptor channel over time;

FIG. 2A is a simplified diagram showing a system for smFRET analysis of macromolecular systems from single photon arrivals leveraging Bayesian nonparametrics (BNP-FRET);

FIG. 2B is a diagram showing a measurement model of the system of FIG. 2A when smFRET is conducted under continuous illumination;

FIG. 2C is a diagram showing a measurement model of the system of FIG. 2A when smFRET is conducted under pulsed illumination;

FIGS. 3A and 3B are a pair of graphical representations depicting random variables and parameters involved in generation of photon arrival data for smFRET experiments;

FIGS. 4A and 4B are a pair of graphical representations showing events for smFRET experiments over a pulsed illumination experiment pulse window;

FIG. 5 is graphical representation showing simulated data including a superstate trajectory generated using Gillespie algorithm for a system-FRET composite with two system states and three photophysical states;

FIG. 6 is a simplified diagram showing an example computing system for implementation of the systems outlined herein; and

FIGS. 7A-7C Tgare a series of process flow diagram showing a method for smFRET analysis of macromolecular systems from single photon arrivals leveraging Bayesian nonparametrics that can be applied by the system of FIGS. 2A-2C, where FIG. 7A shows a general process overview, FIG. 7B shows a sub-process for a sampling step applicable when smFRET is conducted under continuous illumination and FIG. 7C shows a sub-process for a sampling step applicable when smFRET is conducted under pulsed illumination.

Corresponding reference characters indicate corresponding elements among the view of the drawings. The headings used in the figures do not limit the scope of the claims.

### SUMMARY

A method outlined herein for smFRET analysis leveraging Bayesian Nonparametrics includes: accessing observation data indicative of interactions between a donor molecule and an acceptor molecule of a macromolecular complex; iteratively sampling a set of probability values associated with values of a set of model parameters from a measurement model; and jointly inferring, based on the set of probability values and the observation data, a set of most probable values of the set of model parameters that are associated with a highest likelihood of observing the observation data. The set of model parameters can include: a set of transition rates among superstates of a composite representing interactions between the macromolecular complex and FRET dyes; and a set of observed system states of the macromolecular complex.

The observation data can include time-series detector data indicative of photons having a wavelength within a first wavelength range captured at a first channel of a detector device and photons having a wavelength within a second wavelength range captured at a second channel of the detector device over time.

The method can further include: applying a Markov Chain Monte Carlo sampling scheme to iteratively sample probability values associated with values of the set of model parameters of the measurement model, the measurement model being constructed using a nonparametric Bayesian formulation of a system-FRET Master Equation descriptive of an evolution of the composite.

For continuous illumination (the macromolecular complex having been subjected to a continuous illumination scheme), the method can further include: iteratively sampling the set of transition rates using a Metropolis-Hastings sampling scheme; and determining the set of observed system states by sampling, for each load of a plurality of loads representing a hypothetical system state, a load value from a Bernoulli formulation of a conditional posterior probability distribution of the measurement model that jointly incorporates the set of transition rates and the plurality of loads.

For pulsed illumination (where the observation data further including photon arrival times corresponding with a plurality of illumination pulses applied to the macromolecular complex, where transitions between system states occur at a beginning of each illumination pulse), the method can further include: initializing a chain of transition probability values for a set of transition probabilities associated with a set of hypothetical system states from a Dirichlet process prior; sampling the transition probability values of the set of transition probabilities by directly sampling from a posterior probability distribution using a Gibbs sampling scheme; and selecting one or more hypothetical system states for inclusion in the set of observed system states based on the transition probability values.

The method can further include sampling a set of photophysical transition rates of the set of model parameters using a Metropolis-Hastings sampling scheme; and sampling a set of system state trajectories using a forward backward sampling procedure.

For sampling transition rates using Metropolis-Hastings, the method can include: initializing a chain of samples for each transition rate by drawing random values from a corresponding prior distribution for the transition rates; drawing, for an iteration of a plurality of iterations, a new value for the set of transition rates from a proposal distribution; determining, for the iteration, an acceptance probability associated with the new value; and accepting or rejecting the new value for inclusion in the set of transition rates based on the acceptance probability.

In a further aspect, a system outlined herein for smFRET analysis leveraging Bayesian Nonparametrics under continuous illumination includes: a processor in communication with a memory, the memory including instructions executable by the processor to: access observation data indicative of interactions between a donor molecule and an acceptor molecule of a macromolecular complex, the macromolecular complex having been subjected to a continuous illumination scheme; and iteratively sample a set of probability values associated with values of a set of model parameters from a measurement model. The set of model parameters can include a set of transition rates among superstates of a composite representing interactions between the macromolecular complex and FRET dyes. Further, the set of model parameters can include a load value for each load of a plurality of loads, the load value being sampled from a Bernoulli formulation of a conditional posterior probability distribution of the measurement model that jointly incorporates the set of transition rates and the plurality of loads, each load of the plurality of loads representing a hypothetical system state.

The memory can further include instructions executable by the processor to: determine a set of observed system states of the macromolecular complex based on load values for each load of the plurality of loads; and jointly infer, based on the set of probability values and the observation data, a set of most probable values of the set of model parameters that are associated with a highest likelihood of observing the observation data.

The observation data can include time-series detector data indicative of photons having a wavelength within a first wavelength range captured at a first channel of a detector device and photons having a wavelength within a second wavelength range captured at a second channel of the detector device over time.

The memory can further include instructions executable by the processor to: apply a Markov Chain Monte Carlo sampling scheme to iteratively sample probability values associated with values of the set of model parameters of the measurement model, the measurement model being constructed using a nonparametric Bayesian formulation of a system-FRET Master Equation descriptive of an evolution of the composite. This can include iteratively sampling the set of transition rates using a Metropolis-Hastings sampling scheme.

Load values being a first value indicate that a corresponding hypothetical system state is active and should be included in the set of observed system states. Load values being a second value indicate that a corresponding hypothetical system state is inactive and should be excluded from the set of observed system states.

In a further aspect, a system outlined herein for smFRET analysis leveraging Bayesian Nonparametrics under pulsed illumination includes: a processor in communication with a memory, the memory including instructions executable by the processor to: access observation data indicative of interactions between a donor molecule and an acceptor molecule of a macromolecular complex; and iteratively sample a set of probability values associated with values of a set of model parameters from a measurement model. The set of model parameters can include: a set of transition rates among superstates of a composite representing interactions between the macromolecular complex and FRET dyes; and a set of transition probability values for a set of transition probabilities associated with a set of hypothetical system states, sampled from a posterior probability distribution using a Gibbs sampling scheme.

The memory can further include instructions executable by the processor to: select one or more hypothetical system states for inclusion in a set of observed system states of the macromolecular complex based on the set of transition probability values; and jointly infer, based on the set of probability values and the observation data, a set of most probable values of the set of model parameters that are associated with a highest likelihood of observing the observation data.

The observation data can include time-series detector data indicative of photons having a wavelength within a first wavelength range captured at a first channel of a detector device and photons having a wavelength within a second wavelength range captured at a second channel of the detector device over time. In particular, the observation data can further include photon arrival times corresponding with a plurality of illumination pulses applied to the macromolecular complex, where transitions between system states occur at a beginning of each illumination pulse.

The memory can further include instructions executable by the processor to: apply a Markov Chain Monte Carlo sampling scheme to iteratively sample probability values associated with values of the set of model parameters of the measurement model, the measurement model being constructed using a nonparametric Bayesian formulation of a system-FRET Master Equation descriptive of an evolution of the composite.

The memory can further include instructions executable by the processor to: initialize a chain of transition probability values for the set of transition probabilities associated with the set of hypothetical system states from a Dirichlet process prior; and sample a set of system state trajectories using a forward backward sampling procedure.

In a further aspect, a non-transitory computer readable media includes instructions encoded thereon that are executable by a processor to: access observation data indicative of interactions between a donor molecule and an acceptor molecule of a macromolecular complex, the macromolecular complex having been subjected to a continuous illumination scheme; and iteratively sample a set of probability values associated with values of a set of model parameters from a measurement model. The set of model parameters can include a set of transition rates among superstates of a composite representing interactions between the macromolecular complex and FRET dyes. Further, the set of model parameters can include a load value for each load of a plurality of loads, the load value being sampled from a Bernoulli formulation of a conditional posterior probability distribution of the measurement model that jointly incorporates the set of transition rates and the plurality of loads, each load of the plurality of loads representing a hypothetical system state.

The non-transitory computer readable media can further include instructions executable by a processor to: determine a set of observed system states of the macromolecular complex based on load values for each load of the plurality of loads; and jointly infer, based on the set of probability values and the observation data, a set of most probable values of the set of model parameters that are associated with a highest likelihood of observing the observation data.

The observation data can include time-series detector data indicative of photons having a wavelength within a first wavelength range captured at a first channel of a detector device and photons having a wavelength within a second wavelength range captured at a second channel of the detector device over time.

The non-transitory computer readable media can further include instructions executable by a processor to: apply a Markov Chain Monte Carlo sampling scheme to iteratively sample probability values associated with values of the set of model parameters of the measurement model, the measurement model being constructed using a nonparametric Bayesian formulation of a system-FRET Master Equation descriptive of an evolution of the composite. This can include iteratively sampling the set of transition rates using a Metropolis-Hastings sampling scheme.

Load values being a first value indicate that a corresponding hypothetical system state is active and should be included in the set of observed system states. Load values being a second value indicate that a corresponding hypothetical system state is inactive and should be excluded from the set of observed system states.

In a further aspect, a non-transitory computer readable media includes instructions encoded thereon that are executable by a processor to: access observation data indicative of interactions between a donor molecule and an acceptor molecule of a macromolecular complex; and iteratively sample a set of probability values associated with values of a set of model parameters from a measurement model. The set of model parameters can include: a set of transition rates among superstates of a composite representing interactions between the macromolecular complex and FRET dyes; and a set of transition probability values for a set of transition probabilities associated with a set of hypothetical system states, sampled from a posterior probability distribution using a Gibbs sampling scheme.

The non-transitory computer readable media can further include instructions executable by a processor to: select one or more hypothetical system states for inclusion in a set of observed system states of the macromolecular complex based on the set of transition probability values; and jointly infer, based on the set of probability values and the observation data, a set of most probable values of the set of model parameters that are associated with a highest likelihood of observing the observation data.

The observation data can include time-series detector data indicative of photons having a wavelength within a first wavelength range captured at a first channel of a detector device and photons having a wavelength within a second wavelength range captured at a second channel of the detector device over time. In particular, the observation data can further include photon arrival times corresponding with a plurality of illumination pulses applied to the macromolecular complex, where transitions between system states occur at a beginning of each illumination pulse.

The non-transitory computer readable media can further include instructions executable by a processor to: apply a Markov Chain Monte Carlo sampling scheme to iteratively sample probability values associated with values of the set of model parameters of the measurement model, the measurement model being constructed using a nonparametric Bayesian formulation of a system-FRET Master Equation descriptive of an evolution of the composite.

The non-transitory computer readable media can further include instructions executable by a processor to: initialize a chain of transition probability values for the set of transition probabilities associated with the set of hypothetical system states from a Dirichlet process prior; and sample a set of system state trajectories using a forward backward sampling procedure.

### DETAILED DESCRIPTION

Various embodiments of a unified conceptual framework for single molecule Förster Resonance Energy Transfer (smFRET) analysis of macromolecular systems from single photon arrivals leveraging Bayesian nonparametrics, BNP-FRET. This unified framework addresses the following key physical complexities of an smFRET experiment, including:
1) fluorophore photophysics;
2) continuous time dynamics of a labeled macromolecular system with large timescale separations between photophysical phenomena such as excited photophysical state lifetimes and events such as transition between system states;
3) unavoidable detector artefacts;
4) background emissions;
5) unknown number of system states; and
6) both continuous and pulsed illumination.

These physical features necessarily demand a novel framework that extends beyond existing tools. The present disclosure outlines a second order hidden Markov model (HMM) and Bayesian nonparametrics (BNP) on account of items 1, 2 and 5 on the list, respectively.

This method finds and quantifies states in a molecule by looking at data from FRET experiments. The method uses new combination of tools from BNP in order to analyze the data. This method overcomes the model selection problems by treating the number of states as a parameter to be inferred. Furthermore this method gives more accurate results in a more transparent way.

### 1. FRET Methods, Goals, and Drawbacks

Förster Resonance Energy Transfer (FRET) has served as a spectroscopic ruler to study motion of components of a macromolecular system at the nanometer scale, and has revealed insight into intra- and intermolecular dynamics of proteins, nucleic acids, and their interactions. In particular, single molecule FRET (smFRET) experiments have been used to determine the pore size and opening mechanism of ion channels sensitive to mechanical stress in the membrane, the intermediate stages of protein folding, and the chromatin interactions modulated by the helper protein HP1α involved in allowing genetic transcription when the chromatin is tightly packed.

A typical FRET experiment involves labeling molecules of interest of the macromolecular system with donor and acceptor dyes such that the donor may transfer energy to the acceptor via dipole-dipole interaction when separated by distances of 2-10 nm. The donor, in turn, is illuminated by a laser in continuous or pulsating fashion to record a trace of photon arrival times, brightness values, and detection channels.

Upon excitation by the laser, a donor may emit a photon itself or transfer its energy non-radiatively to the acceptor which eventually relaxes to emit a photon of a different color. The distance dependence of this energy transfer is the key to using smFRET as a molecular ruler. Furthermore, this property directly manifests itself in the form of higher fraction of photons detected in the acceptor channel when the dyes are closer together.

The aim of smFRET is to capture on-the-fly changes of the macromolecular system in distance. However, this is often confounded by several sources of stochasticity which unavoidably obscure direct interpretation. These include:
1) the stochasticity inherent to photon arrival times;
2) a detector's probabilistic response to an incoming photon;
3) background emissions; and
4) fluorescent labels' stochastic photophysical properties.

Taken together, these problems necessarily contribute to uncertainty in the number of distinct system states visited by a labeled macromolecular system over the course of an experiment.

This disclosure delves into greater detail into items 2 and 4. In particular, item 2 pertains to questions of crosstalk, detector efficiency, dead time, dark current, and instrument response function (IRF) introducing uncertainty in excited photophysical state lifetime assessments.

Item 4 refers to a collection of effects including limited quantum yield and variable brightness due to blinking of dyes caused by nonradiative pathways, photobleaching or permanent deactivation of the dyes, spectral overlap between the donor and acceptor dyes which may result in direct excitation of the acceptors or leaking of photons into the incorrect channel, or a donor-acceptor pair's relative misalignment or positioning resulting in false signals and inaccurate characterization of the separation between labeled molecules.

Though the goal has always remained to analyze the rawest form of data, the reality of these noise properties has traditionally led to the development of approximate binned photon analyses. Binning is either achieved by directly binning photon arrivals when using single photon detectors or by integrating intensity over a few pixels when using widefield detectors.

While binned data analyses can be used to determine the number and connectivity of system states—by computing average FRET efficiencies over bin time windows and using them in turn to construct FRET efficiency histograms—they come at the cost of averaging dynamics existing below a time bin not otherwise easily accessible. They also eliminate information afforded by, say, the excited photophysical state lifetime in the case of pulsed illumination.

While histogram analyses are suited to infer static molecular properties, dynamics over binned time traces have also been extracted by supplementing these techniques with a hidden Markov model (HMM) treatment.

Using HMMs, histogram analyses techniques immediately face the difficulty of an unknown number of system states visited. Therefore, they require the number of system states as an input to deduce the kinetics between the hypothesized system states.

What is more, the histogram analysis' accuracy is determined by bin sizes where large bins may result in averaging of dynamics. Moreover, increasing bin size may lead to estimation of an excess number of system states. This artifact arises when a system appears to artificially spend more time in the system states below the bin size. To address these challenges, continuous time trajectories below the bin size must be inferred through, for example, the use of Markov jump processes while retaining a binned, i.e., discrete measurement model.

When single photon data is available, and to avoid the binning issues inherent to HMM analysis-and leverage, for example, direct noise properties of detectors known for single photon arrivals (e.g., IRF), and knowledge of excited photophysical state lifetimes available from pulsed illumination—single photon arrivals can be directly employed in the analysis. This, naturally, comes with added computational cost.

Often to help mitigate computational costs, further approximations on the system dynamics are often invoked such as assuming system dynamics to be much slower than FRET label excitation and relaxation rates. This approximation helps decouple photophysical and system (molecular) dynamics.

What is more, as they exist, the rigor of direct photon arrival analysis methods are further compromised to help reduce computational cost by treating detector features and background as preprocessing steps. In doing so, simultaneous and self-consistent inference of kinetics and other molecular features becomes unattainable.

Finally, all methods, whether relying on the analysis of binned photons or single photon arrival, suffer from the “model selection problem”. That is, the problem associated with identifying the number of system states are warranted by the data. More precisely, the problem associated with propagating the uncertainty introduced by items 1-4 into a probability over the models (i.e., system states). Existing methods for system state identification only provide partial reprieve.

For example, while FRET histograms identify peaks to intuit the number of system states, these peaks may provide unreliable estimates for a number of reasons:
1) fast transitions between system states may result in a blurring of otherwise distinct peaks or, counterintuitively, introduce more peaks;
2) system states may differ primarily in kinetics but not FRET efficiency; and
3) detector properties and background may introduce additional features in the histograms.

To address the model selection problem, overfitting penalization criteria (such as the Bayesian information criterion or BIC) or variational Bayesian approaches have been employed. Often, these model selection methods assume implicit properties of the system. For example, the BIC requires the assumption of weak independence between measurements (i.e., ideally independent identically distributed measurements and thus no Markov dynamics in state space) and a unique maximum in the likelihood, both of are violated in smFRET data. Furthermore, BIC and other such methods provide point estimates rather than full probabilities over system states ignoring uncertainty from items 1-4 propagated into model selection.

### 2. Present Systems and Methods

As such, there is a need to learn distributions over system states and kinetics of a macromolecular system warranted by the data and whose breadth is dictated by the sources of uncertainty discussed above. More specifically, to address model selection and build joint distributions over system states and their kinetics, the number of system states is treated as a random variable just as the current community treats smFRET kinetics as random variables. An objective of the present disclosure is therefore to obtain distributions over all unknowns (including system states and kinetics) while accounting for items 1-4. Furthermore, this must be achieved in a computationally efficient way avoiding, altogether, the draconian assumptions of existing in single photon analysis methods. In other words, there is a need to do more (by learning joint distributions over the number of system states alongside everything else) and it needs to cost less.

When learning distributions over unknowns, then it is convenient to operate within a Bayesian paradigm. Also, if the model (i.e., the number of system states) is unknown, then the model must further specialize to the Bayesian nonparametric (BNP) paradigm. BNPs directly address the model selection problem concurrently and self-consistently while learning the associated model's parameters and output full distributions over the number of system states and the other parameters.

In this disclosure, a description is provided of single photon smFRET analysis within the BNP paradigm addressing noise sources discussed above (items 1-4). In addition, specialized computational schemes are presented for both continuous and pulsed illumination for it to “cost less”.

Indeed, mitigating computational cost becomes critical especially with the added complexity of working within the BNP paradigm, warranting a detailed treatment of continuous and pulsed illumination analyses in two companion manuscripts.

To complement this theoretical framework, a suite of programs is also developed called BNP-FRET written in the compiled language Julia for high performance. These freely available programs allow for comprehensive analysis of single photon smFRET time traces on immobilized molecules obtained with a wide variety of experimental setups.

Section 2 presents a forward model which can be applied in practicality through an inverse strategy discussed herein. The inverse strategy in section 3 enables learning full posteriors within the BNP paradigm. Finally, multiple examples are presented by applying the method to simulated data sets across different parameter regimes. Experimental data are treated in two subsequent companion manuscripts.

The present novel concepts of the disclosure include information from the following publications:
Saurabh et al. (Ayush Saurabh, Matthew Safar, Ioannis Sgouralis, Mohamadreza Fazel and Steve Pressé. Single photon smFRET. I. theory and conceptual basis. bioRxiv, 2022.) (referred to herein as “Saurabh et al., 2022a”);
Saurabh et al. (Ayush Saurabh, Matthew Safar, Mohamadreza Fazel, Ioannis Sgouralis and Steve Pressé. Single photon smFRET. II. application to continuous illumination. bioRxiv, 2022.) (referred to herein as “Saurabh et al., 2022b”); and
Safar et al., 2022 (Matthew Safar, Ayush Saurabh, Bidyut Sarkar, Mohamadreza Fazel, Kunihiko Ishii, Tahei Tahara, Ioannis Sgouralis and Steve Pressé. Single photon smFRET. III. application to pulsed illumination. bioRxiv, 2022.) (referred to herein as “Safar et al.”);
which are herein incorporated by reference in their entireties. In particular, these publications include experimental results performed using the novel concepts outlined herein.

### 2.1 Preliminaries

Conventions and terms used herein are defined as follows:
1. A macromolecular complex under study is referred to herein as a macromolecular system,
2. The configurations through which a macromolecular system transitions are termed system states, typically labeled using σ,
3. FRET dyes undergo quantum mechanical transitions between photophysical states, typically labeled using ψ,
4. A macromolecular system-FRET combination is referred to herein as a composite,
5. A composite undergoes transitions among its superstates, typically labeled using ϕ,
6. Transition rates are typically labeled using λ,
7. The symbol Nis generally used to represent the total number of discretized time windows, typically labeled with n, and
8. The symbol wₙ is generally used to represent observations in the n-th time window.

Data collected from typical smFRET experiments analyzed by BNP-FRET is discussed here. In such experiments, donor and acceptor dyes labeling a macromolecular system can be excited using either continuous illumination, or pulsed illumination where short laser pulses arrive at regular time intervals. Moreover, acceptors can also be excited by nonradiative transfer of energy from an excited donor to a nearby acceptor.

Upon relaxation, both donor and acceptor can emit photons collected by single photon detectors. These detectors record the set of photon arrival times and detection channels. Arrival times are denoted by:

$$\{ {T}_{start} , {T}_{1} , {T}_{2} , {T}_{3} , … , {T}_{K} , {T}_{end} \}$$

and detection channels with:

$$\{ {c}_{1} , {c}_{2} , {c}_{3} , … , {c}_{K} \}$$

for a total number of K photons. In the equations above, Tₛₜₐᵣₜ and T_{end} are experiment's start and end times. Further, the strategy used to index the detected photons above is independent of the illumination setup used.

Throughout the experiment, photon detection rates from the donor and acceptor dyes vary as the distance between them changes, due to the kinetics of the macromolecular system. In cases where the distances form an approximately finite set, the macromolecular system can be treated as exploring a discrete system state space. The acquired FRET traces can then be analyzed to estimate the transition rates between these system states assuming a known model (i.e., known number of system states). This assumption of knowing the model a priori is lifted by providing nonparametric models that consider quantity of system states as a parameter to be learned.

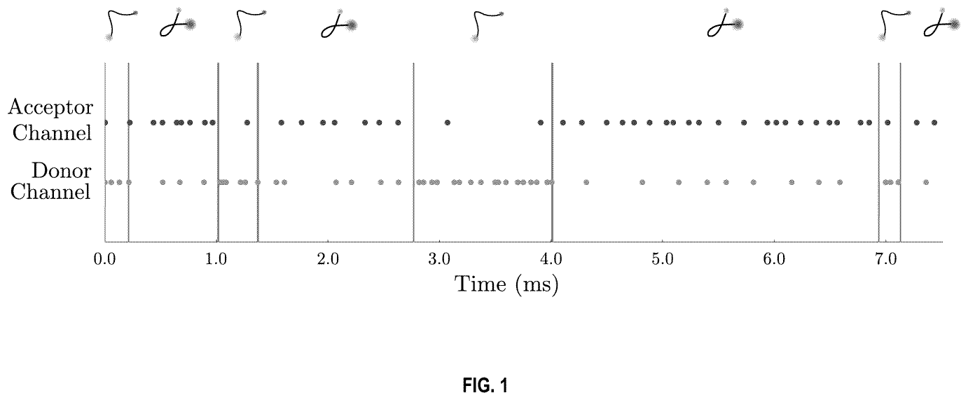

FIG. 1 shows a graphical representation showing smFRET data. For the experiments considered here, the kinetics along the reaction coordinate defined along the donor-acceptor distance are monitored using single photon arrival data. In FIG. 1, photon arrivals are represented by green dots for photons arriving into the donor channel and red dots for photons arriving in the acceptor channel. For the case where donor and acceptor label one molecule, a molecule's transitions between system states (coinciding with conformations) is reflected by the distance between labels measured by variations in detected photon arrival times and colors.

### 2.2—Computer-Implemented System

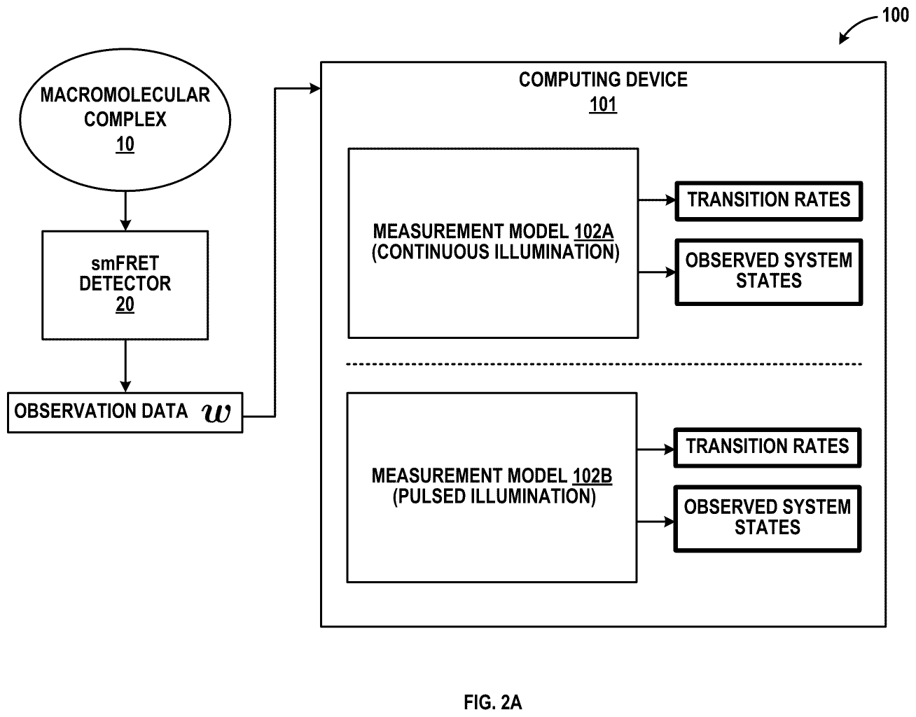

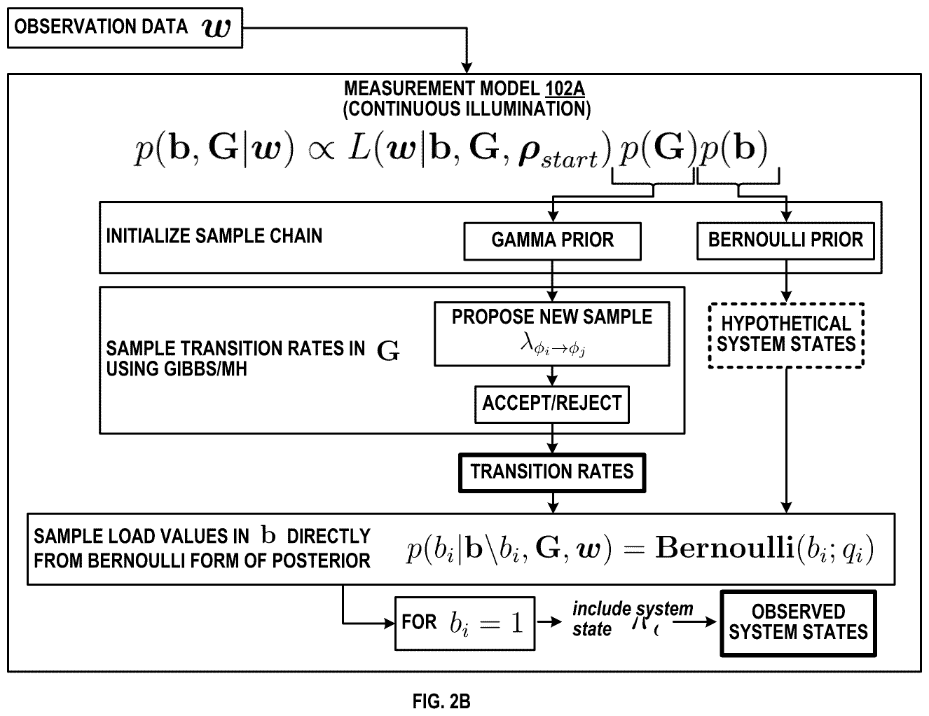

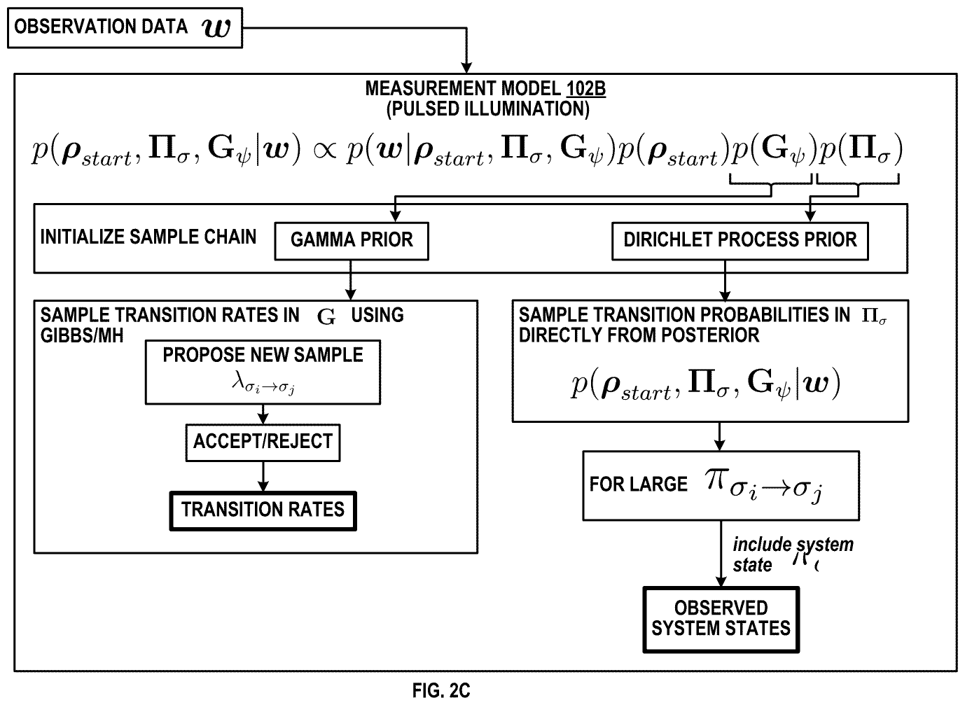

FIG. 2A shows a computer-implemented system (“system 100”) for conducting smFRET analysis leveraging Bayesian nonparametrics in the presence of uncertainties about the underlying model, including a quantity of observed system states. As discussed, interactions between donor molecules and acceptor molecules of a macromolecular complex 10 can be observed by an smFRET detector 20, which can include detector channels that record photons emitted by the macromolecular complex 10. The smFRET detector 20 produces observation data w provided to a computing device 101, which can include time-series detector data indicative of photons having a wavelength within a first wavelength range (e.g., a first color) captured at a first channel of a detector device and photons having a wavelength within a second wavelength range (e.g., a second color) captured at a second channel of the detector device over time.

The computing device 101 can access the observation data indicative of interactions between the donor molecule and the acceptor molecule of the macromolecular complex 10, and can apply a measurement model (e.g., measurement model 102A for continuous illumination or measurement model 102B for pulsed illumination) which can infer values of various model parameters based on the observations. These model parameters can include transition rates among superstates of a composite representing interactions between the macromolecular complex and FRET dyes, as well as observed system states of the macromolecular complex (as opposed to current methods which require a priori specification of a quantity of system states). In particular, each version of the measurement model applies a Markov Chain Monte Carlo sampling scheme to iteratively sample probability values associated with values of the set of model parameters of the measurement model, the measurement model being constructed using a nonparametric Bayesian formulation of a system-FRET Master Equation descriptive of an evolution of the composite.

Based on the outcome of the measurement model, the computing device 101 can jointly infer, based on the set of probability values and the observation data, a set of most probable values of the set of model parameters that are associated with the highest likelihood of observing the observation data.

Referring briefly to FIG. 2B, a first embodiment of the measurement model (measurement model 102A) is formulated for when smFRET has been conducted under a continuous illumination scheme.

Given the observation data, the measurement model 102A iteratively samples the set of transition rates using a Metropolis-Hastings sampling scheme. This includes initializing a chain of samples using a Gamma prior and sampling transition rates by proposing new samples from a proposal distribution and accepting or rejecting the samples based on an acceptance probability. Details about this step are further provided in Sections 3.1 and 3.2.1.

For inferring a set of observed system states of the macromolecular complex, the measurement model 102A determines the set of observed system states using a Bernoulli process prior, where a set of hypothetical system states are each represented by a load of a plurality of loads. In view of the transition rates, the measurement model 102A samples load values for the plurality of loads directly from a Bernoulli form of a posterior probability distribution further outlined in Section 3.2. For load values that are found to have a first value (e.g., where a load value is equal to 1), the associated hypothetical system state can be included in the set of observed system states. Otherwise, for load values that are found to have a second value (e.g., where a load value is equal to 0), the associated hypothetical system state is excluded from the set of observed system states.

Referring briefly to FIG. 2C, a second embodiment of the measurement model (measurement model 102B) is formulated for when smFRET has been conducted under a pulsed illumination scheme.

Given the observation data, the measurement model 102B iteratively samples the set of transition rates using a Metropolis-Hastings sampling scheme similar to that of the measurement model 102A of FIG. 2B for continuous illumination. This includes initializing a chain of samples using a Gamma prior and sampling (photophysical) transition rates by proposing new samples from a proposal distribution and accepting or rejecting the samples based on an acceptance probability. Details about this step are further provided in Sections 3.1 and 3.2.2.

For inferring a set of observed system states of the macromolecular complex, the measurement model 102B determines the set of observed system states using an Infinite Hidden Markov Model (iHMM) and Dirichlet process prior, where a set of hypothetical system states are each represented by a transition probability outlined in Section 3.2.2. In contrast with the measurement model 102A of FIG. 2B for continuous illumination, the measurement model 102B initially considers all hypothetical system states to be “active”, however, states with very low transition probabilities can be inferred as “inactive” and should be excluded from the set of observed system states. States with very high transition probabilities (or the “most visited”) transition probabilities can be inferred as “active” and should be included in the set of observed system states.

### 2.3 Likelihood

To derive the likelihood, consider the stochastic evolution of an idealized system, transitioning through a discrete set of total M_{σ} system states, {σ₁, . . . , σ_{M}_{_{σ}}}, labeled with a FRET pair having M_{ψ} discrete photophysical states, {ψ₁, . . . , ψ_{M}_{_{ψ}}}, representing the fluorophores in their ground, excited, triplet, blinking, photobleached, or other quantum mechanical states. The combined system-FRET composite now undergoes transitions between M_{ϕ}=M_{σ}×M_{ψ} superstates, {ϕ₁, . . . , ϕ_{M}_{_{ϕ}}}, corresponding to all possible ordered pairs (σⱼ, ψₖ) of the system and photophysical states. To be precise, ϕᵢ≡(σⱼ, ψₖ), where i=(j−1)M_{ψ}+k.

Assuming Markovianity (memorylessness) of transitions among superstates, the probability of finding the composite in a specific superstate at a given instant evolves according to the master equation:

$$\frac{d ρ ( t )}{d t} = ρ ( t ) G , \qquad ( 1 )$$

where the row vector ρ(t) of length M_{ϕ} has elements coinciding with probabilities for finding the system-FRET composite in a given superstate at time t. More explicitly, defining the photophysical portion of the probability vector ρ(t) corresponding to system state σᵢ as

$${ρ}_{{σ}_{I}} ( t ) = [ \begin{matrix}{ρ}_{{σ}_{i} , {ψ}_{1}} ( t ) & {ρ}_{{σ}_{i} , {ψ}_{2}} ( t ) & ⋯ & {ρ}_{{σ}_{i} , {ψ}_{{M}_{σ}}}\end{matrix} ] ,$$

ρ(t) can be written as

$$ρ ( t ) = [ \begin{matrix}{ρ}_{{σ}_{1}} ( t ) & {ρ}_{{σ}_{2}} ( t ) & ⋯ & {ρ}_{{σ}_{{M}_{σ}}} ( t )\end{matrix} ] .$$

Furthermore, in the master equation above, G is the generator matrix of size M_{ϕ}×M_{ϕ} populated by all transition rates λ_{ϕ}_{ᵢ}_{→ϕ}_{ⱼ} between superstates.

Each diagonal element of the generator matrix G corresponds to self-transitions and is equal to the negative sum of the remaining transition rates within the corresponding row. That is,

$${λ}_{{ϕ}_{i} \to {ϕ}_{i}} = - {\sum }_{j \neq i} {λ}_{{ϕ}_{i} \to {ϕ}_{j}} .$$

This results in zero row-sums, assuring that ρ(t) remains normalized at all times as described later in more detail (see Eq. 5). Furthermore, for simplicity, the present disclosure assumes no simultaneous transitions among system states and photophysical states as such events are rare (although the incorporation of these events in the model may be accommodated by expanding the superstate space). This assumption results in λ_{(ψ}_{ᵢ}_{,σ}_{ⱼ}_{)→(ψ}_{ₗ}_{,σ}_{ₘ}₎=0 for simultaneous i≠l and i≠m, which allows us to simplify the notation further. That is, λ_{(ψ}_{ᵢ}_{,σ}_{ⱼ}_{)→(ψ}_{ᵢ}_{,σ}_{ₖ}₎≡λ_{σ}_{ⱼ}_{,σ}_{ₖ}₎ (for any i) and λ_{(ψ}_{ᵢ}_{,σ}_{ⱼ}_{)→(ψ}_{ₖ}_{,σ}_{_{j,}}₎≡λ_{σ}_{ⱼ}_{,ψ}_{ᵢ}_{→ψ}_{ₖ} (for any j). This leads to the following form for the generator matrix containing blocks of exclusively photophysical and exclusively system transition rates, respectively

$$G = [ \begin{matrix}{G}_{{σ}_{1}}^{ψ} - {\sum }_{j \neq 1} {λ}_{{σ}_{1} \to {σ}_{j}} 𝕀 & {λ}_{{σ}_{1} \to {σ}_{2}} 𝕀 & ⋯ & {λ}_{{σ}_{1} \to {σ}_{{M}_{σ}}} 𝕀 \\ {λ}_{{σ}_{2} \to {σ}_{1}} 𝕀 & {G}_{{σ}_{2}}^{ψ} - {\sum }_{j \neq 2} {λ}_{{σ}_{2} \to {σ}_{j}} 𝕀 & ⋯ & {λ}_{{σ}_{2} \to {σ}_{{M}_{σ}}} 𝕀 \\ ⋮ & ⋮ & ⋱ & ⋮ \\ {λ}_{{σ}_{{M}_{σ}} \to {σ}_{1}} 𝕀 & {λ}_{{σ}_{{M}_{σ}} \to {σ}_{2}} 𝕀 & ⋯ & {G}_{{σ}_{{M}_{σ}}}^{ψ} - {\sum }_{j \neq {M}_{σ}} {λ}_{{σ}_{{M}_{σ}} \to {σ}_{j}} 𝕀\end{matrix} ] \qquad ( 2 )$$

where the matrices on the diagonal G_{σ}_{ᵢ}^{ψ} are the photophysical parts of the generator matrix for a system found in the σᵢ system state. Additionally, [symbol] is the identity matrix of size M_{ψ}.

For later convenience, the system transition rates λ_{σ}_{→σ}_{ⱼ} in Eq. 2 can be organized as a matrix referred to herein as a system generator matrix.

$${G}_{σ} = [ \begin{matrix}* & {λ}_{{σ}_{1} \to {σ}_{2}} & {λ}_{{σ}_{1} \to {σ}_{3}} & ⋯ & {λ}_{{σ}_{1} \to {σ}_{{M}_{σ}}} \\ {λ}_{{σ}_{2} \to {σ}_{1}} & * & {λ}_{{σ}_{2} \to {σ}_{3}} & ⋯ & {λ}_{{σ}_{2} \to {σ}_{{M}_{σ}}} \\ {λ}_{{σ}_{3} \to {σ}_{1}} & {λ}_{{σ}_{3} \to {σ}_{2}} & * & ⋯ & {λ}_{{σ}_{3} \to {σ}_{{M}_{σ}}} \\ ⋮ & ⋮ & ⋮ & ⋱ & ⋮ \\ {λ}_{{σ}_{{M}_{σ}} \to {σ}_{1}} & {λ}_{{σ}_{{M}_{σ}} \to {σ}_{2}} & {λ}_{{σ}_{{M}_{σ}} \to {σ}_{3}} & ⋯ & *\end{matrix} ] \qquad ( 3 )$$

Moreover, the explicit forms of G_{σ}_{ᵢ}^{ψ} in Eq. 2 depend on the photophysical transitions allowed in the model. For instance, if the FRET pair is allowed to go from its ground photophysical state (ψ₁) to the excited donor (ψ₂) or excited acceptor (ψ₃) states only, the matrix is given as

$${G}_{{σ}_{i}}^{ψ} = [ \begin{matrix}* & {λ}_{{σ}_{i} , {ψ}_{1} \to {ψ}_{2}} & {λ}_{{σ}_{i} , {ψ}_{1} \to {ψ}_{3}} \\ {λ}_{{σ}_{i} , {ψ}_{2} \to {ψ}_{1}} & * & {λ}_{{σ}_{i} , {ψ}_{2} \to {ψ}_{3}} \\ {λ}_{{σ}_{i} , {ψ}_{3} \to {ψ}_{1}} & 0 & *\end{matrix} ] = [ \begin{matrix}* & {λ}_{ex} & {λ}_{direct} \\ {λ}_{d} & * & {λ}_{{σ}_{i}}^{FRET} \\ {λ}_{a} & 0 & *\end{matrix} ] , \qquad ( 4 )$$

where the * along the diagonal represents the negative row-sum of the remaining elements, λₑₓ is the excitation rate, λ_{d} and λₐ are the donor and acceptor relaxation rates, respectively, and λ_{direct} is direct excitation of the acceptor by a laser, and λ_{σ}_{ᵢ}^{FRET} is the donor to acceptor FRET transition rate when the system is in its i-th system state. Note that only FRET transitions depend on the system states (identified by dye-dye separations) and correspond to FRET efficiencies given by

$${ε}_{{σ}_{i}}^{F R E T} = \frac{{λ}_{{σ}_{i}}^{F R E T}}{{λ}_{{σ}_{i}}^{F R E T} + {λ}_{d}} ,$$

where the ratio on the right hand side represents the fraction of FRET transitions among all competing transitions out of an excited donor, that is, the fraction of emitted acceptor photons among total emitted photons.

With the generator matrix at hand, the present disclosure now outlines solutions to the master equation of Eq. 1. Due to its linearity, the master equation accommodates the following analytical solution:

$$ρ ( t ) = ρ ( {t}_{0} ) exp ( ( t - {t}_{0} ) G ) ≡ ρ ( {t}_{0} ) Π ( t - {t}_{0} ) , \qquad ( 5 )$$

illustrating how the probability vector ρ(t) arises from the propagation of the initial probability vector at time t₀ by the exponential of the generator matrix (the propagator matrix Π(t−t₀)). The exponential maps the transition rates λ_{ϕ}_{ᵢ}_{→ϕ}_{ⱼ}, in the generator matrix to their corresponding transition probabilities π_{ϕ}_{ᵢ}_{→ϕ}_{ⱼ}, populating the propagator matrix. The zero row-sums of the generator matrix guarantee that the resulting propagator matrix is stochastic (i.e., has rows of probabilities that sum to unity,

$${\sum }_{j} {π}_{{ϕ}_{i} \to {ϕ}_{j}} = 1 〉 .$$

Example I: State Space and Generator Matrix

```
For a molecule undergoing transitions between its two conformations,
consider M_{σ} = 2 system states given as {σ₁, σ₂}. The photophysical states
labeling this of the FRET pair molecule are defined according to whether
the donor or acceptor are excited. Denoting the ground state by G and
excited state by E, all photophysical states of the FRET pair can be
written as {ψ₁ = (G, G), ψ₂ = (E, G), ψ₃ = (G, E)}, where the first element
in the ordered pair represents the donor state. Further, here, assume no
simultaneous excitation of the donor and acceptor owing to its rarity.
  Next, construct the superstate space with M_{σ} = 6 ordered pairs
{ϕ₁ = (ψ₁, σ₁), ϕ₂ = (ψ₂, σ₁), ϕ₃ = (ψ₃, σ₁), ϕ₄ = (ψ₁, σ₂),
ϕ₅ = (ψ₂, σ₂), ϕ₆ = (ψ₃, σ₂), }.
Finally, the full generator matrix for this setup reads
$\begin{matrix}G = [ \begin{matrix}{G}_{{σ}_{1}}^{ψ} - {λ}_{{σ}_{1} \to {σ}_{2}} 𝕀 & {λ}_{{σ}_{1} \to {σ}_{2}} 𝕀 \\ {λ}_{{σ}_{2} \to {σ}_{1}} 𝕀 & {G}_{{σ}_{2}}^{ψ} - {λ}_{{σ}_{2} \to {σ}_{1}} 𝕀\end{matrix} ] \\ = [ \begin{matrix}* & {λ}_{ex} & {λ}_{direct} & {λ}_{{σ}_{1} \to {σ}_{2}} & 0 & 0 \\ {λ}_{d} & * & {λ}_{{σ}_{1}}^{FRET} & 0 & {λ}_{{σ}_{1} \to {σ}_{2}} & 0 \\ {λ}_{a} & 0 & * & 0 & 0 & {λ}_{{σ}_{1} \to {σ}_{2}} \\ {λ}_{{σ}_{2} \to {σ}_{1}} & 0 & 0 & * & {λ}_{ex} & {λ}_{direct} \\ 0 & {λ}_{{σ}_{2} \to {σ}_{1}} & 0 & {λ}_{d} & * & {λ}_{{σ}_{2}}^{FRET} \\ 0 & 0 & {λ}_{{σ}_{2} \to {σ}_{1}} & {λ}_{a} & 0 & *\end{matrix} ]\end{matrix} .$
Both here, and in similar example boxes that follow, values for rates are
chosen based on those commonly encountered in experiments. Consider
a laser exciting a donor at rate λₑₓ = 10 ms⁻¹. Next, suppose that the
molecule switches between system states
σ₁ and σ₂ at rates λ_{σ}_{₁}_{→σ}_{₂} = 2.0 ms⁻¹ and λ_{σ}_{₁}_{→σ}_{₂} = 1 ms⁻¹.
  Furthermore, assuming typical lifetimes of 3.6 ns and 3.5 ns for
the donor and acceptor dyes, their relaxation rates are, respectively,
λ_{d} = 1/3.6 ns⁻¹ and λₐ = 1/3.5 ns⁻¹. Also assume that there is no direct
excitation of the acceptor and thus λ_{direct} = 0. Next, choose FRET
efficiencies of 0.2 and 0.9 for the two system states resulting in
λ_{σ}_{₁}^{FRET} = λ_{d}/4 = 0.06 ns⁻¹ and λ_{σ}_{₂}^{FRET} = 9λ_{d} = 2.43 ns⁻¹.
Finally, these values lead to the following generator matrix (in ms⁻¹ units)
$G = [ \begin{matrix}- 12 & 10. & 0 & 2. & 0. & 0. \\ 277000 & - 347002 & 70000 & 0. & 2. & 0. \\ 285000 & 0. & - 285002 & 0. & 0. & 2. \\ 1. & 0. & 0. & - 11 & 10. & 0 \\ 0. & 1. & 0. & 277000 & - 2777001 & 2500000 \\ 0. & 0. & 1. & 285000 & 0. & - 285001\end{matrix} ]$
```

After describing the generator matrix and deriving the solution to the master equation, the present disclosure continues by explaining how to incorporate observations into a likelihood.

In the absence of observations, any transition among the set of superstates are unconstrained. However, when monitoring the system using suitable detectors, observations rule out specific transitions at the observation time. For example, ignoring background for now, the detection of a photon from a FRET label identifies a transition from an excited photo-physical state to a lower energy photophysical state of that label. On the other hand, no photon detected during a time period indicates the absence of radiative transitions or the failure of detectors to register such transition. Consequently, even periods without photon detections are informative in the presence of a detector. In other words, observations from a single photon smFRET experiment are continuous in that they are defined at every point in time.

Additionally, since smFRET traces report radiative transitions of the FRET labels at photon arrival times, uncertainty remains about the occurrences of unmonitored transitions (e.g., between system states). Put differently, smFRET traces (observations) only partially specify superstates at any given time.

Now, to compute the likelihood for such smFRET traces, those probabilities must be summed over all trajectories across superstates (superstate trajectories) consistent with a given set of observations. Assuming the system ends in superstate ϕᵢ at T_{end}, this sum over all possible trajectories can be very generally given by the element of the propagated vector ρ(T_{end}) corresponding to superstate ϕᵢ. Therefore, a general likelihood may be written as

$$L = p ( {ϕ}_{i} ) = {[ ρ ( {T}_{e n d} ) ]}_{i} . \qquad ( 6 )$$

However, as the final superstate at time T_{end} is usually unknown, it is important to marginalize (sum) over the final superstate to obtain the following likelihood

$$L = {\sum }_{i = 1}^{{M}_{ϕ}} p ( {ϕ}_{i} ) = ρ ( {T}_{e n d} ) {ρ}_{n orm}^{T} , \qquad ( 7 )$$

where all elements of the vector ρₙₒᵣₘ are set to 1 as a means to sum the probabilities in vector ρ(T_{end}). In the following sections, the present disclosure describes how to obtain concrete forms for these general likelihoods.

### 2.3.1 Absence of Observations

For pedagogical reasons, it is helpful to first look at the trivial case where a system-FRET composite evolves but no observations are made (due to a lack, say, of detection channels). In this case, all allowed superstate trajectories are possible between the start time of the experiment, Tₛₜₐᵣₜ, and end, T_{end}. This is because the superstate cannot be specified or otherwise restricted at any given time by observations previously explained. Consequently, the probability vector ρ(t) remains normalized throughout the experiment as no superstate trajectory is excluded. As such, the likelihood is given by summing over probabilities associated to the entire set of trajectories, that is,

$$L = p ( {T}_{1} , {e}_{1} ) , … , ( {T}_{K} , {e}_{K} ) \vert G = ρ ( {T}_{start} ) Π ( {T}_{e n d} - {T}_{start} ) {ρ}_{n o r m}^{T} = ρ ( {T}_{e n d} ) {ρ}_{n o r m}^{T} = 1 , \qquad ( 8 )$$

where {e₁, . . . e_{K}} are the emission times of all emitted photons, not recorded due to lack of detection channels and thus not appearing on the right hand side of the expression.

In what follows, the present disclosure describes how the probability vector ρ(t) does not remain normalized as it evolves to ρ(T_{end}) when detectors partially collapse knowledge of the occupied superstate during the experiment. This results in a likelihood smaller than one. This is applied for the conceptually simpler case of continuous illumination for now.

### 2.3.2 Introducing Observations

To compute the likelihood when single photon detectors are present, start by defining a measurement model where the observation at a given time is dictated by ongoing transitions and detector features (e.g., crosstalk, detector efficiency). As discussed in more detail later, if the evolution of a system can be described by defining its states at a discrete time points and these states are not directly observed, and thus hidden, then this measurement model adopts the form of a hidden Markov Model (HMM). Here, Markovianity arises when a given hidden state only depends on its immediate preceding hidden state. In such HMMs, an observation at a given time is directly derived from the concurrent hidden state.

As an example of an HMM, for binned smFRET traces, an observation is often approximated to depend only on the current hidden state. However, contrary to such a naive HMM, an observation in a single photon setup in a given time period depends on the current superstate and the immediate previous superstate. This naturally enforces a second order structure on the HMM where each observed random variable depends on two super-states as demonstrated herein. A similar HMM structure was noted previously to model a fluorophore's photo switching behavior.

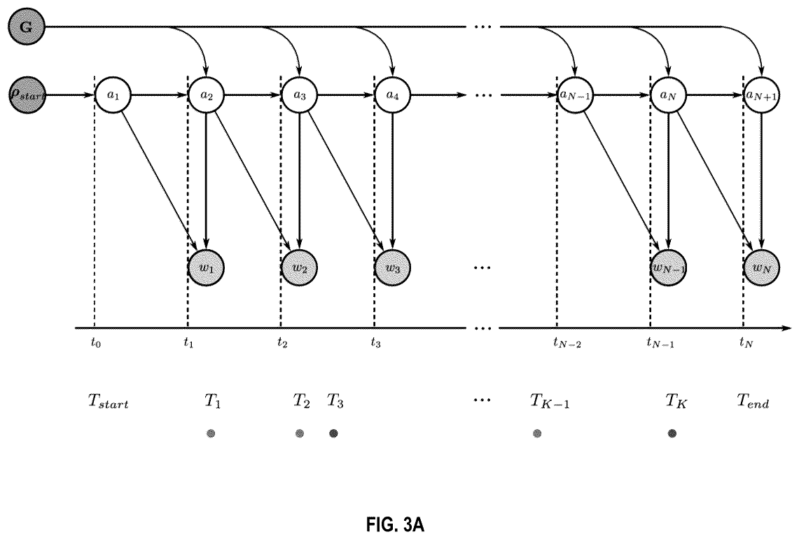

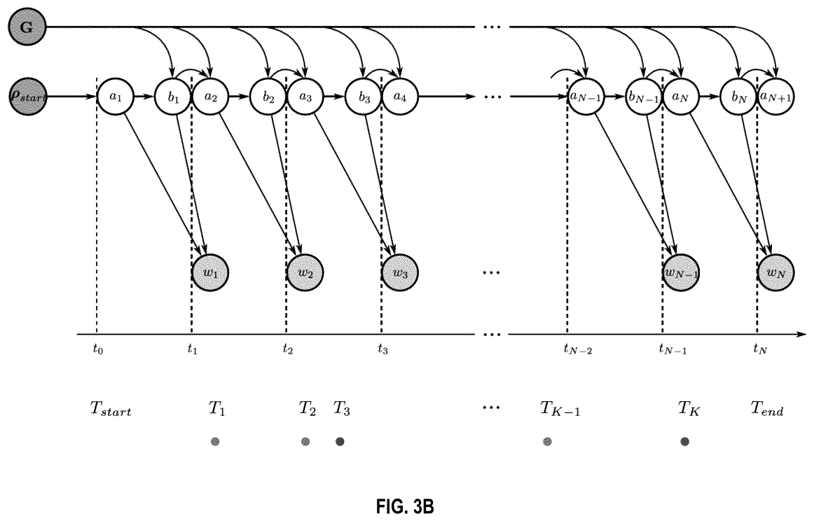

Now, in order to address this observation model, the experiment's time duration can be divided into N windows of equal size, ϵ=(T_{end}−Tₛₜₐᵣₜ)/N. The continuum limit ϵ→0 will eventually be applied to recover the original system as described by the master equation. In addition, the present disclosure also contemplates summing over all possible transitions between superstates within each window. These windows are marked by the times (see FIG. 3A)

$$\{ {t}_{0} , {t}_{1} , {t}_{2} , … , {t}_{N} \} ,$$

where the n-th window is given by (tₙ₋₁, tₙ) with t₀=Tₛₜₐᵣₜ and t_{N}=T_{end}. Corresponding to each time window, observations include:

$$w = \{ {w}_{1} , {w}_{2} , {w}_{3} , … , {w}_{N} \} ,$$

where wₙ=∅ if no photons are detected and w={(Tₙ⁽¹⁾, cₙ⁽¹⁾), (Tₙ⁽²⁾, cₙ⁽²⁾), . . . } otherwise, with the j-th photon in a window being recorded by the channel cₙ^{(j)} at time Tₙ^{(j)}. Note here that observations in a time window, being a continuous quantity, allow for multiple photon arrivals or none at all.

As mentioned earlier, each of these observations originate from the evolution of the superstate. Therefore, superstates occupied at the beginning of each window are defined as

$$\{ {a}_{1} , {a}_{2} , {a}_{3} , … , {a}_{N - 1} , {a}_{N} , {a}_{N + 1} \} ,$$

where aₙ is the superstate at the beginning of the n-th time window as shown in FIG. 3A. The framework described here can be employed to compute the likelihood. However, the second order structure of the HMM leads to complications in these calculations. In the rest of this section, the present disclosure first illustrates the mentioned complication using a simple example and then describes a solution to this issue.

Example II: Naive Likelihood Computation

Here, the likelihood is calculated for the two state system described earlier. For
simplicity alone, the likelihood calculation is applied for a time period spanning the first
two time windows (N = 2) in FIG. 3A. Within this period the system-FRET composite
evolves from superstate a₁ to a₃ giving rise to observations w_{1:2}. The likelihood for such
a setup is typically obtained using a recursive strategy by marginalizing over
superstates a_{1:3} (summing over all possible superstate trajectories)
$\begin{matrix}L = p ( {w}_{1 : 2} \vert G , {ρ}_{start} ) = {\sum }_{{a}_{1 : 3}} p ( {w}_{1 : 2} , {a}_{1 : 3} \vert G , {ρ}_{start} ) \\ = {\sum }_{{a}_{1 : 3}} p ( {w}_{1 : 2} , {a}_{1 : 3} \vert G , {ρ}_{start} ) p ( ( {w}_{1} , {a}_{1 : 3} \vert G , {ρ}_{start} ) ) \\ = {\sum }_{{a}_{1 : 3}} p ( {w}_{2} \vert {a}_{2 : 3} , G ) p ( {w}_{1} \vert {a}_{1 : 2} , G ) p ( ( {a}_{1 : 3} \vert G , {ρ}_{start} ) ) .\end{matrix}$
Here, the chain rule of probabilities is applied in each step. Moreover, in the last step,
the parameters that are directly connected to the random variable on the left are
retained in each term, as shown by arrows in FIG. 3A.
Now, for the two system state example, aₙ can be any of the six superstates
ϕ_{1:6}(M_{ϕ} = 6) given earlier. As such, the sum above includes M_{ϕ}^{N+1} = 6³ terms for such
a simple example. For a large number of time windows, computing this sum becomes
prohibitively expensive. Therefore, it is common to use a recursive approach to find the
likelihood, only requiring M_{ϕ}² (N + 1) operations, as described in the next section of the
present disclosure. However, due to the HMM′s second order structure, the two first
terms (involving observations) in the above sum are conditioned on a mutual superstate
a₂ which forbids recursive calculations.

After describing the issue in computing the likelihood due to the second order structure of the HMM, the present disclosure now describe a solution to this problem. As such, to simplify the likelihood calculation, the present disclosure temporarily introduces superstates bₙ at the end of n-th window separated from superstate aₙ₊₁ at the beginning of (n+1)-th window by a short time τ as shown in FIG. 3B during which no observations are recorded (inactive detectors). This procedure enables conveniently removal of dependency of consecutive observations on a mutual superstate. That is, consecutive observations wₙ and wₙ₊₁ now do not depend on a common superstate aₙ₊₁, but rather on separated (aₙ, bₙ) pairs; see FIG. 3B. The sequence of superstates now looks like (see FIG. 3B)

$$\{ {a}_{1} , {b}_{1} , {a}_{2} , {b}_{2} , {a}_{3} , {b}_{3} , … , {a}_{N - 1} , {b}_{N - 1} , {a}_{N} , {b}_{N} , {a}_{N + 1} \} , \qquad ( 9 )$$

which now permits a recursive strategy for likelihood calculation as described in the next section. Furthermore, the τ→0 limit can eventually be applied to obtain the likelihood of the original HMM with the second order structure.

### 2.3.3 Recursion Formulas

The analysis outlined above provides the means to compute the terminal probability vector ρ_{end}=ρ(T_{end}) by evolving the initial vector ρₛₜₐᵣₜ=ρ(Tₛₜₐᵣₜ). This is most conveniently achieved by recursively marginalizing (summing) over all superstates in Eq. 9 backwards in time, starting from the last superstate a_{N+1} as follows

$$L = p ( {w}_{1 : N} \vert G , {ρ}_{start} ) = {\sum }_{{a}_{N + 1}} p ( {w}_{1 : N} , {a}_{N + 1} \vert G , {ρ}_{start} ) = {\sum }_{{a}_{N + 1}} {𝒜}_{N + 1} {ρ}_{norm}^{T} , \qquad ( 10 )$$

where [symbol] _{N+1}(a_{N+1}) are elements of the vector [symbol] _{N+1} of length M_{ϕ}, commonly known as a filter. Moving backwards in time, the filter at the beginning of the nth time window, [symbol] ₙ (aₙ₊₁), is related to the filter at the end of the nth window, [symbol] ₙ (bₙ), due to Markovianity, as follows

$${𝒜}_{n + 1} ( {a}_{n + 1} ) = p ( {w}_{1 : n} , {a}_{n + 1} \vert G , {ρ}_{start} ) = {\sum }_{{b}_{n}} p ( {a}_{n + 1} \vert {b}_{n} , G ) {β}_{n} ( {b}_{n} ) , \qquad ( 11 )$$

or in matrix notation as

$${𝒜}_{n + 1} = {ℬ}_{n} {\tilde{Π}}_{n} ,$$

where p(aₙ₊₁|bₙ) are the elements of the transition probability matrix \tilde{Π}ₙ described in the next section. Again due to Markovianity, the filter at the end of the nth window, [symbol] ₙ (bₙ), is related to the filter at the beginning of the same time window, [symbol] ₙ (aₙ), as

$${ℬ}_{n} ( {b}_{n} ) = p ( {w}_{1 : n - 1} , {b}_{n} \vert G , {ρ}_{start} ) = {\sum }_{{a}_{n}} p ( {w}_{n} \vert {a}_{n} , {b}_{n} , G ) p ( {b}_{n} \vert {a}_{n} , G ) {𝒜}_{n} ( {a}_{n} ) , \qquad ( 12 )$$

or in matrix notation as

$${ℬ}_{n} = {𝒜}_{n} {Π}_{n}^{( r )} ,$$

where the terms p(wₙ|aₙ, bₙ, G)p(bₙ|aₙ, G) populate the transition probability matrix Πₙ^{(r)} described in the next section. Here, the superscript (r) denotes that elements of this matrix include observation probabilities. Note that the last filter in the recursion formula, [symbol] ₁, is equal to starting probability vector ρₛₜₐᵣₜ itself.

### 2.3.4 Reduced Propagators

To derive the different terms in the recursive filter formulas, note that the transition probabilities p(aₙ|bₙ₋₁, G) and p(bₙ|aₙ, G) do not involve observations. As such, the full propagator can be used as follows

$$p ( {b}_{n} \vert {a}_{n} , G ) = {( Π )}_{{a}_{n} \to {b}_{n}} = {( exp ( ( ϵ - τ ) G ) )}_{{a}_{n} \to {b}_{n}}$$

$$and$$

$$p ( {a}_{n} \vert {b}_{n - 1} , G ) = {( \tilde{Π} )}_{{b}_{n - 1} \to {a}_{n}} = {( exp ( τ G ) )}_{{b}_{n - 1} \to {a}_{n}} ,$$

respectively. On the other hand, the term p(wₙ|aₙ, bₙ, G) includes observations which results in modification to the propagator by ruling out a subset of transitions. For instance, observation of a photon momentarily eliminates all nonradiative transitions. The modifications now required can be structured into a matrix Dₙ of the same size as the propagator with elements (Dₙ)ₐ_{ₙ}_{→b}_{ₙ}=p(wₙ|aₙ, bₙ, G). All such matrices are referred to herein as detection matrices. The product p(wₙ|aₙ, bₙ, G) p(bₙ|aₙ, G) in Eq. 12 can now be written as

$${( {Π}_{n}^{( r )} )}_{{a}_{n} \to {b}_{n}} = {( Π )}_{{a}_{n} \to {b}_{n}} \times {( {D}_{n} )}_{{a}_{n} \to {b}_{n}} ,$$

relating the modified propagator (termed reduced propagator and distinguished by the superscript (r) hereafter) (Πₙ^{(r)})ₐ_{ₙ}_{→b}_{ₙ} in the presence of observations to the full propagator (no observations). Plugging in the matrices introduced above into the recursive filter formulas (Eqs. 11-12), in matrix notation:

$${𝒜}_{n + 1} = {ℬ}_{n} \tilde{Π} = {ℬ}_{n} exp ( ( ϵ - τ ) G ) \qquad ( 13 )$$

$${ℬ}_{n} = {𝒜}_{n} {Π}_{n}^{( r )} = {𝒜}_{n} ( exp ( ϵ G ) ⊙ {D}_{n} ) ,$$

where the symbol ⊙ represents element-by-element product of matrices. Here, however, the detection matrices cannot yet be computed analytically as the observations wₙ allow for an arbitrary number of transitions within the finite time window (tₙ₋₁, tₙ). However, they become manageable in the limit that the time windows become vanishingly small, as demonstrated further herein.
2.3.5 Likelihood for the HMM with Second Order Structure

Now, inserting the matrix expressions for filters of Eq. 13 into the recursive formula likelihood Eq. 10:

$$L = {\sum }_{{a}_{N + 1}} {ρ}_{start} {Π}_{1}^{( r )} \tilde{Π} {Π}_{2}^{( r )} \tilde{Π} {Π}_{3}^{( r )} \tilde{Π} … {Π}_{N - 1}^{( r )} \tilde{Π} {Π}_{N}^{( r )} = {ρ}_{start} {Π}_{1}^{( r )} \tilde{Π} {Π}_{2}^{( r )} \tilde{Π} {Π}_{3}^{( r )} \tilde{Π} … {Π}_{N - 1}^{( r )} \tilde{Π} {Π}_{N}^{( r )} {ρ}_{norm}^{T} = ρ ( {T}_{end} ) {ρ}_{norm}^{T} ,$$

where, in the second step, a row vector of ones, ρₙₒᵣₘ, is added at the end to sum over all elements. Here, the superscript T denotes matrix transpose. As such, the structure of the likelihood above amounts to propagation of the initial probability vector ρₛₜₐᵣₜ to the final probability vector ρ(T_{end}) via multiple propagators corresponding to N time windows.

$$Now , under the limit τ \to 0 :$$

$$\tilde{Π} = {lim}_{τ \to 0} exp ( τ G ) = 𝕀 ,$$

$$Π = {lim}_{τ \to 0} exp ( ( ϵ - τ ) G ) = exp ( ϵ G ) ,$$

where [symbol] is the identity matrix. In this limit, the likelihood for the HMM with a second order structure can be recovered as

$$L = {ρ}_{start} {Π}_{1}^{( r )} {Π}_{2}^{( r )} {Π}_{3}^{( r )} … {Π}_{N - 1}^{( r )} {Π}_{N}^{( r )} {ρ}_{norm}^{T} . \qquad ( 14 )$$

Note here that the final probability vector ρ(T_{end}) is not normalized to one upon propagation due to the presence of reduced propagators corresponding to observations. More precisely, the reduced propagators restrict the superstates evolution to only a subset of trajectories over a time window ϵ in agreement with the observation over this window. This, in turn, results in a probability vector whose elements sum to less than one. That is,

$${ρ}_{start} {Π}_{1}^{( r )} {Π}_{2}^{( r )} {Π}_{3}^{( r )} {…Π}_{N - 1}^{( r )} {Π}_{N}^{( r )} {ρ}_{norm}^{T} = ρ ( {T}_{end} ) {ρ}_{norm} < 1. \qquad ( 15 )$$

### 2.3.6 Continuum Limit

Up until now, the finite size of the time window e allowed for an arbitrary number of transitions per time window (tₙ₋₁, tₙ), which hinders the computation of an exact form for the detection matrices. Here, the continuum limit is taken, as the time windows become vanishingly small (that is, ϵ→0 as N→∞). Thus, no more than one transition is permitted per window. This enables full specification of the detection matrices Dₙ.

To derive the detection matrices, first assume ideal detectors with 100% efficiency (detector effects are examined in subsequent sections, see Sec. 2.4). In such cases, the absence of photon detections during a time window, while detectors are active, indicates that only nonradiative transitions took place. Thus, only nonradiative transitions have nonzero probabilities in the detection matrices. As such, for evolution from superstate aₙ to bₙ, the elements of the nonradiative detection matrix, D^{non}, are given by

$${( {D}^{non} )}_{{a}_{n} \to {b}_{n}} = \{ \begin{matrix}1 & Nonradiative transitions \\ 0 & Radiative transitions\end{matrix} . \qquad ( 16 )$$

On the other hand, when the k-th photon is recorded in a time window, only elements corresponding to radiative transitions are nonzero in the detection matrix denoted by Dₖ^{rad} as

$${( {D}_{k}^{r a d} )}_{{a}_{n} \to {b}_{n}} = \{ \begin{matrix}0 & All transitions except for the k ‐ th photon emission \\ 1 & k ‐ th photon emission\end{matrix} . \qquad ( 17 )$$

Here, note that the radiative detection matrices have zeros along their diagonals, since self-transitions are nonradiative.

The reduced propagators corresponding to the nonradiative and radiative detection matrices, D^{non} and Dₖ^{rad}, can now be defined using the Taylor approximation lim_{ϵ→0}Πₙ= [symbol] +ϵG+ [symbol] (ϵ²) as

$${Π}^{( r ) non} = ( 𝕝 + ϵ G + 𝒪 ( {ϵ}^{2} ) ) ⊙ {D}^{non} = exp ( ϵ {G}^{non} ) + 𝒪 ( {ϵ}^{2} ) , and \qquad ( 18 )$$

$${Π}_{k}^{( r ) ra d} = ( 𝕀 + ϵ G + 𝒪 ( {ϵ}^{2} ) ) ⊙ {D}_{k}^{ra d} = ϵ {G}_{k}^{ra d} + 𝒪 ( {ϵ}^{2} ) . \qquad ( 19 )$$

In the equations above, G^{non}=G⊙D^{non} and Gₖ^{rad}⊙Dₖ^{rad}, where the symbol ⊙ represents an element-by-element product of the matrices. Furthermore, the product between the identity matrix and Dₖ^{rad} above vanishes in the radiative propagator due to zeros along the diagonals of Dₖ^{rad}.

Example III: Detection Matrices

For the example with two system states described earlier, the detection
matrices of Eqs. 16-17 take simple forms. The radiative detection matrix
has the same size as the generator matrix with nonzero elements
wherever there is a rate associated to a radiative transition
${D}_{d / a}^{r a d} = [ \begin{matrix}0 & 0 & 0 & 0 & 0 & 0 \\ 1 / 0 & 0 & 0 & 0 & 0 & 0 \\ 0 / 1 & 0 & 0 & 0 & 0 & 0 \\ 0 & 0 & 0 & 0 & 0 & 0 \\ 0 & 0 & 0 & 1 / 0 & 0 & 0 \\ 0 & 0 & 0 & 0 / 1 & 0 & 0\end{matrix} ] ,$
where the subscripts d and a, respectively, denote photon detection in
donor and acceptor channels. Similarly, the nonradiative detection
matrix is obtained by setting all elements of the generator matrix related
to radiative transitions to zero and the remaining to one as
${D}^{n o n} = [ \begin{matrix}1 & 1 & 1 & 1 & 1 & 1 \\ 0 & 1 & 1 & 1 & 1 & 1 \\ 0 & 1 & 1 & 1 & 1 & 1 \\ 1 & 1 & 1 & 1 & 1 & 1 \\ 1 & 1 & 1 & 0 & 1 & 1 \\ 1 & 1 & 1 & 0 & 1 & 1\end{matrix} ] .$

### 2.3.7 Final Likelihood

With the asymptotic forms of the reduced propagators in Eq. 14 now defined in the last subsection, all the ingredients needed to arrive at the final form of the likelihood have been identified.

To do so, begin by considering the period right after the detection of the (k−1)th photon until the detection of the k-th photon. For this time period, the nonradiative propagators in Eq. 14 can now be easily merged into a single propagator Πₖ^{non}=exp((Tₖ→Tₖ₋₁)G^{non}), as the commutative arguments of the exponentials can be readily added. Furthermore, at the end of this interphoton period, the radiative propagator Πₖ^{(r)rad} marks the arrival of the k-th photon. The product of these two propagators

$${Π}_{k}^{non} {Π}_{k}^{( r ) ra d} = ϵ {Π}_{k}^{non} {G}_{k}^{ra d} + 𝒪 ( {ϵ}^{2} ) = ϵ exp ( ( {T}_{k} - {T}_{k - 1} ) {G}^{non} ) {G}_{k}^{ra d} + 𝒪 ( {ϵ}^{2} ) , \qquad ( 20 )$$

now governs the stochastic evolution of the system-FRET composite during that interphoton period.

Inserting Eq.20 for each interphoton period into the likelihood for the HMM with second order structure in Eq. 14, the desired likelihood is outlined:

$$L = {ϵ}^{K} {ρ}_{start} {Π}_{1}^{non} {G}_{1}^{ra d} {Π}_{2}^{non} {G}_{2}^{ra d} … {Π}_{K - 1}^{non} {G}_{K - 1}^{ra d} {Π}_{K}^{non} {G}_{K - 1}^{ra d} {Π}_{end}^{non} {ρ}_{norm}^{T} + 𝒪 ( {ϵ}^{K + 1} ) . \qquad ( 21 )$$

Example IV: Propagator and Likelihood

Here, consider a simple FRET trace where two photons are detected at
times 0.05 ms and 0.15 ms in the donor and acceptor channels, respectively.
To demonstrate the ideas developed so far, the likelihood of these
observations can be calculated as (see Eq. 21)
$L = {ϵ}^{2} {ρ}_{start} {Π}_{1}^{n o n} {G}_{1}^{r a d} {Π}_{2}^{n o n} {G}_{2}^{r a d} {ρ}_{n o r m}^{T} .$
To do so, first need to calculate Π₁^{non} using the nonradiative detection
(D^{non}) and generator (G) matrices found in the previous example boxes
${Π}_{1}^{n o n} = exp ( 0.05 ( G ⊙ {D}^{n o n} ) ) = [ \begin{matrix}0.55 & 0 & 0 & 0.06 & 0 & 0 \\ 0 & 0 & 0 & 0 & 0 & 0 \\ 0 & 0 & 0 & 0 & 0 & 0 \\ 0.03 & 0 & 0 & 0.58 & 0 & 0 \\ 0 & 0 & 0 & 0 & 0 & 0 \\ 0 & 0 & 0 & 0 & 0 & 0\end{matrix} ] ,$
and similarly
${Π}_{2}^{n o n} = exp ( 0.15 ( G ⊙ {D}^{n o n} ) ) = [ \begin{matrix}0.3 & 0 & 0 & 0.06 & 0 & 0 \\ 0 & 0 & 0 & 0 & 0 & 0 \\ 0 & 0 & 0 & 0 & 0 & 0 \\ 0.03 & 0 & 0 & 0.33 & 0 & 0 \\ 0 & 0 & 0 & 0 & 0 & 0 \\ 0 & 0 & 0 & 0 & 0 & 0\end{matrix} ] ,$
Next, calculate G₁^{rad} and G₂^{rad}. Remembering that the first photon was
detected in the donor channel (in ms⁻¹ units):
${G}_{1}^{r a d} = G ⊙ {D}_{d}^{r a d} = [ \begin{matrix}0 & 0 & 0 & 0 & 0 & 0 \\ 277000 & 0 & 0 & 0 & 0 & 0 \\ 0 & 0 & 0 & 0 & 0 & 0 \\ 0 & 0 & 0 & 0 & 0 & 0 \\ 0 & 0 & 0 & 277000 & 0 & 0 \\ 0 & 0 & 0 & 0 & 0 & 0\end{matrix} ] .$
Similarly, since the second photon was detected in the acceptor channel,
(in ms⁻¹ units):
${G}_{2}^{r a d} = G ⊙ {D}_{d}^{r a d} = [ \begin{matrix}0 & 0 & 0 & 0 & 0 & 0 \\ 0 & 0 & 0 & 0 & 0 & 0 \\ 285000 & 0 & 0 & 0 & 0 & 0 \\ 0 & 0 & 0 & 0 & 0 & 0 \\ 0 & 0 & 0 & 0 & 0 & 0 \\ 0 & 0 & 0 & 285000 & 0 & 0\end{matrix} ] .$
Note that this analysis assumes that the system is initially in the
superstate ϕ₁ giving ρₛₜₐᵣₜ = [1, 0, 0, 0, 0, 0]. Finally, putting everything
together, the likelihood can be calculated as L = 3.06ϵ² where ϵ is a
constant and does not contribute to parameter
estimations as shown further herein.

2.3.8 Effect of Binning Single Photon smFRET Data

When considering binned FRET data, the time period of an experiment (T_{end}−Tₛₜₐᵣₜ) is typically divided into a finite number (=N) of equally sized (=ϵ) time windows (bins), and the photon counts (intensities) in each bin are recorded in the detection channels. This is in contrast to single photon analysis where individual photon arrival times are recorded. To arrive at the likelihood for such binned data, the present disclosure starts with the single photon likelihood derived in Eq. 15 where c is not infinitesimally small, that is,

$$L = {ρ}_{start} {Π}_{1}^{( r )} {Π}_{2}^{( r )} {Π}_{3}^{( r )} … {Π}_{N - 1}^{( r )} {Π}_{N}^{( r )} {ρ}_{norm}^{T} , \qquad ( 22 )$$

where

$${( {Π}_{n}^{( r )} )}_{{a}_{n} \to {a}_{n + 1}} = {( Π )}_{{a}_{n} \to {a}_{n + 1}} \times {( {D}_{n} )}_{{a}_{n} \to {a}_{n + 1}} ,$$

or in the matrix notation

$${Π}_{n}^{( r )} = Π ⊙ {D}_{n} = exp ( ϵ G ) ⊙ {D}_{n} , \qquad ( 23 )$$

where Dₙ is the detection matrix introduced in Sec. 2.3.4.

Next, it is necessary to sum over all superstate trajectories that may give rise to the recorded photon counts (observations) in each bin. However, such a sum is challenging to compute analytically. Here, the present disclosure will only show likelihood computation under commonly applied approximations/assumptions when analyzing binned smFRET data, which are: 1) bin size e is much smaller than typical times spent in a system state or, in other words, for a system transition rate λ_{σ}_{ᵢ}_{→σ}_{ⱼ} then ϵλ_{σ}_{ᵢ}_{→σ}_{ⱼ}<<1; and 2) excitation rate λₑₓ is much slower than dye relaxation and FRET rates, or in other words, interphoton periods are much larger than the excited state lifetimes.

The first assumption is based on realistic situations where system kinetics (at seconds timescale) are many orders of magnitude slower than the photophysical transitions (at nanoseconds timescale). This timescale separation allows us to simplify the propagator calculation in Eq. 23. To see that, the system transition rates can be separated from photo-physical transition rates in the generator matrix as

$$G = {G}_{σ} ⊗ 𝕀 + {G}_{ψ} , \qquad ( 24 )$$

where ⊙ denotes a tensor product, G_{σ} is the portion of generator matrix G containing only system transition rates previously defined in Eq. 3, and G_{ψ} is the portion containing only photophysical transition rates, that is,

$${G}_{σ} ⊗ 𝕀 = [ \begin{matrix}- {\sum }_{j \neq 1} {λ}_{{σ}_{1} \to {σ}_{j}} 𝕀 & {λ}_{{σ}_{1} \to {σ}_{2}} 𝕀 & ⋯ & {λ}_{{σ}_{1} \to {σ}_{{M}_{σ}}} 𝕀 \\ {λ}_{{σ}_{2} \to {σ}_{1}} 𝕀 & - {\sum }_{j \neq 2} {λ}_{{σ}_{2} \to {σ}_{j}} 𝕀 & ⋯ & {λ}_{{σ}_{2} \to {σ}_{{M}_{σ}}} 𝕀 \\ ⋮ & ⋮ & ⋱ & ⋮ \\ {λ}_{{σ}_{{M}_{σ}} \to {σ}_{1}} 𝕀 & {λ}_{{σ}_{{M}_{σ}} \to {σ}_{2}} 𝕀 & ⋯ & - {\sum }_{j \neq {M}_{σ}} {λ}_{{M}_{σ} \to {σ}_{j}} 𝕀\end{matrix} ] , \qquad ( 25 )$$

$$and$$

$${G}_{ψ} = [ \begin{matrix}{G}_{{σ}_{1}}^{ψ} & 0 & ⋯ & 0 \\ 0 & {G}_{{σ}_{2}}^{ψ} & ⋯ & 0 \\ ⋮ & ⋮ & ⋱ & ⋮ \\ 0 & 0 & ⋯ & {G}_{{σ}_{{M}_{σ}}}^{ψ}\end{matrix} ] , \qquad ( 26 )$$

where G_{σ}_{ᵢ}^{ψ} is the photophysical generator matrix corresponding to system state σᵢ given in Eq. 4.

Now plugging Eq. 24 into the full propagator Π=exp(ϵG) and applying the famous Zassenhaus formula for matrix exponentials:

$$Π = exp ( ϵ ( {G}_{σ} ⊗ 𝕀 + {G}_{ψ} ) ) = exp ( ϵ ( {G}_{σ} ⊗ 𝕀 ) ) exp ( ϵ {G}_{ψ} ) exp ( - \frac{{ϵ}^{2}}{2} [ {G}_{σ} ⊗ 𝕀 , {G}_{ψ} ] ) exp ( 𝒪 ( {ϵ}^{3} ) ) \qquad ( 27 )$$

where the square brackets represent the commutator of the constituting matrices and the last term represents the remaining exponentials involving higher order commutators. Furthermore, the commutator [G_{σ}⊗ [symbol] , G_{ψ}] results in a very sparse matrix given by

$$[ {G}_{σ} ⊗ 𝕀 , {G}_{ψ} ] = [ \begin{matrix}0 & {{σ}_{1} \to {σ}_{2}}_{} ( {G}_{{σ}_{2}}^{ψ} - {G}_{{σ}_{1}}^{ψ} ) & … & {{σ}_{1} \to {σ}_{{M}_{σ}}}_{} ( {G}_{{σ}_{{M}_{σ}}}^{ψ} - {G}_{{σ}_{1}}^{ψ} ) \\ {{σ}_{2} \to {σ}_{1}}_{} ( {G}_{{σ}_{2}}^{ψ} - {G}_{{σ}_{2}}^{ψ} ) & 0 & … & {{σ}_{2} \to {σ}_{{M}_{σ}}}_{} ( {G}_{{σ}_{{M}_{σ}}}^{ψ} - {G}_{{σ}_{2}}^{ψ} ) \\ ⋮ & ⋮ & ⋱ & ⋮ \\ {{σ}_{{M}_{σ}} \to {σ}_{1}}_{} ( {G}_{{σ}_{1}}^{ψ} - {G}_{{σ}_{{M}_{σ}}}^{ψ} ) & {{σ}_{{M}_{σ}} \to {σ}_{2}}_{} ( {G}_{{σ}_{2}}^{ψ} - {G}_{{σ}_{{M}_{σ}}}^{ψ} ) & … & 0\end{matrix} ] , \qquad ( 28 )$$

where

$${{σ}_{i} \to {σ}_{j}}_{} ( {G}_{{σ}_{j}}^{ψ} - {G}_{{σ}_{i}}^{ψ} ) = {{σ}_{i} \to {σ}_{j}}_{} [ \begin{matrix}0 & 0 & 0 \\ 0 & - ( {{σ}_{j}}_{FRET}^{} - {{σ}_{i}}_{FRET}^{} ) & ( {{σ}_{j}}_{FRET}^{} - {{σ}_{i}}_{FRET}^{} ) \\ 0 & 0 & 0\end{matrix} ] .$$

Now, the propagator calculation in Eq. 27 simplifies if the commutator ϵ²[G_{σ}⊗ [symbol] , G_{ψ}]→0, implying that either the bin size ϵ is very small such that ϵλ_{σ}_{ᵢ}_{→σ}_{ⱼ}<<1 (the first assumption) or FRET rates/efficiencies are almost indistinguishable (ϵ(λ_{σ}_{ⱼ}^{FRET}−λ_{σ}_{ᵢ}^{FRET}≈0)). Under such conditions, the system state can be assumed to stay constant during a bin, with system transitions only occurring at the ends of bin periods. Furthermore, the full propagator Π in Eq. 27 can now be approximated as

$$Π = exp ( ϵ G ) \approx exp ( ϵ ( {G}_{σ} ⊗ 𝕀 ) ) exp ( ϵ {G}_{ψ} ) = ( {Π}_{σ} ⊗ 𝕀 ) {Π}_{ψ} , \qquad ( 29 )$$

where the last equality follows from the block diagonal form of G_{σ} ⊗ [symbol] given in Eq. 25 and Π_{σ}=exp(ϵG_{σ}) is the system transition probability matrix (propagator) given as

$${Π}_{σ} = [ \begin{matrix}{π}_{{σ}_{1} \to {σ}_{1}} & {π}_{{σ}_{1} \to {σ}_{2}} & … & {π}_{{σ}_{1} \to {σ}_{{M}_{σ}}} \\ {π}_{{σ}_{2} \to {σ}_{1}} & {π}_{{σ}_{2} \to {σ}_{2}} & … & {π}_{{σ}_{2} \to {σ}_{{M}_{σ}}} \\ ⋮ & ⋮ & ⋱ & ⋮ \\ {π}_{{σ}_{{M}_{σ}} \to {σ}_{1}} & {π}_{{σ}_{{M}_{σ}} \to {σ}_{2}} & … & {π}_{{σ}_{{M}_{σ}} \to {M}_{σ}}\end{matrix} ] . \qquad ( 30 )$$

Moreover, Π_{ψ}=exp(ϵG_{ψ}) is the photophysical transition probability matrix (propagator) as

$${Π}_{ψ} = [ \begin{matrix}{Π}_{{σ}_{1}}^{ψ} & 0 & … & 0 \\ 0 & {Π}_{{σ}_{2}}^{ψ} & … & 0 \\ ⋮ & ⋮ & ⋱ & ⋱ \\ 0 & 0 & … & {Π}_{{σ}_{{M}_{σ}}}^{ψ}\end{matrix} ] , \qquad ( 31 )$$

where the elements are given as Π_{σ}_{ᵢ}^{ψ}=exp(ϵG_{σ}_{ᵢ}^{ψ}). Furthermore, because of the block diagonal structure of Π_{ψ}, the matrix multiplication in Eq. 29 results in

$$Π = [ \begin{matrix}{π}_{{σ}_{1} \to {σ}_{1}} {Π}_{{σ}_{1}}^{ψ} & {π}_{{σ}_{1} \to {σ}_{2}} {Π}_{{σ}_{1}}^{ψ} & … & {π}_{{σ}_{1} \to {σ}_{{M}_{σ}}} {Π}_{{σ}_{1}}^{ψ} \\ {π}_{{σ}_{2} \to {σ}_{1}} {Π}_{{σ}_{2}}^{ψ} & {π}_{{σ}_{2} \to {σ}_{2}} {Π}_{{σ}_{2}}^{ψ} & … & {π}_{{σ}_{2} \to {σ}_{{M}_{σ}}} {Π}_{{σ}_{2}}^{ψ} \\ ⋮ & ⋮ & ⋱ & ⋮ \\ {π}_{{σ}_{{M}_{σ}} \to {σ}_{1}} {Π}_{{σ}_{{M}_{σ}}}^{ψ} & {π}_{{σ}_{{M}_{σ}} \to {σ}_{2}} {Π}_{{σ}_{{M}_{σ}}}^{ψ} & … & {π}_{{σ}_{{M}_{σ}} \to {σ}_{{M}_{σ}}} {Π}_{{σ}_{{M}_{σ}}}^{ψ}\end{matrix} ] . \qquad ( 32 )$$

After deriving the full propagator Π for the time period ϵ (bin) under the first assumption, the present disclosure now proceeds to incorporate observations during this period via detection matrices Dₙ to compute the reduced propagator of Eq. 23. To do so, the second assumption of relatively slower excitation rate λₑₓ can be applied. This assumption implies that interphoton periods are dominated by the time spent in the ground state of the FRET pair and are distributed according to a single exponential distribution, Exponential(λₑₓ). Consequently, the total photon counts per bin follow a Poisson distribution, Poisson(ϵλₑₓ), independent of the photophysical portion of the photophysical trajectory taken from superstate aₙ to aₙ₊₁.

Now, the first and the second assumptions imply that the observation during the n-th bin only depends on the system state sₙ (or the associated FRET rate λₛ_{ₙ}^{FRET}). As such the detection matrix elements can be approximated as

$${( {D}_{n} )}_{{a}_{n} \to {a}_{n + 1}} = p ( {w}_{n} \vert {a}_{n} , {a}_{n + 1} ) \approx p ( {w}_{n} \vert {s}_{n} ) . \qquad ( 33 )$$

Using these approximations, the reduced propagator in Eq. 23 can now be written as

$$\begin{matrix}{Π}_{n}^{( r )} = Π ⊙ {D}_{n} \\ \approx [ \begin{matrix}{π}_{{σ}_{1} \to {σ}_{1}} p ( {w}_{n} \vert {s}_{n} = {σ}_{1} ) {Π}_{{σ}_{1}}^{ψ} & … & {π}_{{σ}_{1} \to {σ}_{{M}_{σ}}} p ( {w}_{n} \vert {s}_{n} = {σ}_{1} ) {Π}_{{σ}_{1}}^{ψ} \\ {π}_{{σ}_{2} \to {σ}_{1}} p ( {w}_{n} \vert {s}_{n} = {σ}_{2} ) {Π}_{{σ}_{2}}^{ψ} & … & {π}_{{σ}_{2} \to {σ}_{{M}_{σ}}} p ( {w}_{n} \vert {s}_{n} = {σ}_{2} ) {Π}_{{σ}_{2}}^{ψ} \\ ⋮ & ⋱ & ⋮ \\ {π}_{{σ}_{{M}_{σ}} \to {σ}_{1}} p ( {w}_{n} \vert {s}_{n} = {σ}_{{M}_{σ}} ) {Π}_{{σ}_{{M}_{σ}}}^{ψ} & … & {π}_{{σ}_{{M}_{σ}} \to {σ}_{{M}_{σ}}} p ( {w}_{n} \vert {s}_{n} = {σ}_{{M}_{σ}} ) {Π}_{{σ}_{{M}_{σ}}}^{ψ}\end{matrix} ]\end{matrix} . \qquad ( 34 )$$

Next, to compute the likelihood for the n-th bin, it is necessary to sum over all possible superstate trajectories within this bin as

$$\begin{matrix}{L}_{n} = {ρ}_{n} {Π}_{n}^{( r )} {Π}_{norm}^{T} \\ \approx {\sum }_{i = 1}^{{M}_{σ}} {\sum }_{j = 1}^{{M}_{σ}} p ( {w}_{n} \vert {s}_{n} = {σ}_{i} ) {π}_{{σ}_{i} \to {σ}_{j}} ( {ρ}_{{σ}_{i} , n} {Π}_{{σ}_{i}}^{ψ} {ρ}_{norm}^{T} ) ,\end{matrix} \qquad ( 35 )$$

where ρₙ is a normalized row vector populated by probabilities of finding the system-FRET composite in the possible superstates at the beginning of the n-th bin. Furthermore, portions of ρₙ corresponding to system state σᵢ as are written as ρ_{σ}_{ᵢ}_{,n}. be more explicit:

$${ρ}_{n} = [ {ρ}_{{σ}_{i} , n} {ρ}_{{σ}_{2} , n} … {ρ}_{{σ}_{{M}_{σ} , n}} ] ,$$

following the convention in Sec. 2.3 and using n to now represent time tₙ.

Moreover, since each row of Π_{σ}_{ᵢ}^{ψ}=exp(ϵG_{σ}_{ᵢ}^{ψ}) sums to one, e Π_{σ}_{ᵢ}^{ψ}ρₙₒᵣₘ^{T}=ρₙₒᵣₘ^{T}, which simplifies the bin likelihood of Eq. 35 to

$$\begin{matrix}{L}_{n} = {\sum }_{i = 1}^{{M}_{σ}} {\sum }_{j = 1}^{{M}_{σ}} p ( {w}_{n} \vert {s}_{n} = {σ}_{i} ) {π}_{{σ}_{i} \to {σ}_{j}} ( {ρ}_{{σ}_{i} , n} {ρ}_{norm}^{T} ) \\ = {\sum }_{i = 1}^{{M}_{σ}} {\sum }_{j = 1}^{{M}_{σ}} p ( {w}_{n} \vert {s}_{n} = {σ}_{i} ) {π}_{{σ}_{i} \to {σ}_{j} {ρ}_{{σ}_{i} , n}} ,\end{matrix} \qquad ( 36 )$$

where

$${ρ}_{{σ}_{i} , n} ≡ {ρ}_{{σ}_{i} , n} {ρ}_{norm}^{T} {\sum }_{j} {ρ}_{{σ}_{i} , {ψ}_{j}}$$

is defined as the probability of the system to occupy system state σᵢ. The previous equation can also be written in matrix form as

$${L}_{n} \approx {ρ}_{n}^{σ} ( {Π}_{σ} ⊙ {D}_{n}^{σ} ) {ρ}_{norm}^{T} , \qquad ( 37 )$$

where ρₙ^{σ} is a row vector of length M_{σ} (number of system states) populated by ρ_{σ}_{ᵢ}_{,n} for each system state, and Dₙ^{σ}, in the same spirit as Dₙ, is a detection matrix of dimensions M_{σ}×M_{σ} populated by observation probability p(wₙ|sₙ=σᵢ) in each row corresponding to system state σᵢ. Furthermore, defining Πₙ^{σ}≡(Π_{σ}⊙Dₙ^{σ}), note that Πₙ^{σ} propagates probabilities during the n-th bin in a similar manner as the reduced propagators Πₙ^{(r)} of Eq. 23.

Therefore, these new propagators can be multiplied for each bin to approximate the likelihood of Eq. 22 as

$$L \approx {ρ}_{start}^{σ} {Π}_{1}^{σ} {Π}_{2}^{σ} {Π}_{3}^{σ} … {Π}_{N}^{σ} {ρ}_{norm}^{T} , \qquad ( 38 )$$

where ρₛₜₐᵣₜ^{σ} is a row vector, similar to ρₙ^{σ}, populated by probabilities of being in a given system state at the beginning of an experiment.

To conclude, the two assumptions regarding system kinetics and excitation rate enable significant reduction of the dimensions of the propagators. This, in turn, leads to much lowered expense for likelihood computation. However, cheaper computation comes at the expense of requiring large number of photon detections or excitation rate per bin to accurately determine FRET efficiencies (identify system states) due to marginalization over photophysics in each bin. Such high excitation rates lead to faster photobleaching and increased photo-toxicity, and thereby much shorter experiment durations. As discussed in Sec. 2.5.1, this problem can be mitigated by using pulsed illumination, where the likelihood takes a similar form as Eq. 38, but FRET efficiencies can be accurately estimated from the measured microtimes.

### 2.4 Detection Effects

The analysis in the previous section assumed idealized detectors to illustrate basic ideas on detection matrices. However, realistic FRET experiments must typically account for detector nonidealities. For instance, many emitted photons may simply go undetected when the detection efficiency of single photon detectors, i.e., the probability of an incident photon being successfully registered, is less than one due to inherent nonlinearities associated with the electronics or the use of filters in cases of polarized fluorescent emission. Additionally, donor photons may be detected in the channel reserved for acceptor photons or vice-versa due to emission spectrum overlap. This phenomenon, commonly known as crosstalk, crossover, or bleedthrough, can significantly affect the determination of quantities such as transition rates and FRET efficiencies. Other effects adding noise to fluorescence signal include dark current (false signal in the absence of incident photons), dead time (the time a detector takes to relax back into its active mode after a photon detection), and timing jitter or IRF (stochastic delay in the output signal after a detector receives a photon). This section of the present disclosure describes the incorporation of all such effects into the model except dark current and background emissions which require more careful treatment and will be discussed in Sec. 2.6.

### 2.4.1 Crosstalk and Detection Efficiency

Noise sources such as crosstalk and detection efficiency necessarily result in photon detection being treated as a stochastic process. Both crosstalk and detection efficiency can be included into the propagators in both cases by substituting the zeros and ones, appearing in the ideal radiative and nonradiative detection matrices (Eqs. 16-17), with probabilities between zero and one. In such a way, the resulting propagators obtained from these detection matrices, in turn, incorporate into the likelihood the effects of crosstalk and detection efficiency into the model.

Here, in the presence of crosstalk, for clarity, a superscript is added to the radiative detection matrix of Eq. 17 for the k-th photon, Dₖ^{rad-ct}. The elements of this detection matrix for the aₙ→bₙ transition, when a photon intended for channel j is registered in channel i reads

$${( {D}_{k}^{rad - ct} )}_{{a}_{n} \to {b}_{n}} = \{ \begin{matrix}0 & Nonradiative transitions \\ {∅}_{ji} & Radiative transitions\end{matrix}$$

where ϕⱼᵢ is the probability for this event (upon transition from superstate aₙ to bₙ). Further, detector efficiencies can also be accounted for in these probabilities in order to represent the combined effects of crosstalk, arising from spectral overlap, and absence of detection channel registration. Upon doing so,

$${\sum }_{j} {ϕ}_{ij} \leq 1$$

(for cases where i and j can be both the same or different) can be recovered, as not all emitted photons can be accounted for by the detection channels.

This new detection matrix above results in the following modification to the radiative propagator of Eq. 19 for the k-th photon

$${Π}_{k}^{( r ) rad - ct} = ( 𝕀 + ϵ G + 𝒪 ( {ϵ}^{2} ) ) ⊙ {D}_{k}^{rad - ct} = ϵ {G}_{k}^{rad - ct} + 𝒪 ( {ϵ}^{2} ) .$$

The second equality above follows by recognizing that the identity matrix multiplied, element-wise, by Dₖ^{rad-ct} is zero. By definition, Gₖ^{rad-ct}is the remaining nonzero product.

On the other hand, for time periods when no photons are detected, the nonradiative detection matrices in Eq. 16 becomes

$${( {D}_{n} )}_{{a}_{n} \to {b}_{n}} = {( {D}^{non - ct} )}_{{a}_{n} \to {b}_{n}} = \{ \begin{matrix}1 & Nonradiative transitions \\ 1 - {\sum }_{j} {∅}_{ij} & Radiative transitions\end{matrix} ,$$

where the sum gives the probability of the photon intended for channel i to be registered in any channel. The nonradiative propagator of Eq. 18 for an infinitesimal period of size e in the presence of crosstalk and inefficient detectors is now:

$${Π}^{( r ) non - ct} = ( 𝕀 + ϵ G + 𝒪 ( {ϵ}^{2} ) ) ⊙ {D}^{non - ct} = exp ( ϵ {G}^{non - ct} ) + 𝒪 ( {ϵ}^{2} ) , \qquad ( 39 )$$

where G^{non-ct}=G⊙D^{non-ct}. With the propagators incorporating crosstalk and detection efficiency now defined, the evolution during an interphoton period between the (k−1)-th photon and the k-th photon of size (Tₖ−Tₖ₋₁) is now governed by the product:

$${Π}_{k}^{non - ct} {Π}_{k}^{( r ) non - ct} = {ϵΠ}_{k}^{non - ct} {G}_{k}^{rad - ct} + 𝒪 ( {ϵ}^{2} ) , \qquad ( 40 )$$

where the nonradiative propagators in Eq. 39 have now been merged into a single propagator Πₖ^{non-ct}=exp((Tₖ−Tₖ₋₁)G^{non-ct}) following the same procedure as Eq. 20.

Finally, inserting Eq. 40 for each interphoton period into the likelihood of Eq. 14, the final likelihood incorporating crosstalk and detection efficiency can be arrived at:

$$L = {ϵ}^{K} {ρ}_{start} {Π}_{1}^{non - ct} {G}_{1}^{rad - ct} {Π}_{2}^{non - ct} {G}_{2}^{rad - ct} … {Π}_{K - 1}^{non - ct} {G}_{K - 1}^{rad - ct} \times {Π}_{K}^{non - ct} {G}_{K}^{rad - ct} {Π}_{end}^{non - ct} {ρ}_{norm}^{T} + 𝒪 ( {ϵ}^{K + 1} ) .$$

After incorporating crosstalk and detector efficiencies into the model, the calibration of the crosstalk probabilities/detection efficiencies ϕᵢⱼ is briefly outlined here. To calibrate these parameters, two samples, one containing only donor dyes and another containing only acceptor dyes, are individually excited with a laser under the same power to determine the number of donor photons n_{di}^{raw} and number of acceptor photons nₐᵢ^{raw} detected in channel i.

From photon counts recorded for the donor only sample, assuming ideal detectors with 100% efficiency, the crosstalk probabilities for donor photons going to channel i, ϕ_{di}, can be computed using the photon count ratios as ϕ_{di}=n_{di}^{raw}/n_{d}^{em} where n_{d}^{em} is the absolute number of emitted donor photons. Similarly, crosstalk probabilities for acceptor photons going to channel i, ϕₐᵢ, can be estimated as ϕₐᵢ=nₐᵢ^{raw}/nₐ^{em} where nₐ^{em} is the absolute number of emitted acceptor photons. In the matrix form, these crosstalk factors for a two-detector setup can be written as

$$A = [ \begin{matrix}{ϕ}_{{a}_{1}} & {ϕ}_{{d}_{1}} \\ {ϕ}_{{a}_{2}} & {ϕ}_{{d}_{2}}\end{matrix} ] . \qquad ( 41 )$$

Using this matrix, for the donor only sample:

$$[ \begin{matrix}{n}_{d 1}^{raw} \\ {n}_{d 2}^{raw}\end{matrix} ] = A [ \begin{matrix}0 \\ {n}_{d}^{em}\end{matrix} ] = [ \begin{matrix}{ϕ}_{d 1} \\ {ϕ}_{d 2}\end{matrix} ] {n}_{d}^{em} , \qquad ( 42 )$$

and similarly for the acceptor only sample:

$$[ \begin{matrix}{n}_{a 1}^{raw} \\ {n}_{a 2}^{raw}\end{matrix} ] = A [ \begin{matrix}{n}_{a}^{em} \\ 0\end{matrix} ] = [ \begin{matrix}{ϕ}_{a 1} \\ {ϕ}_{a 2}\end{matrix} ] {n}_{a}^{em} , \qquad ( 43 )$$

and nₐ^{em} experimentally, and therefore the crosstalk factors in A can only be determined up to multiplicative factors of n_{d}^{em} and nₐ^{em}.

Since scaling the photon counts in an smFRET trace by an overall constant does not affect the FRET efficiency estimates (determined by photon count ratios) and escape rates (determined by changes in FRET efficiency), crosstalk factors up to a constant are required as in the last equation.

For this reason, one possible solution toward determining the matrix elements of A up to one multiplicative constant is to first tune dye concentrations such that the ratio n_{d}^{em}/nₐ^{em}=1, which can be accomplished experimentally. This enables to write the crosstalk factors in the matrix form up to a constant as follows:

$$A = [ \begin{matrix}{∅}_{a 1} & {∅}_{d 1} \\ {∅}_{a 2} & {∅}_{d 2}\end{matrix} ] ∝ [ \begin{matrix}{n}_{a 1}^{raw} & {n}_{d 1}^{raw} \\ {n}_{a 2}^{raw} & {n}_{d 1}^{raw}\end{matrix} ] . \qquad ( 44 )$$

It is common to set the multiplicative factor in Eq. 44 by the total donor photons counts Σⱼn_{dj}^{raw} to give:

$$A = [ \begin{matrix}{∅}_{a 1} & {∅}_{d 1} \\ {∅}_{a 2} & {∅}_{d 2}\end{matrix} ] ≡ [ \begin{matrix}\frac{{n}_{a 1}^{raw}}{{\sum }_{j} {n}_{dj}^{raw}} & \frac{{n}_{d 1}^{raw}}{{\sum }_{j} {n}_{dj}^{raw}} \\ \frac{{n}_{a 2}^{raw}}{{\sum }_{j} {n}_{dj}^{raw}} & \frac{{n}_{d 2}^{raw}}{{\sum }_{j} {n}_{dj}^{raw}}\end{matrix} ] . \qquad ( 45 )$$

Note that from the convention adopted here, ϕ_{d1}+ϕ_{d2}=1.

Furthermore, in situations where realistic detectors affect the raw counts, the matrix elements of A as computed above automatically incorporate the effects of detector inefficiencies including the fact that

$${\sum }_{j} {ϕ}_{ij} \leq 1$$

Additionally, the matrix A can be further generalized to account for more than two detectors by appropriately expanding the size of the matrix dimensions to coincide with the number of detectors. Calibration of the matrix elements then follows the same procedure as above.

Now, in performing single photon FRET analysis, the elements of A can be used directly in constructing the measurement matrix. However, it is also common to compute the matrix elements of A from what is termed the route correction matrix (RCM) typically used in binned photon analysis. The RCM is defined as the inverse of A to obtain corrected counts n_{d}^{em} and nₐ^{em} up to a proportionality constant as

$$RCM ∝ [ \begin{matrix}{∅}_{d 2} & - {∅}_{d 1} \\ - {∅}_{a 2} & {∅}_{a 1}\end{matrix} ] . \qquad ( 46 )$$

Example V: Detection Matrices with Crosstalk and Detector Efficiencies

For the example with two system states, detection matrices for ideal detectors were
previously shown. Here, crosstalk and detector efficiencies are incorporated into these
matrices. Moreover, a realistic RCM can be assumed, given as:
$RCM ∝ [ \begin{matrix}1.0 & - 0.22 \\ 0.0 & 1.02\end{matrix} ] .$
However, following the convention of Eq. 45, the matrix can be scaled by a sum of
absolute values of its first row elements, namely 1.22, leading to effective crosstalk
factors ϕᵢⱼ given as
${ϕ}_{a 1} = 0.84 , {ϕ}_{a 2} = 0.0 , {ϕ}_{d 1} = 0 \text{.18} , {ϕ}_{d 2} = 0.82 .$
As such, these values imply approximately 18% crosstalk from donor to acceptor
channel and 84% detection efficiency for acceptor channel without any crosstalk using
the convention adopted in Eq. 45. Now, the ideal radiative detection matrices are
modified by replacing their nonzero elements with the calibrated ϕᵢⱼ′s above
${D}_{d / a}^{rad - ct} = [ \begin{matrix}0 & 0 & 0 & 0 & 0 & 0 \\ {ϕ}_{d 2} / {ϕ}_{d 1} & 0 & 0 & 0 & 0 & 0 \\ {ϕ}_{a 2} / {ϕ}_{a 1} & 0 & 0 & 0 & 0 & 0 \\ 0 & 0 & 0 & 0 & 0 & 0 \\ 0 & 0 & 0 & {ϕ}_{d 2} / {ϕ}_{d 1} & 0 & 0 \\ 0 & 0 & 0 & {ϕ}_{a 2} / {ϕ}_{a 1} & 0 & 0\end{matrix} ] = [ \begin{matrix}0 & 0 & 0 & 0 & 0 & 0 \\ 0.82 / 0.18 & 0 & 0 & 0 & 0 & 0 \\ 0 / 0.84 & 0 & 0 & 0 & 0 & 0 \\ 0 & 0 & 0 & 0 & 0 & 0 \\ 0 & 0 & 0 & 0.82 / 0.18 & 0 & 0 \\ 0 & 0 & 0 & 0 / 0.84 & 0 & 0\end{matrix} ] .$
Similarly, the ideal nonradiative detection matrix is modified by replacing the zero:
${D}^{non - ct} = [ \begin{matrix}1 & 1 & 1 & 1 & 1 & 1 \\ 0 & 1 & 1 & 1 & 1 & 1 \\ 0.16 & 1 & 1 & 1 & 1 & 1 \\ 1 & 1 & 1 & 1 & 1 & 1 \\ 1 & 1 & 1 & 0 & 1 & 1 \\ 1 & 1 & 1 & 0.16 & 1 & 1\end{matrix} ] .$

### 2.4.2 Effects of Detector Dead Time

Typically, a detection channel i becomes inactive (dead) after the detection of a photon for a period δᵢ as specified by the manufacturer. Consequently, radiative transitions associated with that channel cannot be monitored during that period.

To incorporate this detector dead period into the likelihood model, an inter-photon period between the (k−1)-th and k-th photon is broken into two intervals: the first interval with an inactive detector and the second interval with an active detector. Assuming that the (k−1)-th photon is detected in the ith channel, the first interval is thus δᵢₖ long. As such, the detection matrix for this interval can be defined as:

$${( {D}^{{i}_{k} - dead} )}_{{a}_{n} \to {b}_{n}} = \{ \begin{matrix}1 & All transitions not intended for channel {i}_{k} \\ 0 & All transitions intended for channel {i}_{k}\end{matrix} .$$

Next, corresponding to this detection matrix, the propagator can be written as follows:

$${Π}_{k}^{{i}_{k} - dead} = exp ( {δ}_{{i}_{k}} ( G ⊙ {D}^{{i}_{k} - dead} ) ) = exp ( {δ}_{{i}_{k}} {G}^{{i}_{k} - dead} ) ,$$

which evolves the superstate during the detector dead time. This propagator can now be used to incorporate the detector dead time into Eq. 20 to represent the evolution during the period between the (k−1)-th and k-th photons as:

$${Π}_{k - 1}^{{i}_{k - 1} - dead} {Π}_{k}^{non} {Π}_{k}^{( r ) rad} = {ϵΠ}_{k - 1}^{{i}_{k - 1} - dead} {Π}_{k}^{non} {G}_{k}^{rad} + 𝒪 ( {ϵ}^{2} ) , \qquad ( 47 )$$

where Πₖ^{non}Πₖ^{(r)rad} describes the evolution when the detector is active.

Finally, inserting Eq. 47 for each interphoton period into the likelihood for the HMM with a second order structure in Eq. 14, the following likelihood that includes detector dead time is as follows:

$$L ∝ {ρ}_{start} {Π}_{1}^{non} {G}_{1}^{rad} {Π}_{1}^{{i}_{1} - dead} {Π}_{2}^{non} {G}_{2}^{rad} {Π}_{2}^{{i}_{2} - dead} … {Π}_{K}^{non} {G}_{K}^{rad} {Π}_{K}^{{i}_{K} - dead} {Π}_{end}^{non} {ρ}_{norm}^{T} . \qquad ( 48 )$$

To provide an explicit example on the effect of the detector dead time on the likelihood, the present disclosure takes a detour for pedagogical reasons. In this context, consider a very simple case of one detection channel (dead time δ) observing a fluorophore with two photophysical states, ground (ψ₁) and excited (ψ₂), illuminated by a laser. The data in this case includes only photon arrival times:

{T₁, Tₛ, T₃, . . . , T_{K}}. (49)

The generator matrix containing the photophysical transition rates for this setup is:

$$G = [ \begin{matrix}* & {{ψ}_{1} \to {ψ}_{2}}_{} \\ {{ψ}_{2} \to {ψ}_{1}}_{} & *\end{matrix} ] = [ \begin{matrix}* & {ex}_{} \\ {d}_{} & *\end{matrix} ]$$

where the * along the diagonal represents the negative row-sum of the remaining elements, λₑₓ is the excitation rate, and λ_{d} is the donor relaxation rate.

Here, all transitions are possible during detector dead times as there are no observations. As such, the dead time propagators in the likelihood (Eq. 48) are simply expressed as exponentials of the full generator matrix, that is, Πₖⁱ^{ₖ}^{-dead}=exp(δG), leaving the normalization of the propagated probability vector ρ unchanged, e.g., just as in Eq. 8.

As demonstrated herein, these dead times, similar to detector inefficiencies, simply increase the uncertainty over parameters to be learned, such as kinetics, by virtue of providing less information. By contrast, background emissions and cross talk, provide false information. However, the net effect is the same: all noise sources increasing uncertainty.

### 2.4.3 Adding the Detection IRF

Due to various sources of noise impacting the detection timing electronics (also known as jitter), the time elapsed between photon arrival and detection is itself a hidden (latent) random variable. Under continuous illumination, this stochastic delay in time is sampled from a probability density, ƒ(τ), termed the detection instrument response function (IRF). To incorporate the detection IRF into the likelihood of Eq. 48, the propagators are convoluted with ƒ(τ) as follows:

$$L ∝ {ρ}_{start} ( {\int }_{0}^{{T}_{IRF}} {d}_{{τ}_{1}} {Π}_{1}^{non} ( Δ {T}_{1} - {τ}_{1} ) {G}_{1}^{rad} {Π}_{1}^{{i}_{1} - dead} ( {τ}_{1} ) f ( {τ}_{1} ) ) \times ( {\int }_{0}^{{T}_{IRF}} {d}_{{τ}_{2}} {Π}_{2}^{non} ( Δ {T}_{2} - {τ}_{2} ) {G}_{2}^{rad} {Π}_{2}^{{i}_{2} - dead} ( {τ}_{2} ) f ( {τ}_{2} ) ) ⋮ \times ( {\int }_{0}^{{T}_{IRF}} {d}_{{τ}_{K}} {Π}_{K}^{non} ( Δ {T}_{K} - {τ}_{K} ) {G}_{K}^{rad} {Π}_{K}^{{i}_{K} - dead} ( {τ}_{K} ) f ( {τ}_{K} ) ) {Π}_{end}^{non} {ρ}_{norm}^{T} , \qquad ( 50 )$$

where dead time propagators Πₖⁱ^{ₖ}^{-dead} are used to incorporate detector inactivity during the period between photon reception and detector reactivation. Moreover, Πₖ^{non}(ΔTₖ−Tₖ)=exp((ΔTₖ−τₖ)G^{non}) as described in Eq. 18.

To facilitate the computation of this likelihood, the systems outlined herein leverage the fact that typical acquisition devices record at discrete (but very small) time intervals. For instance, a setup with the smallest acquisition time of 16 ps and a detection IRF distribution that is approximately 100 ps wide will have the detection IRF spread over, roughly, six acquisition periods. This allows each convolution integral to be discretized over the six acquisition intervals and computed in parallel, thereby avoiding extra real computational time associated to this convolution other than the overhead associated with parallelization.

### 2.5 Illumination Features

After discussing detector effects, the present disclosure further considers different illumination features. For simplicity alone, the likelihood computation until now assumed continuous illumination with a uniform intensity. More precisely, the element λₑₓ of the generator matrix in Eq. 4 was assumed to be time-independent. Here, the formulation is generalized. Further, the present disclosure shows how other illumination setups (such as pulsed illumination and alternating laser excitation, ALEX) can be incorporated into the likelihood by simply assigning a time dependence to the excitation rate λₑₓ(t).

### 2.5.1 Pulsed Illumination

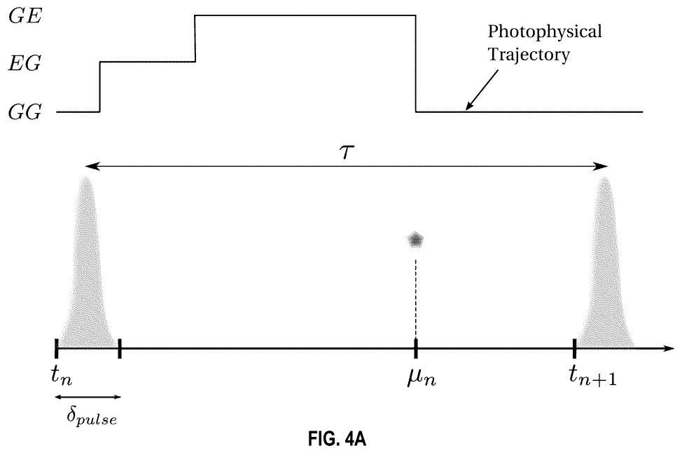

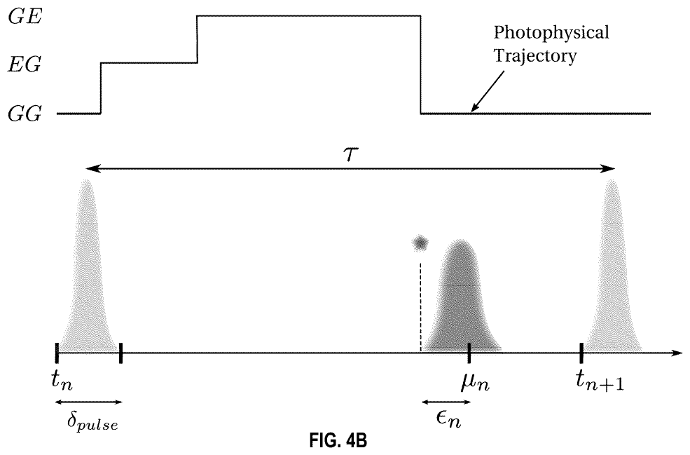

Here, consider an smFRET experiment where the FRET pair is illuminated using a laser for a very short period of time (a pulse), δₚᵤₗₛₑ, at regular intervals of size τ; see FIG. 4A. Now, as in the case of continuous illumination with constant intensity, the likelihood for a set of observations acquired using pulsed illumination takes a similar form to Eq. 21 involving products of matrices as follows:

$$L ∝ {ρ}_{start} {Q}_{1} {Q}_{2} {Q}_{3} {⋯Q}_{N - 1} {Q}_{N} {ρ}_{norm ,}^{T} \qquad ( 51 )$$

where Qₙ, with n=1, . . . , N, denotes the propagator evolving the superstate during the n-th interpulse period between the (n−1)-th and the n-th pulse.

To derive the structure of Qₙ during the n-th interpulse period, Qₙ can be broken into two portions: 1) pulse with nonzero laser intensity where the evolution of the FRET pair is described by the propagator Πₙ^{pulse} introduced shortly; 2) dark period with zero illumination intensity where the evolution of the FRET pair is described by the propagator Πₙ^{dark} introduced shortly. Furthermore, depending on whether a photon is detected or not over the n-th interpulse period the propagators Πₙ^{pulse} and Πₙ^{dark} assume different forms.

First, when no photons are detected:

$${Π}_{n}^{pulse} = exp ( {\int }_{0}^{{δ}_{pulse}} d δ {G}^{non} ( δ ) ) , and \qquad ( 52 )$$

$${Π}_{n}^{dark} = exp ( ( τ - {δ}_{pulse} ) {G}^{dark} ) , \qquad ( 53 )$$

where the integration over the pulse period now involves a time dependent G^{non} due to temporal variations in λₑₓ(t). The integral in Eq. 52 is sometimes termed the excitation IRF though this convention will not be used here. For this reason, when referring to IRF herein, detection IRF alone is implied. Additionally, G^{dark} is the same as G^{non} except for the excitation rate that is now set to zero due to lack of illumination. Finally, the propagator for an interpulse period with no photon detection can now be written as

$${Q}_{n} = {Π}_{n}^{pulse} {Π}_{n}^{dark} = exp ( {\int }_{0}^{{δ}_{pulse}} d δ {G}^{non} ( δ ) ) exp ( ( τ - {δ}_{pulse} ) {G}^{dark} ) . \qquad ( 54 )$$

On the other hand, if a photon is detected sometime after a pulse (as in FIG. 4A), the pulse propagator remains as in Eq. 52. However, the propagator Πₙ^{dark} must now be modified to include a radiative generator matrix Gₙ^{rad} similar to Eq. 20

$${Π}_{n}^{dark} = exp ( ( {μ}_{n} - {δ}_{pulse} ) {G}^{dark} ) {G}_{n}^{rad} exp ( ( τ - {μ}_{n} ) {G}^{dark} ) , \qquad ( 55 )$$

where μₙ is the photon arrival time measured with respect to the n-th pulse (also termed microtime) as shown in in FIG. 4A. Here, the two exponential terms describe the evolution of the superstate before and after the photon detection during the dark period.

Moreover, the propagator can be constructed for situations where a photon is detected during a pulse itself in a similar fashion. Here, the propagator Πₙ^{dark} remains the same as in Eq. 53 but Πₙ^{pulse} must now be modified to include the radiative generator matrix Gₙ^{rad} as:

$${Π}_{n}^{pulse} = exp ( {\int }_{0}^{{μ}_{n}} d δ {G}^{non} ( δ ) ) {G}_{n}^{rad} exp ( {\int }_{{μ}_{n}}^{{δ}_{pulse}} d δ {G}^{non} ( δ ) ) . \qquad ( 56 )$$

The propagators derived so far in this section assumed ideal detectors. The present disclosure now describes a procedure to incorporate the IRF into this formulation. This is especially significant for accurate estimation of fluorophores' lifetimes, which is commonly done in pulse illumination smFRET experiments. To incorporate the IRF, the same procedure is followed as in Sec. 2.4.3 convolution is introduced between the IRF function ƒ(ϵ) and propagators above involving photon detections. That is, when there is a photon detected during the dark period, the propagator Πₙ^{dark} can be modified as:

$${Π}_{n}^{dark} = {\int }_{0}^{{δ}_{IRF}} d {ϵ}_{n} exp ( ( {μ}_{n} - {δ}_{pulse} - {ϵ}_{n} ) {G}^{dark} ) {G}_{n}^{rad} \times exp ( ( τ - {μ}_{n} + {ϵ}_{n} ) {G}^{dark} ) f ( {ϵ}_{n} ) , \qquad ( 57 )$$

while the Πₙ^{pulse} stays the same as in Eq. 52. Here, ϵₙ is the stochastic delay in photon detection resulting from the IRF as shown in in FIG. 4B.

Moreover, when there is a photon detected during a pulse, the propagator Πₙ^{pulse} of Eq. 56 can be modified in a similar fashion to accommodate the IRF, while the propagator Πₙ^{dark} remains the same as in Eq. 53.

The propagators Qₙ presented in this section involve integrals over large generator matrices that are analytically intractable and computationally expensive when considering large pulse numbers. Therefore, a strategy similar to Sec. 2.3.8 for binned likelihood can be applied to approximate these propagators.

To reduce the complexity of the calculations, one may start by making realistic approximations. Given the timescale separation between the interpulse period (typically tens of nanoseconds) and the system kinetics (typically of seconds timescale) in a pulsed illumination experiment, it is possible to approximate the system state trajectory as being constant during an inter-pulse period. In essence, rather than treating the system state trajectory as a continuous time process, the trajectory can be discretized such that system transitions only occur at the beginning of each interpulse period. This enables separation of the photophysical part of the generator matrix G_{ψ} in Eq. 4 from the portion describing the evolution of the system under study G_{σ} given in Eq. 3. Here, by contrast to the likelihood shown in Sec. 2.5.1 for pulsed illumination, the photophysical and system likelihood portions can be independently computed, as described below.

To derive the likelihood, the system state propagator during an interpulse period can be written as:

$${Π}_{σ} = exp ( τ {G}_{σ} ) , \qquad ( 58 )$$

Furthermore, observations must be incorporated into these propagators by multiplying each system transition probability in Π_{σ}, π_{σ}_{ᵢ}_{→σ}_{ⱼ}, with the observation probability if that transition had occurred. These observation probabilities can be organized using the newly defined detection matrices Dₙ^{σ} similar to Sec. 2.3.6, and the modified propagators can be written as:

$${Π}_{n}^{σ} = {Π}_{σ} ⊙ {D}_{n}^{σ} , \qquad ( 59 )$$

where ⊙ again represents the element-by-element product. Here, the elements of Dₙ^{σ} depend on the photophysical portion of the generator matrix G_{ψ}. Note here that propagator matrix dimensions are now M_{σ}×M_{σ} making them computationally less expensive than in the continuous illumination case. Finally, the likelihood for the pulsed illuminated smFRET data with these new propagators reads:

$$L = p ( ω \vert {ρ}_{start} , {Π}_{σ} , {G}_{ψ} ) ∝ {ρ}_{start} {Π}_{1}^{σ} {Π}_{2}^{σ} … {Π}_{N}^{σ} {ρ}_{norm}^{T} , \qquad ( 60 )$$

which, similar to the case of binned likelihood under continuous illumination (see Sec. 2.3.8), sums over all possible system state trajectories.

This likelihood can be used later to put forward an inverse model to learn transition probabilities (elements of œ_{σ}) and photophysical transition rates appearing in G_{ψ}.

### 2.6 Background Emissions

Here, consider background photons registered by detectors from sources other than the labeled system under study. The majority of background photons comprise ambient photons, photons from the illumination laser entering the detectors, and dark current (false photons registered by detectors).

Due to the uniform laser intensity in the continuous illumination case, considered in this section, all background photons can be modeled using a single distribution from which waiting times are drawn. Often, such distributions are assumed (or verified) to be Exponential with fixed rates for each detection channel. Here, the waiting time distribution for background photons arising from both origins is modeled as a single Exponential, as is often the most common case. However, in the pulsed illumination case, laser source and the two other sources of background require different treatments due to nonuniform laser intensity. That is, the ambient photons and dark current are still modeled by an Exponential distribution though it is often further approximated as a Uniform distribution given that interpulse period if much shorter than the average background waiting time.

Now, the background can be incorporated into the likelihood under continuous illumination. This is achieved, as mentioned earlier, by assuming an Exponential distribution for the background, which effectively introduces new photophysical transitions into the model. As such, these transitions may be incorporated by expanding the full generator matrix G (described in Sec. 2.3) appearing in the likelihood, thereby leaving the structure of the likelihood itself intact, c.f., Eq. 21.

To be clear, in constructing the new generator matrix, the background in each detection channel is treated as if originating from fictitious independent emitters with constant emission rates (exponential waiting time). Furthermore, it is assumed that an emitter corresponding to channel i is a two state system with photophysical states denoted by:

$$\{ {ψ}_{i , 1}^{bg} , {ψ}_{i , 2}^{bg} \} .$$

Here, each transition to the other state coincides with a photon emission with rate λᵢ^{bg}. As such, the corresponding background generator matrix for channel i can now be written as:

$${G}_{i}^{bg} = [ \begin{matrix}* & {{ψ}_{i , 1}^{bg} \to {ψ}_{i , 2}^{bg}}_{} \\ {{ψ}_{i , 2}^{bg} \to {ψ}_{i , 1}^{bg}}_{} & *\end{matrix} ] = [ \begin{matrix}* & {i}_{bg}^{} \\ {i}_{bg}^{} & *\end{matrix} ] .$$

Since the background emitters for each channel are independent of each other, the expanded generator matrix G for the combined setup (system-FRET composite plus background) can now be computed. This can be achieved by combining the system-FRET composite state space and the background state spaces for all of the total C detection channels using Kronecker sums as

$$G = {G}_{no - bg} ⊕ {G}_{1}^{bg} ⊕ {G}_{2}^{bg} ⊕ … ⊕ {G}_{C}^{bg} ,$$

where the symbol ⊕ denotes the matrix Kronecker sum, and G_{no-bg} represents previously shown generator matrices without any background transition rates.

The propagators needed to compute the likelihood can now be obtained by exponentiating the expanded generator matrix above as

$$exp ( ( {T}_{k} - {T}_{k - 1} ) G ) = exp ( ( {T}_{k} - {T}_{k - 1} ) {G}_{no - bg} ) ⊗ exp ( ( {T}_{k} - {T}_{k - 1} ) {G}_{1}^{bg} ) ⊗ exp ( ( {T}_{k} - {T}_{k - 1} ) {G}_{2}^{bg} ) ⊗ … ⊗ exp ( ( {T}_{k} - {T}_{k - 1} ) {G}_{C}^{bg} ) ,$$

where the symbol ® denotes the matrix Kronecker product (tensor product).

Furthermore, the same detection matrices defined earlier to include only nonradiative transitions or only radiative transitions, and their generalization with crosstalk and detection efficiency, can be used to obtain nonradiative and radiative propagators, as shown in Sec. 2.3.6.

Consequently, as mentioned earlier, by contrast to incorporating the effects of dead time or IRF, addition of background sources do not entail any changes in the basic structure (arrangement of propagators) of the likelihood appearing in Eq. 21.

Example VI: Background

To provide a concrete example for background, again return to the FRET
pair with two system states. The background free full generator matrix
for this system-FRET composite was provided in the example box in
Sec. 2.3 as (in units of ms⁻¹)
${G}_{no - bg} = [ \begin{matrix}- 12 & 10. & 0 & 2. & 0. & 0. \\ 277000 & - 347002 & 70000 & 0. & 2. & 0. \\ 285000 & 0. & - 285002 & 0. & 0. & 2. \\ 1. & 0. & 0. & - 11 & - 11 & 0 \\ 0. & 1. & 0. & 277000 & - 2777001 & 2500000 \\ 0. & 0. & 1. & 285000 & 0. & - 285001\end{matrix} ] .$
This portion expands upon the above generator matrix to incorporate
background photons entering two channels (i = 1, 2) at rates of
λ₁^{bg} = 1 ms⁻¹ and λ₂^{bg} = 0.5 ms⁻¹. This is achieved by performing a
Kronecker sum of G_{no-bg} with the following generator matrix for
the background:
${G}_{bg} = {G}_{1}^{bg} ⊕ {G}_{2}^{bg} = [ \begin{matrix}- 1 & 1 \\ 1 & - 1\end{matrix} ] ⊕ [ \begin{matrix}- 0.5 & 0.5 \\ 0.5 & 0.5\end{matrix} ] = [ \begin{matrix}- 1 \text{.5} & 0 \text{.5} & 1 & 0 \\ 0 \text{.5} & - 1 \text{.5} & 0 & 1 \\ 1 & 0 & - 1 \text{.5} & 0 \text{.5} \\ 0 & 1 & 0 \text{.5} & - 1 \text{.5}\end{matrix} ]$
resulting in:
$G = {G}_{no - bg} ⊕ {G}_{bg} .$
Here, G is a 24 × 24 matrix (omitting its explicit form).

### 2.7 Fluorophore Characteristics: Quantum Yield, Blinking, Photobleaching, and Direct Acceptor Excitation

As demonstrated for background in the previous section, to incorporate new photophysical transitions such as fluorophore blinking and photobleaching into the likelihood, the full generator matrix G must be modified. This can again be accomplished by adding extra photophysical states, relaxing nonradiatively, to the fluorophore model. These photophysical states can have long or short lifetimes depending on the specific photophysical phenomenon at hand. For example, donor photobleaching can be included by introducing a third donor photophysical state into the matrix of Eq. 4 without any escape transitions as follows:

$${G}_{{σ}_{i}}^{ψ} = [ \begin{matrix}* & {{ψ}_{1} \to {ψ}_{2}}_{} & 0 & 0 \\ {{ψ}_{2} \to {ψ}_{1}}_{} & * & {{σ}_{i} , {ψ}_{2} \to {ψ}_{3}}_{} & {{ψ}_{2} \to {ψ}_{4}}_{} \\ {{ψ}_{3} \to {ψ}_{1}}_{} & 0 & * & 0 \\ 0 & 0 & 0 & *\end{matrix} ] = [ \begin{matrix}* & {ex}_{} & 0 & 0 \\ {d}_{} & * & {{σ}_{i}}_{FRET}^{} & {bleach}_{} \\ {a}_{} & 0 & * & 0 \\ 0 & 0 & 0 & *\end{matrix} ] ,$$

where ψ₁ is the lowest energy combined photophysical state for the FRET labels, ψ₂ represents the excited donor, ψ₃ represents the excited acceptor, and ψ₄ represents a photobleached donor, respectively. Additionally, λ_{d} and λₐ denote donor and acceptor relaxation rates, respectively, λ_{bleach} represents permanent loss of emission from the donor (photobleaching), and λ_{σ}_{ᵢ}^{FRET} represents FRET transitions when the system is in its i-th system state.

Fluorophore blinking can be implemented similarly, except with a nonzero escape rate out of the new photophysical state, allowing the fluorophore to resume emission after some time. Here, assuming that the fluorophore cannot transition into the blinking photophysical state from the donor ground state results in the following generator matrix:

$${G}_{{σ}_{i}}^{ψ} = [ \begin{matrix}* & {{ψ}_{1} \to {ψ}_{2}}_{} & 0 & 0 \\ {{ψ}_{2} \to {ψ}_{1}}_{} & * & {{σ}_{i} , {ψ}_{2} \to {ψ}_{3}}_{} & {{ψ}_{2} \to {ψ}_{4}}_{} \\ {{ψ}_{3} \to {ψ}_{1}}_{} & 0 & * & 0 \\ {{ψ}_{4} \to {ψ}_{1}}_{} & 0 & 0 & *\end{matrix} ] = [ \begin{matrix}* & {ex}_{} & 0 & 0 \\ {d}_{} & * & {{σ}_{i}}_{FRET}^{} & {blink}_{} \\ {a}_{} & 0 & * & 0 \\ {unblink}_{} & 0 & 0 & *\end{matrix} ] .$$

So far, this discussion has ignored direct excitation of acceptor dyes in the likelihood model. This effect can also be incorporated into the likelihood by assigning a nonzero value to the transition rate λ_{ψ}_{₁}_{→ψ}_{₃}, that is,

$${G}_{{σ}_{i}}^{ψ} = [ \begin{matrix}* & {{ψ}_{1} \to {ψ}_{2}}_{} & {{ψ}_{1} \to {ψ}_{3}}_{} \\ {{ψ}_{2} \to {ψ}_{1}}_{} & * & {{σ}_{i} , {ψ}_{2} \to {ψ}_{3}}_{} \\ {{ψ}_{3} \to {ψ}_{1}}_{} & 0 & *\end{matrix} ] = [ \begin{matrix}* & {ex}_{} & {direct}_{} \\ {d}_{} & * & {{σ}_{i}}_{FRET}^{} \\ {a}_{} & 0 & *\end{matrix} ] .$$

Other photophysical phenomena can also be incorporated into the likelihood by following the same procedure as above. Finally, just as when adding background, the structure of the likelihood (arrangement of the propagators) when treating photophysics (including adding the effect of direct acceptor excitation) stays the same as in Eq. 21.

### 2.8 Synthetic Data Generation

The previous subsections described how to compute the likelihood, which is the sum of probabilities over all possible superstate trajectories that could give rise to the observations made by a detector, as demonstrated in Sec. 2. Here, the present disclosure demonstrates how one such superstate trajectory can be simulated to produce synthetic photon arrival data using the Gillespie algorithm, as described in the next section followed by the addition of detector artefacts. The generated data can be used to test the BNP-FRET sampler.

### 2.8.1 Gillespie and Detector Artefacts

The Gillespie algorithm generates two sets of random variables. The times at which super-states change (indexed 1 through N). These times occur anywhere along a continuous time grid. The next set of random variables are the states associated to the superstate preceding the time at which the superstate changes.

The sequence of superstates is designated as:

$$\{ {b}_{1} , {b}_{2} , … , {b}_{N} \} ,$$

where bₙ∈{ϕ₁, ϕ₂, . . . , ϕ_{M}_{_{ϕ}}}. Here, unlike earlier in Sec. 2.3, the time index n on superstates bₙ is not on a regular temporal grid.

Now, to generate the superstate sequence above, the first superstate, b₁, is randomly drawn from the set of possible superstates given their corresponding probabilities. Next, second superstate b₂ of the sequence is drawn using the set of transition rates out of the first state with self-transitions excluded by construction. Now, after choosing b₂, the holding time h₁ (the time spent in b₁) is generated from the Exponential distribution with rate constant associated with transitions b₁→b₂. Finally, the two previous steps are repeated to sequentially generate the full sequence of superstates along with the corresponding holding times.

More formally, a trajectory is generated, by first sampling the initial superstate as

$${b}_{1} \sim {Categorical}_{{∅}_{1} : {M}_{∅}} ( {ρ}_{start} ) ,$$

where ρₛₜₐᵣₜ is the initial probability vector and the Categorical distribution is the generalization of the Bernoulli distribution for more than two possible outcomes. The remaining superstates can now be sampled as:

$${b}_{n + 1} \vert {b}_{n} , G ∼ Cat {egorical}_{{∅}_{1} : {M}_{∅}} ( \frac{{{b}_{n} \to {ϕ}_{1}}_{}}{{{b}_{n}}_{}} , \frac{{{b}_{n} \to {ϕ}_{2}}_{}}{{{b}_{n}}_{}} , ⋯ , \frac{{{b}_{n} \to {M}_{ϕ}}_{}}{{{b}_{n}}_{}} ) ,$$

where

$${λ}_{{b}_{n}} = {\sum }_{i} {λ}_{{b}_{n} \to {ϕ}_{i}}$$

is the escape rate for the superstate bₙ and rates for self-transitions are zero. The above equation reads as follows: “the superstate bₙ₊₁ is drawn (sampled) from a Categorical distribution given the superstate bₙ and the generator matrix G”.

Once the n-th superstate bₙ is chosen, the holding time hₙ (the time spent in bₙ) is sampled as follows

$${h}_{n} \vert {b}_{n} , G \sim Exponential ( {{b}_{n}}_{} ) .$$

Finally, with ideal detectors, the detection channel cₖ is assigned deterministically to the k-th photon emitted at time Tₖ^{em}, which can be computed by summing all the holding times preceding the corresponding radiative transition.

Furthermore, in the presence of detection effects, such as crosstalk, detection efficiency, and IRF, another layer of stochasticity originating from the measurement model must be added to the stochastic output of the Gillespie simulation. That is, the detection channel and detection times are stochastically assigned to an emitted photon, as described below.

In the presence of crosstalk and inefficient detectors, the detection channel for the k-th photon emitted upon a radiative transition is selected as:

$${c}_{k} ∼ Cat {egorial}_{\{ ∅ , 1 , 2 \}} ( {p}_{∅}^{k} , {p}_{1}^{k} , {p}_{2}^{k} ) , \qquad ( 61 )$$

where p_{∅}^{k}, p₁^{k} and p₂^{k}, respectively, denote the probability of the photon going undetected, being detected in channel 1 and channel 2.

Moreover, in the presence of the IRF, a stochastic delay ϵₖ, sampled from a probability distribution f(ϵ), is assigned to the absolute photon emission time Tₖ^{em}. This results in the detection time, Tₖ=Tₖ^{em}+ϵₖ, as registered by the timing hardware.

Additionally, when photophysical effects (such as blinking and photobleaching) and background are present, a superstate trajectory can be generated following the same procedure as above using the generator matrices G incorporating these effects as described in the previous sections.

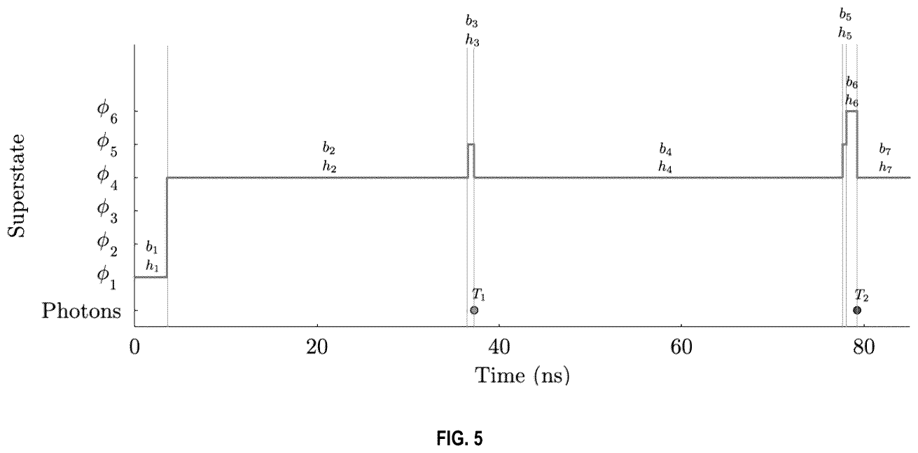

Finally, the desired smFRET trace is obtained (see FIG. 5) which includes photon arrival times T_{1:K} and detection channels c_{1:K} as

$$\{ ( {T}_{1} , {c}_{1} ) , ( {T}_{2} , {c}_{2} ) , ( {T}_{3} , {c}_{3} ) , … , ( {T}_{K} , {c}_{K} ) \} .$$

### 3—Inverse Strategy

This section builds on the forward model outlined above to show how to obtain parameters of interest for single photon smFRET analysis within the BNP paradigm.

Now, armed with the likelihood for different experimental setups and a means by which to generate synthetic data (or having experimental data at hand), the parameters of interest can be learned. Assuming precalibrated detector parameters, these include transition rates that enter the generator matrix G, and elements of ρₛₜₐᵣₜ that denote probabilities for the macromolecular system-FRET composite to be in a given superstate at the beginning of the experiment. However, accurate estimation of the unknowns requires an inverse strategy capable of dealing with all existing sources of uncertainty in the problem such as photon's stochasticity and detector noise. This naturally leads to adoption of a Bayesian inference framework where Monte Carlo methods can be applied to learn distributions over the parameters.

The distribution of interest over the unknown parameters to be learned is termed the posterior. The posterior is proportional to the product of the likelihood and prior distributions using Bayes' rule as follows:

$$p ( G , {ρ}_{start} \vert w ) ∝ L ( w \vert G , {ρ}_{start} ) p ( G , {ρ}_{start} ) , \qquad ( 62 )$$

where the last term p(G, ρₛₜₐᵣₜ) is the joint prior distribution over G and ρₛₜₐᵣₜ defined over the same domains as the parameters. The prior is often selected on the basis of computational convenience. The influence of the prior distribution on the posterior diminishes as more data is incorporated through the likelihood. Furthermore, the constant of proportionality is the inverse of the absolute probability of the collected data, 1/p(w), and can be safely ignored as generation of Monte Carlo samples only involves ratios of posterior distributions or likelihoods.

FIGS. 3A and 3B show graphical models depicting the random variables and parameters involved in the generation of photon arrival data for smFRET experiments. Circles shaded in blue represent parameters of interest for deduction, namely transition rates and probabilities. The circles shaded in gray correspond to observations. The unshaded circles represent the superstates. The arrows reflect conditional dependence among these variables and colored dots represent photon arrivals. Going from FIG. 3A to FIG. 3B, the original HMM can be converted with a second order structure to a naive HMM where each observation only depends on one state.

Additionally, the ϵ^{K} factor in the likelihood first derived in Eq. 21 can be absorbed into the proportionality constant as it does not depend on any of the parameters of interest, resulting in the following expression for the posterior (in the absence of detector dead time and IRF for simplicity)

$$p ( G , {ρ}_{s tart} \vert w ) ∝ {ρ}_{s tart} {\prod }_{1}^{non} {G}_{1}^{rad} {\prod }_{2}^{non} {G}_{2}^{rad} {\prod }_{K - 1}^{non} {G}_{K - 1}^{rad} {\prod }_{K}^{non} {G}_{K}^{rad} {\prod }_{end}^{non} {ρ}_{end}^{T} \times p ( G , {ρ}_{start} ) \qquad ( 63 )$$

Next, assuming a priori that different transition rates are independent of each other and initial probabilities, the prior can be simplified as follows:

$$P ( G , {ρ}_{start} ) = P ( {ρ}_{start} ) {\prod }_{i , j} p ( {λ}_{{ϕ}_{i} \to {ϕ}_{j}} ) , \qquad ( 64 )$$

where the Dirichlet prior distribution over initial probabilities is selected as this prior is conveniently defined over a domain where the probability vectors, drawn from it, sum to unity. That is,

$$p ( {ρ}_{start} ) = Dirichlet ( ζ ) , \qquad ( 65 )$$

where the Dirichlet distribution is a multivariate generalization of the Beta distribution and ζ is a vector of the same size as the superstate space. Typically parameters of the prior are termed hyperparameters and as such ζ collects as many hyperparameters as its size.

Additionally, Gamma prior distributions are selected for individual rates. That is,

$$p ( {λ}_{{ϕ}_{i} \to {ϕ}_{j}} ) = Gamma ( {λ}_{{ϕ}_{i} \to {ϕ}_{j}} ; α , \frac{{λ}_{ref}}{α} ) , \qquad ( 66 )$$

guaranteeing positive values. Here, α and λ_{ref} (a reference rate parameter) are hyperparameters of the Gamma prior. For simplicity, these hyperparameters are usually chosen (with appropriate units) such that the prior distributions are very broad, minimizing their influence on the posterior.

Furthermore, to reduce computational cost, the number of parameters to be learned can be reduced by reasonably assuming the macromolecular system was at steady-state immediately preceding the time at which the experiment began. That is, instead of sampling ρₛₜₐᵣₜ from the posterior, ρₛₜₐᵣₜ can be computed by solving the time-independent master equation,

$${ρ}_{start} G = 0 .$$

Therefore, the posterior in Eq. 63 now reduces to

$$p ( G \vert w ) ∝ {ρ}_{start} {\prod }_{1}^{non} {G}_{1}^{rad} {\prod }_{2}^{non} {G}_{2}^{rad} {\prod }_{K - 1}^{non} {G}_{K - 1}^{rad} {\prod }_{K}^{non} {G}_{K}^{rad} {\prod }_{end}^{non} {ρ}_{end}^{T} \times p ( G ) . \qquad ( 67 )$$

In the following subsections, a parametric inverse strategy is provided, i.e., assuming a known number of system states, for sampling parameters from the posterior distribution in Eq. 67 using Monte Carlo methods. Next, this inverse strategy is generalized to a nonparametric case to enable deduction of the number of system states.

3.1 Parametric Sampler: BNP-FRET with Fixed Number of System States

Now with the posterior, Eq. 67, at hand and assuming steady-state ρₛₜₐᵣₜ, a sampling scheme is illustrated to deduce the transition rates of the generator matrix G.

As the posterior of Eq. 67 does not assume a standard form amenable to analytical calculations, numerical samples of the transition rates within G can be iteratively drawn using Markov Chain Monte Carlo (MCMC) techniques. Specifically, a Gibbs algorithm can be adopted to sequentially and separately, generate samples for individual transition rates at each MCMC iteration. To do so, the posterior of Eq. 67 can be written using the chain rule as follows:

$$p ( G \vert w ) = p ( {λ}_{{ϕ}_{i} \to {ϕ}_{j}} \vert G ∖ {λ}_{{ϕ}_{i} \to {ϕ}_{j}} , w ) p ( G ∖ {λ}_{{ϕ}_{i} \to {ϕ}_{j}} \vert w ) , \qquad ( 68 )$$

where the backslash after G indicates exclusion of the following rate parameters and w denotes the set of observations as introduced in Sec. 2.3.2. Here, the first term on the right hand side is the conditional posterior for the individual rate λ_{ϕ}_{ᵢ}_{→ϕ}_{ⱼ}. The second term is considered a constant in the corresponding Gibbs step as it does not depend on λ_{ϕ}_{ᵢ}_{→ϕ}_{ⱼ}. Moreover, following the same logic, the priors p (G\λ_{ϕ}_{ᵢ}_{→ϕ}_{ⱼ}) (see Eq. 67) for the remaining rate parameters in the posterior on the left are also considered constant. Therefore, from Eqs. 67 & 68, the conditional posterior for λ_{ϕ}_{ᵢ}_{→ϕ}_{ⱼ}above can be written as:

$$p ( {λ}_{{ϕ}_{i} \to {ϕ}_{j}} \vert G ∖ {λ}_{{ϕ}_{i} \to {ϕ}_{j}} , w ) ∝ {ρ}_{start} {Π}_{1}^{n o n} {G}_{1}^{r a d} {Π}_{2}^{n o n} {G}_{2}^{r a d} … {Π}_{K}^{n o n} {G}_{K}^{r a d} {Π}_{e n d}^{n o n} {ρ}_{e n d}^{T} \times Gamma ( {λ}_{{ϕ}_{i} \to {ϕ}_{j}} ; α , \frac{{λ}_{r e f}}{α} ) . \qquad ( 69 )$$

Just as with the posterior over all parameters, this conditional posterior shown above does not take a closed form allowing for direct sampling.

As such, the Metropolis-Hastings (MH) algorithm can be applied to draw samples from this conditional posterior, where new samples are drawn from a proposal distribution q and accepted with probability

$$α ( {λ}_{{ϕ}_{i} \to {ϕ}_{j}}^{*} , {λ}_{{ϕ}_{i} \to {ϕ}_{j}} ) = min \{ 1 , \frac{p ( {λ}_{{ϕ}_{i} \to {ϕ}_{j}}^{*} \vert w , G ∖ {λ}_{{ϕ}_{i} \to {ϕ}_{j}} ) q ( {λ}_{{ϕ}_{i} \to {ϕ}_{j}} \vert {λ}_{{ϕ}_{i} \to {ϕ}_{j}}^{*} )}{p ( {λ}_{{ϕ}_{i} \to {ϕ}_{j}} \vert w , G ∖ {λ}_{{ϕ}_{i} \to {ϕ}_{j}} ) q ( {λ}_{{ϕ}_{i} \to {ϕ}_{j}}^{*} \vert {λ}_{{ϕ}_{i} \to {ϕ}_{j}} )} \} , \qquad ( 70 )$$

where the asterisk represents the proposed rate values from the proposal distribution q.

To construct an MCMC chain of samples, the process begins by initializing the chain for each transition rate λ_{ϕ}_{ᵢ}_{→ϕ}_{ⱼ}, by random values drawn from the corresponding prior distributions. Then, the whole set of transition rates in each MCMC iteration can be iteratively swept by drawing new values from the proposal distribution q.

A computationally convenient choice for the proposal is a Normal distribution leading to a simpler acceptance probability in Eq. 70. This is due to its symmetry resulting in q (λ_{ϕ}_{ᵢ}_{→ϕ}_{ⱼ}|λ*_{ϕ}_{ᵢ}_{→ϕ}_{ⱼ})=q(λ*_{ϕ}_{ᵢ}_{→ϕ}_{ⱼ}|λ_{ϕ}_{ᵢ}_{→ϕ}_{ⱼ}). However, a Normal proposal distribution would allow negative transition rates naturally forbidden leading to rejection in the MH step and thus inefficient sampling. Therefore, it is convenient to propose new samples either drawn from a Gamma distribution or, as shown below, from a Normal distribution in logarithmic space to allow for exploration along the full real line as follows

$$log ( {λ}_{{ϕ}_{i} \to {ϕ}_{j}}^{*} / κ ) \vert log ( {λ}_{{ϕ}_{i} \to {ϕ}_{j}} / κ ) {σ}^{2} ∼ Normal ( log ( {λ}_{{ϕ}_{i} \to {ϕ}_{j}} / κ ) , {σ}^{2} ) ,$$

where κ=1 is an auxiliary parameter in the same units as λ_{ϕ}_{ᵢ}_{→ϕ}_{ⱼ}introduced to obtain a dimensionless quantity within the logarithm.

The variable transformation above now requires introduction of Jacobian factors in the acceptance probability as follows

$$α ( {λ}_{{ϕ}_{i} \to {ϕ}_{j}}^{*} , {λ}_{{ϕ}_{i} \to {ϕ}_{j}} ) = min \{ 1 , \frac{p ( {λ}_{{ϕ}_{i} \to {ϕ}_{j}}^{*} \vert w , G ∖ {λ}_{{ϕ}_{i} \to {ϕ}_{j}} ) ( \partial log ( {λ}_{{ϕ}_{i} \to {ϕ}_{j}} / κ ) \vert \partial {λ}_{{ϕ}_{i} \to {ϕ}_{j}} )}{p ( {λ}_{{ϕ}_{i} \to {ϕ}_{j}} \vert w , G ∖ {λ}_{{ϕ}_{i} \to {ϕ}_{j}} ) {( \partial log ( {λ}_{{ϕ}_{i} \to {ϕ}_{j}} / κ ) \vert \partial {λ}_{{ϕ}_{i} \to {ϕ}_{j}} )}^{*}} \} ,$$

where the derivative terms represent the Jacobian and the proposal distributions are canceled by virtue of using a symmetric Normal distribution.

The acceptance probability above depends on the difference of the current and proposed values for a given transitions rate. In other words, smaller differences between the current and proposed values often lead to larger acceptance probabilities. This difference is determined by the covariance of the Normal proposal distribution σ² which needs to be tuned for each rate individually to achieve optimal performance of the BNP-FRET sampler, or very approximately, one-fourth acceptance rate for the proposals.

This whole algorithm can now be summarized in the following pseudocode:

```
# Initialize Chain of Samples
j = 1
for i = 1 : M_{σ} × M_{σ}
          ${λ}_{i}^{( j )} ∼ Gamma ( α , \frac{{λ}_{r e f}}{α} )$
end
# Iteratively sample from the posterior using Gibbs algorithm
for j = 2: Draws
  for i = 1: Mₐ × Mₐ
    # Propose new sample
    log(λᵢ)~Normal (log (λᵢ^{(j-1)}), σ²),
    # Compute acceptance probability
    $α ( {λ}_{i}^{*} , {λ}_{i}^{( j - 1 )} ) = min \{ 1 , \frac{p ( {λ}_{i}^{*} \vert 𝓌 , G ∖ {λ}_{i} ) {( \partial log {λ}_{i} / \partial {λ}_{i} )}^{( j - 1 )}}{p ( {λ}_{i}^{( j - i )} \vert 𝓌 , G ∖ {λ}_{i} ) ( \partial log ( {λ}_{i} ) / \partial {λ}_{i} ) *} \}$
    if a (λᵢ^{*},λᵢ^{(j-1)}) > rand( )
    # Accept proposal
        λᵢ^{(j)} = exp(λᵢ^{*})
    else
      # Reject proposal
        λᵢ^{(j)} = λᵢ^{(j-1)}
    end
  end
end
```

### 3.2—Nonparametrics: Predicting the Number of System States

After describing the inverse strategy for a known number of system states (i.e., parametric inference), more realistic scenarios are considered where the number of system states may be unknown which, in turn, leads to an unknown number of superstates (i.e., nonparametric inference). In the following subsections, the BNP framework is first provided for continuous illumination and then for pulsed illumination. Such BNP frameworks introduced herein, eventually, provide distributions over the number of system states simultaneously, and self-consistently, with other model parameters.

3.2.1—Bernoulli process for Continuous Illumination

The number of system states is often unknown and cannot a priori be set by hand. Therefore, in order to learn the states warranted by the data, the Bayesian nonparametric paradigm can be considered. That is, an infinite-dimensional version of the generator matrix in Eq. 2 is first defined; each of its elements can be multiplied by a Bernoulli random variable bᵢ (also termed loads). These loads, indexed by i, enable turning on/off portions of the generator matrix associated with transitions between specific system states (including self-transitions). The nonparametric generator matrix can be written as follows:

$$G = [ \begin{matrix}{b}_{1}^{2} {G}_{{σ}_{1}}^{ψ} - {\sum }_{j \neq 1} {b}_{1} {b}_{j} {λ}_{{σ}_{1} \to {σ}_{j}} 𝕀 & {b}_{1} {b}_{j} {λ}_{{σ}_{1} \to {σ}_{j}} 𝕀 & … \\ {b}_{2} {b}_{j} {λ}_{{σ}_{2} \to {σ}_{j}} 𝕀 & {b}_{2}^{2} {G}_{{σ}_{2}}^{ψ} - {\sum }_{j \neq 2} {b}_{2} {b}_{j} {λ}_{{σ}_{2} \to {σ}_{j}} 𝕀 & … \\ ⋮ & ⋮ & ⋱\end{matrix} ] = [ \begin{matrix}* & {b}_{1}^{2} {λ}_{{ψ}_{1} \to {ψ}_{2}} & {b}_{1}^{2} {λ}_{{ψ}_{1} \to {ψ}_{3}} & {b}_{1} {b}_{2} {λ}_{{σ}_{1} \to {σ}_{2}} & 0 & 0 & … \\ {b}_{1}^{2} {λ}_{{ψ}_{2} \to {ψ}_{1}} & * & {b}_{1}^{2} {λ}_{{ψ}_{2} \to {ψ}_{3}}^{( 1 )} & 0 & {b}_{1} {b}_{2} {λ}_{{σ}_{1} \to {σ}_{2}} & 0 & … \\ {b}_{1}^{2} {λ}_{{ψ}_{3} \to {ψ}_{1}} & {b}_{1}^{2} {λ}_{{ψ}_{3} \to {ψ}_{2}} & * & 0 & 0 & {b}_{1} {b}_{2} {λ}_{{σ}_{1} \to {σ}_{2}} & … \\ {b}_{1} {b}_{2} {λ}_{{σ}_{2} \to {σ}_{1}} & 0 & 0 & * & {b}_{2}^{2} {λ}_{{ψ}_{1} \to {ψ}_{2}} & {b}_{2}^{2} {λ}_{{ψ}_{1} \to {ψ}_{3}} & … \\ 0 & {b}_{1} {b}_{2} {λ}_{{σ}_{2} \to {σ}_{1}} & 0 & {b}_{2}^{2} {λ}_{{ψ}_{2} \to {ψ}_{1}} & * & {b}_{2}^{2} {λ}_{{ψ}_{2} \to {ψ}_{3}}^{( 2 )} & … \\ 0 & 0 & {b}_{1} {b}_{2} {λ}_{{σ}_{2} \to {σ}_{1}} & {b}_{2}^{2} {λ}_{{ψ}_{3} \to {ψ}_{1}} & {b}_{2}^{2} {λ}_{{ψ}_{3} \to {ψ}_{2}} & * & … \\ ⋮ & ⋮ & ⋮ & ⋮ & ⋮ & ⋮ & ⋱\end{matrix} ]$$

where a load value of 1 represents an “active” system state, while “inactive” system states (not warranted by the data) get a load value of 0. Here, there are two loads associated to every transition because there is a pair of states corresponding to each transition. Within this formalism, the number of active loads is the number of system states estimated by the BNP-FRET sampler. As before, * represents negative row-sums.

The full set of loads, b={b₁, b₂, . . . , b_{∞}}, now become quantities to be learnt. In order to leverage Bayesian inference methods to learn the loads, the previously defined posterior distribution (Eq. 67) now reads as follows

$$p ( b , G \vert w ) ∝ L ( w \vert b , G , {ρ}_{start} ) p ( G ) p ( b ) , \qquad ( 71 )$$

where the prior p(b) is Bernoulli while the remaining prior, p(G), can be assumed to be the same as in Eq. 66.

As in the case of the parametric BNP-FRET sampler presented in Sec. 3.1 of the present disclosure, samples can be generated from this nonparametric posterior employing a similar Gibbs algorithm. To do so, the MCMC chains of loads and rates can first be initialized by taking random values from their priors. Next, to construct the MCMC chains, samples can be iteratively drawn from the posterior in two steps: 1) sequentially sample all rates using the MH algorithm; then 2) loads by direct sampling, one-by-one from their corresponding conditional posteriors. Here, step (1) can be identical to the parametric case of Sec. 3.1 of the present disclosure. The following elaborates on step (2).

To sample the i-th load, the corresponding conditional posterior reads:

$$p ( {b}_{i} \vert b ∖ {b}_{i} , G , w ) ∝ L ( w \vert b , G , {ρ}_{start} ) Bernoulli ( {b}_{i} ; \frac{1}{1 + \frac{{M}_{σ}^{max} - 1}{γ}} ) , \qquad ( 72 )$$

where the backslash after b indicates exclusion of the following load and M_{σ}^{max} and γ are hyperparameters.

Here γ sets the a priori expected number of system states.

A note on the interpretation of M_{σ}^{max} is in order. When dealing with nonparametrics, an infinite set of loads and priors for these loads called Bernoulli process priors are nominally considered. Samplers for such process priors are available though inefficient means. However, for computational convenience, it is possible to introduce a large albeit finite number of loads set to M_{σ}^{max}. It can be shown that parameter inference are unaffected by this choice of cutoff when setting the success probability to

$$1 / ( 1 + \frac{{M}_{σ}^{max} - 1}{γ} )$$

as in the Bernoulli distribution of Eq. 72. This is because such a choice forces the mean (expected number of system states) of the full prior on loads Πᵢp(bᵢ) to be finite (=γ).

Since the conditional posterior in the equation above must be discrete and describes probabilities of the load being either active or inactive, it must itself follow a Bernoulli distribution with updated parameters

$$p ( {b}_{i} \vert b \backslash {b}_{i} , G , w ) = Bernoulli ( {b}_{i} ; {q}_{i} )$$

where

$${q}_{i} = \frac{L ( w \vert {b}_{i} = 1 , b ∖ {b}_{i} , G , {ρ}_{start} )}{L ( w \vert {b}_{i} = 1 , b ∖ {b}_{i} , G , {ρ}_{start} ) + L ( w \vert {b}_{i} = 0 , b ∖ {b}_{i} , G , {ρ}_{start} )}$$

The Bernoulli form of this posterior allows direct sampling of the loads.

This method can be applied to synthetic and experimental data.

3.2.2—iHMM Methods for Pulsed Illumination

Under pulsed illumination, the Bernoulli process prior described earlier for continuous illumination can in principle be used as is to estimate the number of system states and the transition rates. However, in this section, a computationally cheaper inference strategy is provided that is applicable to the simplified likelihood of Eq. 60 assuming system state transitions occurring only at the beginning of each pulse. The reduction in computational expense is achieved by directly learning the elements of the propagator Π_{σ} of Eq. 58, identical for all interpulse periods. In doing so, transition probabilities for the system states can be learned instead of learning rates, however it is still advantageous to continue learning rates for photophysical states. This avoids expensive matrix exponentials for potentially large system state numbers required for computing the propagators under continuous illumination.

Now, to infer the transition probabilities in Π_{σ}, the dimensions of which are unknown owing to an unknown number of system states, as well as transition rates among the photophysical states (elements of G_{ψ} in Eq. 4), and initial probabilities, suitable priors can be placed on these parameters yielding the following posterior:

$$p ( {ρ}_{start} , {Π}_{σ} , {G}_{ψ} \vert w ) ∝ p ( w \vert {ρ}_{start} , {Π}_{σ} , {G}_{ψ} ) p ( {ρ}_{start} ) p ( {G}_{ψ} ) p ( {Π}_{σ} ) , \qquad ( 73 )$$

where the joint prior is written as a product prior over ρₛₜₐᵣₜ, G_{ψ}, and Π_{σ}. Next, for ρₛₜₐᵣₜ and G_{σ}, the same priors as in Eqs. 65-66 can be applied. However, as the number of system states is unknown, Π_{σ} requires special treatment. To learn Π_{σ}, it is convenient to adopt the infinite HMM (iHMM) due to the discrete nature of system state transitions over time.

As the name suggests, the iHMM leverages infinite system state spaces (M_{σ}→∞ in Eq. 3) similar to the Bernoulli process prior of Sec. 3.2.1 of the present disclosure. However, unlike the Bernoulli process, all system states remain permanently active. The primary goal of an iHMM is then to infer transition probabilities between system states, some of which, not warranted by the data, remain very small and set by the (nonparametric) prior discussed herein. Thus the effective number of system states can be enumerated from the most frequently visited system states over the course of a learned trajectory.

Within this iHMM framework, an infinite dimensional version of the Dirichlet prior, termed the Dirichlet process prior, is selected as priors over each row of the propagator Π_σ. That is,

$${π}_{m} ∼ DirichletProcess ( αβ ) , m = 1 , 2 , … , \qquad ( 74 )$$

where πₘ is the mth row of Π_{σ}. Here, the hyperparameters of the Dirichlet process prior include the concentration parameter a which determines the sparsity of the πₘ and the hyper parameter β which is a probability vector, also known as base distribution. Together αβ are related to the ζ introduced earlier for the (finite) Dirichlet distribution of Eq. 65.

Next, as the base distribution itself is unknown and all transitions out of each state should be likely to revisit the same set of states, the same base distribution can be placed on all Dirichlet process priors placed on the rows of the propagator. To sample this unique base, a Dirichlet process prior is selected, that is,

β=DirichletProcess(ξγ),

where ξ=1 and γ is a vector of hyperparameters of size M_{σ}.

Now, to deduce the unknown parameters, samples must be drawn from the posterior in Eq. 73. However, due to the nonanalytical form of the posterior, the posterior cannot be jointly sampled. Thus, as before, a Gibbs sampling strategy can be adopted to sequentially and separately draw samples for each parameter. Here, the Gibbs sampling step is illustrated for the transition probabilities πₘ. The Gibbs steps for the remaining parameters are similar to Sec. 3.2.1 of the present disclosure.

Similar to the Bernoulli process prior, there are two common approaches to draw samples within the iHMM framework: slice sampling using the exact Dirichlet process prior and finite truncation. Just as before for the case of continuous illumination, the Dirichlet process prior is truncated to a finite Dirichlet distribution and fix its dimensionality to a finite (albeit large) number set to M_{σ}^{max} to improve the sampling. It can then be shown that for large enough M_{σ}^{max} the number of system states visited becomes independent of M_{σ}^{max}.

As before, to numerically sample the transition probabilities πₘfrom the full posterior in Eq. 73 through MCMC, initial samples are selected from the priors:

$$\begin{matrix}β ∼ Dirichlet ( ξγ ) , & \\ {π}_{m} ∼ Dirichlet ( αβ ) , & m = 1 , 2 , … , {M}_{σ}^{max}\end{matrix}$$

where elements of γ are selected as 1/M_{σ}^{max} to ascribe similar weights across the state space a priori.

### 3.3—Likelihood Computation in Practice

As shown in Sec. 2.5.1, the likelihood typically takes the following generic form

$$L ∝ {ρ}_{start} {Q}_{1} {Q}_{2} {Q}_{3} … {Q}_{K - 1} {Q}_{K} {ρ}_{norm}^{T} , \qquad ( 75 )$$

where Qᵢ are matrices whose exact form depends on which effects are incorporated into the likelihood. Computing this last expression would typically lead to underflow as likelihood values quickly drop below floating-point precision.

For this reason, it is convenient to introduce the logarithm of this likelihood. In order to derive the logarithm of the likelihood of Eq. 75, the likelihood is re-written as a product of multiple terms as follows:

$$L ∝ ( {ρ}_{start} {ρ}_{n o r m}^{T} ) ( {ρ}_{1} {Q}_{1} {ρ}_{n o r m}^{T} ) ( {ρ}_{2} {Q}_{2} {ρ}_{n o r m}^{T} ) … ( {ρ}_{K - 1} {Q}_{K - 1} {ρ}_{n o r m}^{T} ) ( {ρ}_{K} {Q}_{K} {ρ}_{n o r m}^{T} ) ,$$

where ρᵢ are the normalized probability vectors given by the following recursive formula:

$$\begin{matrix}{ρ}_{1} = {ρ}_{start} , and \\ {ρ}_{i} = \frac{{ρ}_{i - 1} {Q}_{i - 1}}{( {ρ}_{i - 1} {Q}_{i - 1} {ρ}_{n o r m}^{T} )}\end{matrix} .$$

Now, using the recursion relation above, the log-likelihood can be written as:

$$log ( L ) = log ( {ρ}_{start} {ρ}_{e n d}^{T} ) + log ( {ρ}_{1} {Q}_{1} {ρ}_{n o r m}^{T} ) + log ( {ρ}_{2} {Q}_{2} {ρ}_{n o r m}^{T} ) + log ( {ρ}_{3} {Q}_{3} {ρ}_{n o r m}^{T} ) + … log ( {ρ}_{K - 1} {Q}_{K - 1} {ρ}_{n o r m}^{T} ) + log ( {ρ}_{K} {Q}_{K} {ρ}_{n o r m}^{T} ) + const ,$$

where const is a constant.

Note that ρₛₜₐᵣₜρₙₒᵣₘ^{T}=1. The pseudocode to compute the log-likelihood is as follows

```
ρ = ρₛₜₐᵣₜ
p = sum(ρ) = 1
log(L) = log(p) = 0
for i = 1:K
    Q = ...
    ρ = ρQ
    p = sum(ρ)
  log(L) = log(L) + log(P)
    ρ = ρ/p
end
return log(L)
```

### 4. Results and Practical Implementation Summary

Results using the BNP-FRET sampler described above are presented in Section 4 of Saurabh et al. 2022a. Experimental results were undertaken to benchmark the parametric (i.e., fixed number of system states) version of the sampler using synthetic data, while the two subsequent manuscripts focus on the nonparametric (i.e., unknown number of system states) analysis of experimental data. Saurabh et al. 2022b expands upon experimentation conducted for continuous illumination, while Safar et al. expands upon experimentation conducted for pulsed illumination.

For simplicity alone, this discussion begins by analyzing data from an idealized macromolecular system with two system states using different photon budgets and excitation rates. Next, more realistic examples are considered incorporating the following, one at a time: 1) crosstalk and detection efficiency; 2) background emission; 3) IRF; and then 4) end with a brief discussion on the unknown number of system states. This disclosure demonstrates when these features become relevant, as well as the overall robustness and generality of the BNP-FRET sampler.

For now, assume continuous illumination for all parametric examples and use the following priors for the analyses. The prior used for the FRET rates are:

$$\\ {λ}_{{}_{} {σ}_{i}}^{FRET} \sim Gamma ( 1 , 1 {ns}^{- 1} ) ,$$

and following prior is used over the system transition rates:

$$\\ {λ}_{{}_{} {σ}_{i} \to {σ}_{j}} \sim Gamma ( 1 , 1 {0}^{- 6} {ns}^{- 1} ) .$$

As discussed earlier in Sec. 3.1 of the present disclosure, it is more convenient to work within logarithmic space where the following proposal distributions are used to update the parameter values:

$$\\ log ( {λ}_{{}_{} ex}^{*} ) \vert log ( {λ}_{ex} ) , {σ}_{ex} \sim Normal ( log ( {λ}_{ex} ) , {σ}_{ex}^{{}_{} 2} ) ,$$

$$\\ log ( {λ}_{{}_{} {σ}_{i}}^{{FRET}^{{}_{} *}} ) \vert log ( {λ}_{{}_{} {σ}_{i}}^{FRET} ) , {σ}_{FRET} \sim Normal ( log ( {λ}_{{}_{} {σ}_{i}}^{FRET} ) , {σ}_{FRET}^{{}_{} 2} ) , and$$

$$\\ log ( {λ}_{{}_{} {σ}_{i} \to {σ}_{j}}^{*} ) \vert log ( {λ}_{{}_{} {σ}_{i} \to {σ}_{j}} ) , {σ}_{sys} \sim Normal ( log ( {λ}_{{}_{} {σ}_{i} \to {σ}_{j}} ) {σ}_{sys}^{{}_{} 2} ) ,$$

where * denotes proposed rates and where it is understood that all rates appearing in the logarithm have been divided through by a unit constant in order for the argument of the logarithm to remain dimensionless.

For efficient exploration of the parameter space by the BNP-FRET sampler and upon extensive experimentation with acceptance ratios, it is prudent to alternate between two sets of variances, {σₑₓ²=10⁻⁵, σ_{FRET}²=0.01, σ_{sys}²=0.1} and {σₑₓ²=10⁻⁵, σ_{FRET}²=0.5, σ_{sys}²=5.0} to generate an MCMC chain. This ensures that samples of different orders of magnitude are proposed.

As an intuitive guide, the more data there is, the sharper the posterior is expected to be over the rates and thus, the smaller both variances should be in proposal distributions.

### 4.1—Applied to Continuous Illumination

For the sake of completeness, relevant aspects of the methods presented in Section 3.2.1 of the present disclosure are presented, including the likelihood needed in Bayesian inference, and parametric and nonparametric Markov Chain Monte Carlo (MCMC) samplers.

An smFRET experiment involves at least two single photon detectors collecting information on stochastic arrival times. These arrival times are denoted with:

$$\{ {T}_{start} , {T}_{1} , {T}_{2} , {T}_{3} , … , {T}_{K} , {T}_{end} \} ,$$

in detection channels:

$$\{ {c}_{1} , {c}_{2} , {c}_{3} , … , {c}_{K} \} ,$$

for a total number of K photons. In this representation above, Tₛₜₐᵣₜ and T_{end} are the experiment's start and end times, respectively.

Using this dataset, parameters governing a macromolecular system's kinetics can be inferred. That is, the number of system states M_{σ} and the associated transition rates λ_{σ}_{ᵢ}_{→σ}_{ⱼ}, as well as M_{ψ} photophysical transition rates λ_{σ}_{ᵢ}_{ψ}_{ₗ}_{→ψ}_{ₘ} corresponding to each system state σᵢ. Here, σᵢ∈{σ₁, . . . , σ_{M}_{_{σ}}} and ψᵢ∈{ψ₁, . . . , ψ_{M}_{_{ψ}}} are the system states and photophysical states, respectively. These rates populate a generator matrix G of dimension M_{ϕ}=M_{σ}×M_{ψ} now representing transitions among composite superstates, ϕᵢ≡(σⱼ, ψₖ) where i=(j−1)M_{ψ}+k. This matrix governs the evolution of the macromolecular system-FRET composite via the master equation:

$$\\ \begin{matrix}\frac{d ρ ( t )}{dt} = ρ ( t ) G , & ( B 1 )\end{matrix}$$

as described in Sec. 2.3. Here, ρ(t) is a row vector populated by probabilities for finding the composite in a given superstate at time t.

In estimating these parameters, all sources of uncertainty present in the experiment must be accounted for, such as shot noise and detector electronics. Therefore, working in the Bayesian paradigm can be helpful, where the parameters are learned by sampling from probability distributions over these parameters termed posteriors. Such posteriors are proportional to the product of the likelihood, which is the probability of the collected data w given the physical model, and prior distributions over the parameters as follows

$$\\ \begin{matrix}p ( G \vert w ) ∝ L ( w \vert G ) p ( G ) , & ( B 2 )\end{matrix}$$

where w constitutes the set of all observations, including photon arrival times and detection channels.

To construct the posterior, the likelihood:

$$\\ \begin{matrix}L ( w \vert G ) ∝ {ρ}_{start} {Π}_{1}^{{}_{} non} {G}_{1}^{{}_{} rad} {Π}_{2}^{{}_{} non} {G}_{2}^{{}_{} rad} … {Π}_{K - 1}^{{}_{} non} {G}_{K - 1}^{{}_{} rad} {Π}_{K}^{{}_{} non} {G}_{K}^{{}_{} rad} {Π}_{end}^{{}_{} non} {ρ}_{norm}^{{}_{} T} , & ( B 3 )\end{matrix}$$

is derived in Sec. 2.3. Here, Πₖ^{non} and Gₖ^{non} are the non-radiative and radiative propagators, respectively. Furthermore, ρₛₜₐᵣₜ is computed by solving the master equation assuming the macromolecular system was at steady-state immediately preceding the time at which the experiment began. That is, solving:

$$\\ {ρ}_{start} G = 0.$$

Next, assuming that the transition rates are independent of each other, the associated prior can be written as:

$$\\ p ( G ) = {\prod }_{i , j} p ( {λ}_{{}_{} {ϕ}_{i} \to {ϕ}_{j}} ) ,$$

where Gamma prior distributions over individual rates are selected. That is:

$$\\ p ( {λ}_{{}_{} {ϕ}_{i} \to {ϕ}_{j}} ) = Gamma ( {λ}_{{}_{} {ϕ}_{i} \to {ϕ}_{j}} ; α , \frac{{λ}_{{}_{} ref}}{α} ) ,$$

to guarantee positive values. Here, ϕᵢ represents one of the M_{ϕ} superstates of the macromolecular system-FRET composite collecting both the system states and photophysical states. Furthermore, α and λ_{ref} are parameters of the Gamma prior.

In what follows, the inference procedure in 4.1.1 of the present disclosure assumes that the number of system states are known and provides an inverse strategy that uses the posterior above to learn only transition rates. Next, in 4.1,2 of the present disclosure, the model is applied to a nonparametric case accommodating more practical situations with unknown system state numbers by assuming an infinite dimensional system state space and making the existence of each system state itself a random variable.

### 4.1.1—Inference Procedure for Continuous Illumination: Parametric Sampler

Now, with the posterior defined, a sampling scheme is provided to learn distributions over all parameters of interest, namely, transitions rates populating G and the number of system states. However, the posterior in Eq. B2 does not assume a form amenable to analytical calculations. Therefore, Markov Chain Monte Carlo (MCMC) techniques can be applied to draw numerical samples.

Particularly convenient here is the Gibbs algorithm that sequentially and separately generates samples for individual transition rates in each MCMC iteration. This requires first writing the posterior in Eq. B2 using the chain rule as follows:

$$\\ \begin{matrix}p ( G \vert w ) = p ( {λ}_{{}_{} {ϕ}_{i} \to {ϕ}_{j}} \vert G {}_{} \backslash {}_{} {λ}_{{}_{} {ϕ}_{i} \to {ϕ}_{j}} , w ) p ( G {}_{} \backslash {}_{} {λ}_{{}_{} {ϕ}_{i} \to {ϕ}_{j}} \vert w ) , & ( B 4 )\end{matrix}$$

where the backslash after G indicates exclusion of the subsequent rate parameter. Furthermore, the first term on the right hand side is the conditional posterior for the individual rate λ_{ϕ}_{ᵢ}_{→ϕ}_{ⱼ}. The second term in the product is a constant in the corresponding Gibbs step as it is independent of λ_{ϕ}_{ᵢ}_{→ϕ}_{ⱼ}. Similarly, the priors p(G\λ_{ϕ}_{ᵢ}_{→ϕ}_{ⱼ}) for the rest of the rate parameters on the right hand side of Eq. B2 are also considered constant. Equating the right hand sides of Eqs. B2 & B4 then enables the following conditional posterior for λ_{ϕ}_{ᵢ}_{→ϕ}_{ⱼ} to be written as:

$$\\ \begin{matrix}p ( {λ}_{{}_{} {ϕ}_{i} \to {ϕ}_{j}} \vert G {}_{} \backslash {}_{} {λ}_{{}_{} {ϕ}_{i} \to {ϕ}_{j}} , w ) ∝ L ( w \vert G ) Gamma ( {λ}_{{}_{} {ϕ}_{i} \to {ϕ}_{j}} ; α , \frac{{λ}_{{}_{} ref}}{α} ) . & ( B 5 )\end{matrix}$$

Since the conditional posterior above does not take a closed form that allows for direct sampling, the Metropolis-Hastings (MH) step can be applied where new samples are drawn from a proposal distribution q and accepted with probability:

$$\\ \begin{matrix}α ( {λ}_{{}_{} {ϕ}_{i} \to {ϕ}_{j}}^{{}_{} *} , {λ}_{{}_{} {ϕ}_{i} \to {ϕ}_{j}} ) = min \{ 1 , \frac{p ( {λ}_{{}_{} {ϕ}_{i} \to {ϕ}_{j}}^{{}_{} *} \vert w , G {}_{} \backslash {}_{} {λ}_{{}_{} {ϕ}_{i} \to {ϕ}_{j}} ) q ( {λ}_{{}_{} {ϕ}_{i} \to {ϕ}_{j}} \vert {λ}_{{}_{} {ϕ}_{i} \to {ϕ}_{j}}^{{}_{} *} )}{p ( {λ}_{{}_{} {ϕ}_{i} \to {ϕ}_{j}} \vert w , G {}_{} \backslash {}_{} {λ}_{{}_{} {ϕ}_{i} \to {ϕ}_{j}} ) q ( {λ}_{{}_{} {ϕ}_{i} \to {ϕ}_{j}}^{{}_{} *} \vert {λ}_{{}_{} {ϕ}_{i} \to {ϕ}_{j}} )} \} , & ( B 6 )\end{matrix}$$

where the asterisk denotes proposed rate values from the proposal distribution q.

Now, to generate an MCMC chain of samples, the chains for all transition rates λ_{ϕ}_{ᵢ}_{→ϕ}_{ⱼ} are first initialized by randomly drawing values from their corresponding prior distributions. Then, the process includes successively iterating across each transition rate in each new MCMC step and drawing new samples from the corresponding conditional posterior using the MH criterion.

In the MH step, a convenient choice for the proposal is a Normal distribution leading to a simpler formula for the acceptance probability in Eq. B6. This is due to its symmetry resulting in q(λ_{ϕ}_{ᵢ}_{→ϕ}_{ⱼ}|λ*_{ϕ}_{ᵢ}_{→ϕ}_{ⱼ})=q(λ*_{ϕ}_{ᵢ}_{→ϕ}_{ⱼ}|λ_{ϕ}_{ᵢ}_{→ϕ}_{ⱼ}). However, a Normal proposal distribution would allow forbidden negative transition rates, leading to automatic rejection in the MH step and thus inefficient sampling. Therefore, it is more convenient to propose new samples using a Normal distribution in logarithmic space to allow exploration along the full real line as follows:

$$\\ log ( {λ}_{{}_{} {ϕ}_{i} \to {ϕ}_{j}}^{{}_{} *} / κ ) \vert log ( {λ}_{{}_{} {ϕ}_{i} \to {ϕ}_{j}} / κ ) , {σ}^{{}_{} 2} \sim Normal ( log ( {λ}_{{}_{} {ϕ}_{i} \to {ϕ}_{j}} / κ ) , {σ}^{{}_{} 2} ) ,$$

where κ=1 is an auxiliary parameter in the same units as λ_{ϕ}_{ᵢ}_{→ϕ}_{ⱼ} introduced to obtain a dimensionless quantity within the logarithm.

The transformation above requires introduction of Jacobian factors in the acceptance probability as follows:

$$\\ α ( {λ}_{{}_{} {ϕ}_{i} \to {ϕ}_{j}}^{{}_{} *} , {λ}_{{}_{} {ϕ}_{i} \to {ϕ}_{j}} ) = min \{ 1 , \frac{p ( {λ}_{{}_{} {ϕ}_{i} \to {ϕ}_{j}}^{{}_{} *} \vert w , G {}_{} \backslash {}_{} {λ}_{{}_{} {ϕ}_{i} \to {ϕ}_{j}} ) ( \partial log ( {λ}_{{}_{} {ϕ}_{i} \to {ϕ}_{j}} / κ / \partial {λ}_{{}_{} {ϕ}_{i} \to {ϕ}_{j}} )}{p ( {λ}_{{}_{} {ϕ}_{i} \to {ϕ}_{j}} \vert w , G {}_{} \backslash {}_{} {λ}_{{}_{} {ϕ}_{i} \to {ϕ}_{j}} ) ( \partial log {( {λ}_{{}_{} {ϕ}_{i} \to {ϕ}_{j}} / κ / \partial {λ}_{{}_{} {ϕ}_{i} \to {ϕ}_{j}} )}^{*}} \} ,$$

where the derivatives represent the Jacobian and the proposal distributions are canceled by virtue of using a Normal distribution.

The acceptance probability above depends on the difference of the current and proposed values for a given transition rate. This difference is determined by the covariance of the Normal proposal distribution σ² which needs to be tuned for each rate individually to achieve an optimum performance of the BNP-FRET sampler, or equivalently approximately one-third acceptance rate for the proposals.

In one case, where the smFRET traces analyzed contain about 10⁵ photons, it is prudent to make the sampler alternate between two sets of variances at every MCMC iteration, {σₑₓ²=10⁻⁵, σ_{FRET}²=0.01, σ_{sys}²=0.1} and {σₑₓ²=10⁻⁵, σ_{FRET}²=0.5, σ_{sys}²=5.0}, for the excitation rates, FRET rates, and system transition rates. This ensures that the sampler is quickly able to explore values at different orders of magnitude.

Intuitively, these covariance values in the proposal distributions above would ideally scale with the relative widths of the conditional posteriors for these parameters (in log-space) if the approximate width could be estimated. Since posterior widths depend on the amount of data used, an increase in the number of photons available in the analysis would require a correspondingly smaller variance.

### 4.1.2—Inference Procedure for Continuous Illumination: Nonparametric BNP-FRET Sampler

Here, aspects of the inference procedure described in Sec. 3.1 & 3.2.1 of the present disclosure are recited for ease of reference.

In realistic situations, the system state space's dimensionality is usually unknown as molecules under study may exhibit complex and unexpected behaviors across conditions and timescales. Consequently, the dimensionality M_{ϕ} of the generator matrix G is also unknown, and must be determined by adopting a BNP framework.

Such a framework starts with assuming an infinite set of system states and placing a binary weight, termed load, on each system state such that if it is warranted by the data, the value of the load is realized to one. Put differently, a Bernoulli prior must be placed on each candidate state (of which there are formally an infinite number). In practice, distributions over Bernoulli random variables bᵢ can be learned that activate/deactivate different portions of the full generator matrix as (see Sec. 3.2.1):

$$\\ G = [ \begin{matrix}* & {b}_{1}^{{}_{} 2} {λ}_{{}_{} {ψ}_{1} \to {ψ}_{2}} & {b}_{1}^{{}_{} 2} {λ}_{{}_{} {ψ}_{1} \to {ψ}_{3}} & {b}_{1} {b}_{2} {λ}_{{}_{} {σ}_{1} \to {σ}_{2}} & 0 & 0 & ⋯ \\ {b}_{1}^{{}_{} 2} {λ}_{{}_{} {ψ}_{2} \to {ψ}_{1}} & * & {b}_{1}^{{}_{} 2} {λ}_{{{}_{} σ}_{1} , {ψ}_{2} \to {ψ}_{3}} & 0 & {b}_{1} {b}_{2} {λ}_{{}_{} {σ}_{1} \to {σ}_{2}} & 0 & ⋯ \\ {b}_{1}^{{}_{} 2} {λ}_{{}_{} {ψ}_{3} \to {ψ}_{1}} & {b}_{1}^{{}_{} 2} {λ}_{{}_{} {ψ}_{3} \to {ψ}_{2}} & * & 0 & 0 & {b}_{1} {b}_{2} {λ}_{{}_{} {σ}_{1} \to {σ}_{2}} & ⋯ \\ {b}_{1} {b}_{2} {λ}_{{}_{} {σ}_{2} \to {σ}_{1}} & 0 & 0 & * & {b}_{2}^{{}_{} 2} {λ}_{{}_{} {ψ}_{1} \to {ψ}_{2}} & {b}_{2}^{{}_{} 2} {λ}_{{}_{} {ψ}_{1} \to {ψ}_{3}} & ⋯ \\ 0 & {b}_{1} {b}_{2} {λ}_{{}_{} {σ}_{2} \to {σ}_{1}} & 0 & {b}_{2}^{{}_{} 2} {λ}_{{}_{} {ψ}_{2} \to {ψ}_{1}} & * & {b}_{2}^{{}_{} 2} {λ}_{{{}_{} σ}_{2} , {ψ}_{2} \to {ψ}_{3}} & ⋯ \\ 0 & 0 & {b}_{1} {b}_{2} {λ}_{{}_{} {σ}_{2} \to {σ}_{1}} & {b}_{2}^{{}_{} 2} {λ}_{{}_{} {ψ}_{3} \to {ψ}_{1}} & {b}_{2}^{{}_{} 2} {λ}_{{}_{} {ψ}_{3} \to {ψ}_{2}} & * & ⋯ \\ ⋮ & ⋮ & ⋮ & ⋮ & ⋮ & ⋮ & ⋱\end{matrix} ] ,$$

where active loads are set to 1, while inactive loads are set to 0. Furthermore, * represents negative row-sums. Finally, the number of active loads provides an estimate of the number of system states warranted by a given dataset.

As new variables to be learned have been introduced, the posterior of Eq. B2 is updated to incorporate the full set of loads, b={b₁, b₂, . . . , b_{∞}}, as follows:

$$p ( b , G \vert w ) ∝ L ( w \vert b , G ) p ( b ) p ( G ) ,$$

assuming that all parameters of interest are independent of each other.

As in the parametric sampler presented in the previous subsection, samples can be generated from the nonparametric posterior above using Gibbs sampling. That is, the MCMC chains for loads and rates can be initialized by drawing random samples from their priors. Next, to construct the chains, samples can be iteratively drawn from the posterior in two steps: 1) sequentially sample all rates using the MH procedure; then 2) loads by direct sampling, from their corresponding conditional posteriors (as described in Sec. 3.2.1). Since step (1) is similar to the parametric case, the following focuses on step (2).

To generate samples for load bᵢ, the corresponding conditional posterior is given by:

$$p ( {b}_{i} \vert b ∖ {b}_{i} , G , w ) ∝ L ( w \vert b , G ) Bernoulli ( {b}_{i} ; \frac{1}{1 + \frac{{M}_{σ}^{max} - 1}{γ}} ) ,$$

where the backslash after b indicates exclusion of the following load. Hyperparameters M_{σ}^{max}, the maximum allowed number of system states used in computations, and γ, the expected number of system states, can be set based on simple visual inspection of the smFRET traces.

Now, the conditional posterior in the equation above is discrete and describes the probability for the load to be either active or inactive, that is, it is itself a Bernoulli distribution as follows:

$$p ( {b}_{i} \vert b ∖ {b}_{i} , G , w ) = Bernoulli ( {b}_{i} ; {q}_{i} ) ,$$

where:

$${q}_{i} = \frac{L ( w \vert {b}_{i} = 1 , b ∖ {b}_{i} , G , {ρ}_{start} )}{L ( w \vert {b}_{i} = 1 , b ∖ {b}_{i} , G ) + L ( w \vert {b}_{i} = 0 , b ∖ {b}_{i} , G )} .$$

The simple form of this posterior is amenable to direct sampling. In the end, the chain of generated samples can be used for subsequent statistical analysis.

### 4.1.3 Results

Saurabh et al. (2022b) shows results demonstrating the robustness of the BNP-FRET sampler by investigating the effects of excitation rate on the distributions over transitions rates and system state numbers. The BNP-FRET sampler's performance is illustrated on synthetic data, and is then applied to estimate the number of system states along with associated escape rates from publicly available experimental data for a complex involving instrinsically disorder proteins (ACTR-NCBD). Results are compared with reported literature values.

### 4.2—Applied to Pulsed Illumination

In this section the adaptation of the general formalism described in Section 3 to the pulsed illumination case is illustrated. Next, a specialized inference procedure is presented.

As before, a molecular complex labeled is considered with a donor-acceptor FRET pair. As the molecular complex transitions through its M_{σ} system states indexed by σ_{1:M}_{_{σ}}, laser pulses (optimized to excite the donor) separated by time t may excite either the donor or acceptor to drive transitions among the photophysical states, ψ_{1:M}_{_{ψ}}, as defined above.

Such photophysical transitions lead to photon emissions that may be detected in either donor or acceptor channels. The set of N observations, e.g., photon arrival times, from N pulses are recorded as:

$$w = \{ {w}_{1} , {w}_{2} , … , {w}_{N} \} . \qquad ( C1 )$$

Here, each individual measurement is a pair wₙ=(μₙ^{d}, μₙ^{a}), where μₙ^{d} and μₙ^{a} are the recorded arrival times (also known as microtimes) after the n-th pulse in both donor and acceptor channels, respectively. In cases where there is no photon detection, absent microtimes are denoted with μₙ^{d}=∅ and μₙ^{a}=∅ for donor and acceptor channels, respectively.

FIGS. 3A and 3B show events over a pulsed illumination experiment pulse window. Here, the beginning of the n-th interpulse window of size τ is marked by time tₙ. The sample is then excited by a high intensity burst (shown by the yellow Gaussian) for a very short time Δ_{IRF}_{₁}. If excited, the fluorophore then emits a photon at μₑ. However, detection, highlighted with a red star, occurs at time μₙ dictated by the detection portion of the IRF (shown by the red Gaussian). The acronyms GG, EG and GE denote the photophysical states of a FRET pair where G and E, respectively, stand for ground and excited states. The first letter indicates the photophysical state of the donor

As is clear from FIGS. 3A and 3B, smFRET traces are inherently stochastic due to the nature of photon excitation, emission, and noise introduced by detector electronics. To analyze such stochastic macromolecular systems, the most generic likelihood derived in Eq. 51 is considered:

$$L ∝ {ρ}_{start} {Q}_{1} … {Q}_{n} … {Q}_{N} {ρ}_{norm}^{T} , \qquad ( C2 )$$

where ρₛₜₐᵣₜ is the initial probability vector for the macromolecular system-FRET composite to be in one of M(=M_{ψ}×M_{σ}) superstates, and ρₙₒᵣₘ is a vector that sums the elements of the propagated probability vector. Here, Qₙ is the transition probability matrix between pulses n and n+1, characterizing macromolecular system-FRET composite transitions among superstates.

The propagators Qₙ above adopt different forms depending on whether a photon is detected or not during the associated period. Their most general forms are derived in Sec. 2.5.1. However, these propagators involve computationally expensive integrals and thus a few approximations are made here as follows: 1) assuming that the system state remains the same over an interpulse period since typical system kinetic timescales (typically 1 ms or more) are much longer than interpulse periods (˜100 ns); 2) assuming the interpulse period (˜100 ns) is longer than the donor and acceptor lifetimes (˜a few ns) such that they relax to the ground state before the next pulse. Furthermore, a specialized sampling scheme is demonstrated under these physically motivated approximations.

The immediate implications of assumption (1) are that the macromolecular system transitions may now, to a good approximation, only occur at the beginning of each pulse. Consequently, the evolution of the FRET pair between two consecutive pulses is now exclusively photophysical as the system state remains the same during interpulse times. As such, the macromolecular system now evolves in equally spaced discrete time steps of size τ where the system state trajectory can be written as:

$${s}_{1 : N} = \{ {s}_{1} , {s}_{2} , … , {s}_{n} , … , {s}_{N - 1} , {s}_{N} \} ,$$

where sₙ is the system state between pulses n and n+1. The stochastic evolution of the system states in such discrete steps is then determined by the transition probability matrix designated by Π_{σ}. For example, in the simplest case of a molecular complex with two system states σ_{1:2}, this matrix is computed as follows:

$${Π}_{σ} = exp ( τ [ \begin{matrix}* & {λ}_{{σ}_{1} \to {σ}_{2}} \\ {λ}_{{σ}_{2} \to {σ}_{2}} & *\end{matrix} ] ) = [ \begin{matrix}{π}_{{σ}_{1} \to {σ}_{1}} & {π}_{{σ}_{1} \to {σ}_{2}} \\ {π}_{{σ}_{2} \to {σ}_{1}} & {π}_{{σ}_{2} \to {σ}_{2}}\end{matrix} ] , \qquad ( C3 )$$

where the matrix in the exponential contains transition rates among the system states and the * represents the negative row sum.

Next, by assumption 2, further suppose that the fluorophores always start in the ground state at the beginning of every pulse. As a result, pulses are treated independently and the probability of observation wₙ can be written as:

$$p ( {w}_{n} \vert {s}_{n} , {G}_{ψ} ) = {ρ}_{ground} {Q}_{n}^{ψ} ( {s}_{n} ) {ρ}_{n orm}^{T} , \qquad ( C4 )$$

where ρ_{ground} denotes the probability vector when the FRET pair is in the ground state at the beginning of each pulse, G_{ψ} is the generator matrix with only photophysical transition rates, and Qₙ^{ψ}(sₙ) is the photophysical propagator for the n-th interpulse period.

The observation probabilities of Eq. C4 are further organized into a newly defined detection matrix Dₙ^{σ} with its elements given by (Dₙ^{σ})ₛ_{ₙ}_{→σ}_{ⱼ}=p(wₙ|sₙ, G_{ψ}). Here, the index j does not appear on the right hand side because the system state does not change during an interpulse window resulting in the independence of observation probability from the next system state sₙ₊₁. The explicit formulas for the observation probabilities are provided in the Supplementary Information.

Now, using the matrix Dₙ^{σ}, the reduced propagators for each interpulse period are defined as:

$${Π}_{n}^{σ} = {Π}_{σ} ⊙ {D}_{n}^{σ} , \qquad ( C5 )$$

where ⊙ denotes element-by-element product.

Finally, using these simplified propagators, the likelihood for an smFRET trace under pulsed illumination can be written as:

$$L = p ( w \vert {ρ}_{start} , {Π}_{σ} , {G}_{ψ} ) ∝ {ρ}_{start} {Π}_{1}^{σ} {Π}_{2}^{σ} … {Π}_{N}^{σ} {ρ}_{norm}^{T} , \qquad ( C6 )$$

as also introduced in the Sec. 2.5.1. This form of the likelihood is advantageous in that it allows empty pulses to be computed as a simple product, greatly reducing computational cost.

In the following, a parametric inference procedure assuming a given number of system states is illustrated. Next, the procedure is generalized to the nonparametric case to deduce the number of system states along with the rest of parameters.

### 4.2.1—Inference Procedure for Pulsed Illumination: Parametric Sampler

Now, with the likelihood at hand, the posterior can be constructed as follows:

$$p ( {ρ}_{start} , {Π}_{σ} , {G}_{ψ} \vert w ) ∝ p ( w \vert {ρ}_{start} , {Π}_{σ} , {G}_{ψ} ) p ( {ρ}_{start} ) p ( {G}_{ψ} ) p ( {Π}_{σ} ) , \qquad ( C7 )$$

where the prior assumes that the unknown parameters, including the initial probability vector, ρₛₜₐᵣₜ, the photophysical transition rates in the generator matrix G_{ψ}, and the transition probabilities among system states in propagator Π_{σ}, are independent. Here, the set of unknowns can be sampled using the above posterior with the Gibbs sampling procedure as described in Sec. 3.2.2. However, a computationally more convenient inference procedure that allows direct sampling is accomplished by writing the posterior as a marginalization (sum) over state trajectories as follows:

$$p ( {ρ}_{start} , {Π}_{σ} , {G}_{ψ} \vert w ) = {\sum }_{{s}_{1 : N}} p ( {ρ}_{start} , {Π}_{σ} , {G}_{ψ} , {s}_{1 : N} \vert w ) ∝ {\sum }_{{s}_{1 : N}} p ( w \vert {Π}_{σ} , {G}_{ψ} , {s}_{1 : N} ) p ( {ρ}_{start} ) p ( {G}_{ψ} ) p ( {Π}_{σ} ) \vert p ( {s}_{1 : N} \vert {ρ}_{start} , {Π}_{σ} ) , \qquad ( C8 )$$

where s_{1:N}={s₁, s₂ . . . , s_{N}} denotes a system state trajectory. Now, the nonmarginal posterior:

$$p ( {ρ}_{start} , {Π}_{σ} , {G}_{ψ} , {s}_{1 : N} \vert w ) ∝ p ( w \vert {Π}_{σ} , {G}_{ψ} , {s}_{1 : N} ) p ( {ρ}_{start} ) p ( {G}_{ψ} ) p ( {Π}_{σ} ) p ( {s}_{1 : N} \vert {ρ}_{start} , {Π}_{σ} ) \qquad ( C9 )$$

can be used to sample the trajectory s_{1:N} which, in turn, allows direct sampling of the elements of propagator Π_{σ} described shortly. For priors on ρₛₜₐᵣₜ and rates in G_{ψ}, we, respectively, use a Dirichlet and Gamma distributions similar to Eq. 65-66. The system state trajectory s_{1:N} is sampled by recursively sampling the states using a forward filtering backward sampling algorithm.

Finally, for each row in the propagator Π_{σ}, a Dirichlet prior is used:

$${π}_{m} ∼ Dirichlet ( αβ ) , m = 1 , 2 , … , {M}_{σ} , \qquad ( C10 )$$

where M_{σ} is the number of system states and πₘ denotes the m-th row of the propagator. Here, the hyperparameters α and β are, respectively, the concentration parameter and a vector of length M_{σ} described in Sec. 3.2.2. Now, samples can be directly generated for the transition probability vectors πₘ of length M_{σ} via prior-likelihood conjugacy:

$${π}_{m} ∼ Dirichlet ( {n}_{m} + αβ ) , m = 1 , 2 , … , {M}_{σ}^{max} ,$$

where the vector nₘ collects the number of times each transition out of system state σₘ occurs obtained using the system state trajectory.

After constructing the posterior, inferences can be made on the parameters by drawing samples from the posterior. However, as the resulting posterior has a nonanalytical form, it cannot be directly sampled. Therefore, a Markov chain Monte Carlo sampling (MCMC) procedure is developed to draw samples from the posterior.

The MCMC procedure follows a Gibbs sampling technique sweeping through updates of the set of parameters in the following order: 1) photophysical transition rates including donor relaxation rates λ_{d} (inverse of donor lifetime), acceptor relaxation rate λₐ (inverse of acceptor lifetime), FRET rates for each system state, and excitation rate (inverse of excitation probability πₑₓ) using MH; 2) transition probabilities between system states, π_{1:M}_{_{σ}} by directly drawing samples from the posterior; 3) the system states trajectory, [symbol] , using forward backward sampling procedure; and 4) the initial probabilities ρₛₜₐᵣₜ by taking direct samples. In the end, the chains of samples drawn can be used for subsequent numerical analysis.

### 4.2.2—Inference Procedure for Pulsed Illumination: Nonparametrics Sampler

The smFRET data analysis method illustrated above assumes a given number of system states, M_{σ}. However, in many applications the number of system states is not specified a priori. Here, a generalization of the parametric method is provided to address this shortcoming and estimate the number of system states simultaneously along with other unknown parameters.

The previously-introduced parametric posterior can be modified as follows. First, suppose an infinite number of system states (M_{σ}→∞) for the likelihood introduced previously and learn the transition matrix Π_{σ}. The number of system states can then be interpreted as those appreciably visited over the course of the trajectory.

To incorporate this infinite system state space into the inference strategy, the iHMM from the BNP repertoire can be leveraged, placing a hierarchical Dirichlet process prior over the infinite set of system states as described in Sec. 3.2.2 of the present disclosure. However, dealing with an infinite number of random variables, though feasible, is not computationally efficient and this infinite value can be approximated with a large number M_{σ}^{max}, reducing the hierarchical Dirichlet process prior to:

$$β ∼ Dirichlet ( \frac{γ}{{M}_{σ}^{max}} , … , \frac{γ}{{M}_{σ}^{max}} ) , \\ {π}_{m} ∼ Dirichlet ( αβ ) , m = 1 , … , {M}_{σ}^{max} .$$

Here, β denotes the base probability vector of length M_{σ}^{max} serving itself as a prior on the probability transition matrix Π_{σ}, and πₘ is the m-th row of Π_{σ}. Moreover, γ is a positive scalar hyperparameter of the Dirichlet process prior often chosen to be one. As such, identical weights can be ascribed across the state space a priori for computational convenience.

Now, equipped with the nonparametric posterior, inferences can be made simultaneously on transition probabilities, excited state escape rates, and the remaining parameters. To do so, the Gibbs sampling scheme detailed in Sec. 3.2.2 of the present disclosure can be employed, except that the system state trajectory s_{1:N} must also be sampled.

### 4.2.3—Results

Safar et al. shows results for validation of the systems and methods discussed herein as applied to pulsed illumination. The main objective of the methods described herein is to learn full distributions over:
1) transition probabilities among Π_{σ}^{max} system states determining, in turn, the corresponding system transition rates and the effective number of system states; and
2) photophysical transition rates including FRET rates λ_{1:M}^{FRET}, and fluorophores' relaxation rates (inverse of lifetimes) λₐ and λ_{d}.

To sample from distributions over these parameters, the BNP-FRET sampler requires input data comprised of photon arrival time traces from both donor and acceptor channels as well as a set of precalibrated input parameters including: camera effects such as crosstalk matrix and detection efficiency (see Sec. 2.4 and Example V); background emission (see Sec. 2.6); and the IRF (see Sec. 2.5).

The results shown in Safar et al. indicate that the method samples posteriors over a set of parameters employing realistic synthetic data generated using the Gillespie algorithm to simulate system transitions and photophysical transitions while incorporating detector artefacts such as crosstalk (see Sec. 2.8).

Experimental results show that the method works for the simplest case of slow transitions compared to the interpulse period (25˜ns) with two system states using synthetic data. Next, more challenging synthetic data is discussed with three system states and higher transition rates. The nonparametric algorithm correctly infers system transition probabilities and thus the number of system states.

After demonstrating the performance of the method using synthetic data, experimental data is applied to investigate the kinetics of HJs under different MgCL₂ concentrations in buffer.

### 5. Computer-implemented System and Example Device

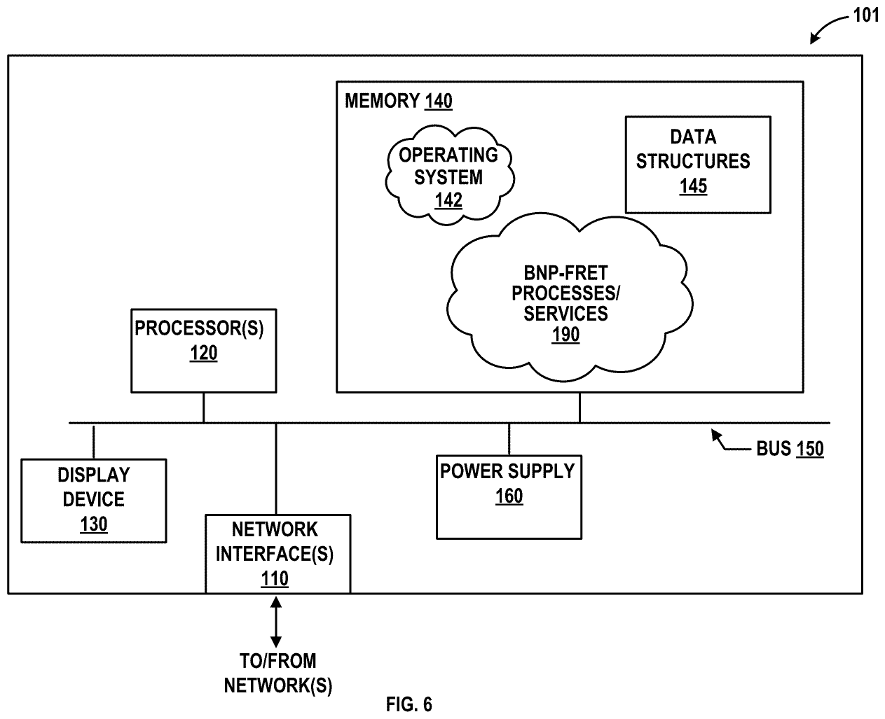

FIG. 6 is a schematic block diagram of an example device 101 that may be used with one or more embodiments described herein, e.g., as a component of system 100 discussed herein.

Device 101 comprises one or more network interfaces 110 (e.g., wired, wireless, PLC, etc.), at least one processor 120, and a memory 140 interconnected by a system bus 150, as well as a power supply 160 (e.g., battery, plug-in, etc.). Device 101 can also include or otherwise communicate with a display device 130 to communicate results of the methods outlined herein.

Network interface(s) 110 include the mechanical, electrical, and signaling circuitry for communicating data over the communication links coupled to a communication network. Network interfaces 110 are configured to transmit and/or receive data using a variety of different communication protocols. As illustrated, the box representing network interfaces 110 is shown for simplicity, and it is appreciated that such interfaces may represent different types of network connections such as wireless and wired (physical) connections. Network interfaces 110 are shown separately from power supply 160, however it is appreciated that the interfaces that support PLC protocols may communicate through power supply 160 and/or may be an integral component coupled to power supply 160.

Memory 140 includes a plurality of storage locations that are addressable by processor 120 and network interfaces 110 for storing software programs and data structures associated with the embodiments described herein. In some embodiments, device 101 may have limited memory or no memory (e.g., no memory for storage other than for programs/processes operating on the device and associated caches). Memory 140 can include instructions executable by the processor 120 that, when executed by the processor 120, cause the processor 120 to implement aspects of the system and the methods outlined herein.

Processor 120 comprises hardware elements or logic adapted to execute the software programs (e.g., instructions) and manipulate data structures 145. An operating system 142, portions of which are typically resident in memory 140 and executed by the processor, functionally organizes device 101 by, inter alia, invoking operations in support of software processes and/or services executing on the device. These software processes and/or services may include BNP-FRET processes/services 190, which can include aspects of methods and implementations of various modules described herein. Note that while BNP-FRET processes/services 190 is illustrated in centralized memory 140, alternative embodiments provide for the process to be operated within the network interfaces 110, such as a component of a MAC layer, and/or as part of a distributed computing network environment.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules or engines configured to operate in accordance with the techniques herein (e.g., according to the functionality of a similar process). In this context, the term module and engine may be interchangeable. In general, the term module or engine refers to model or an organization of interrelated software components/functions. Further, while the BNP-FRET processes/services 190 is shown as a standalone process, those skilled in the art will appreciate that this process may be executed as a routine or module within other processes.

### 5.1—Methods

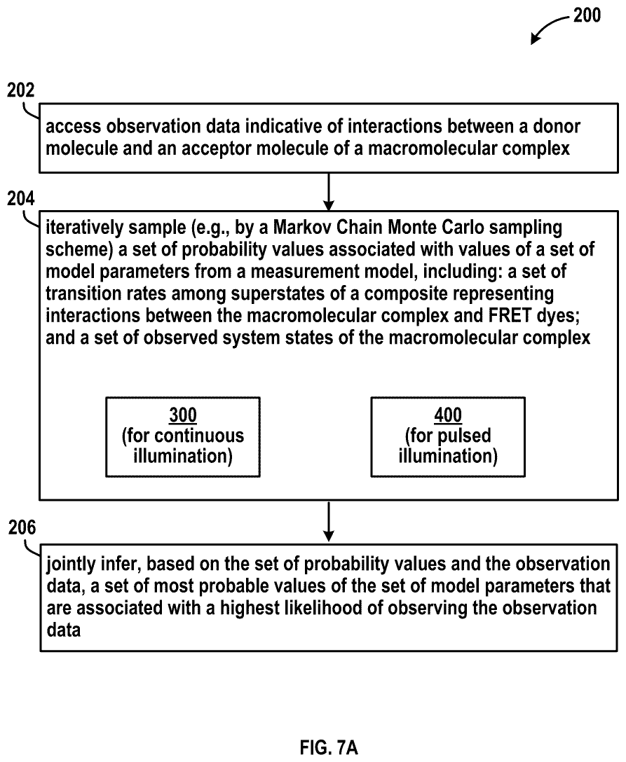

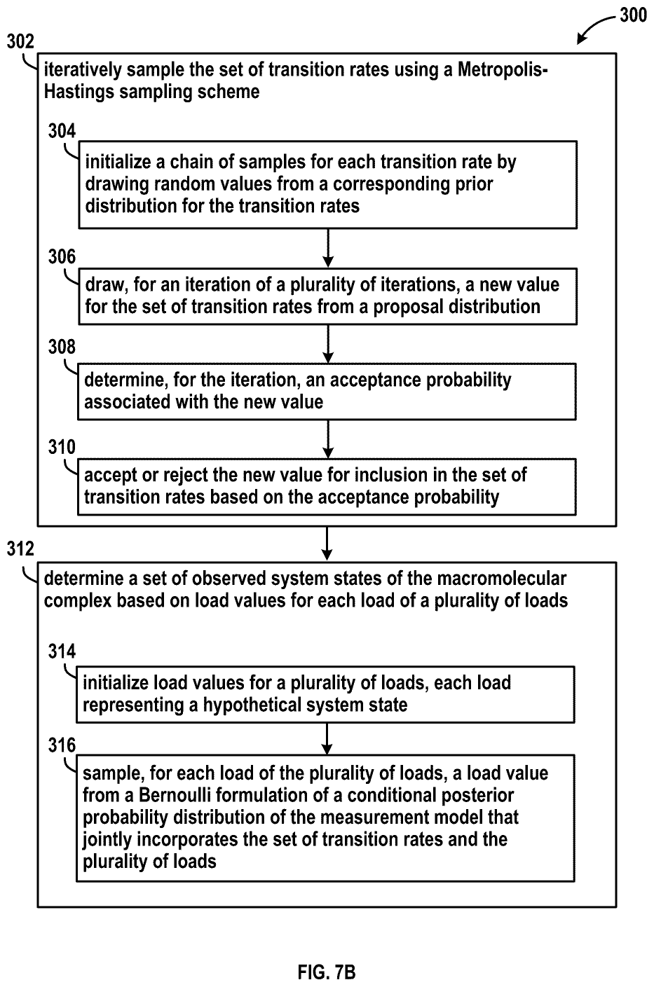

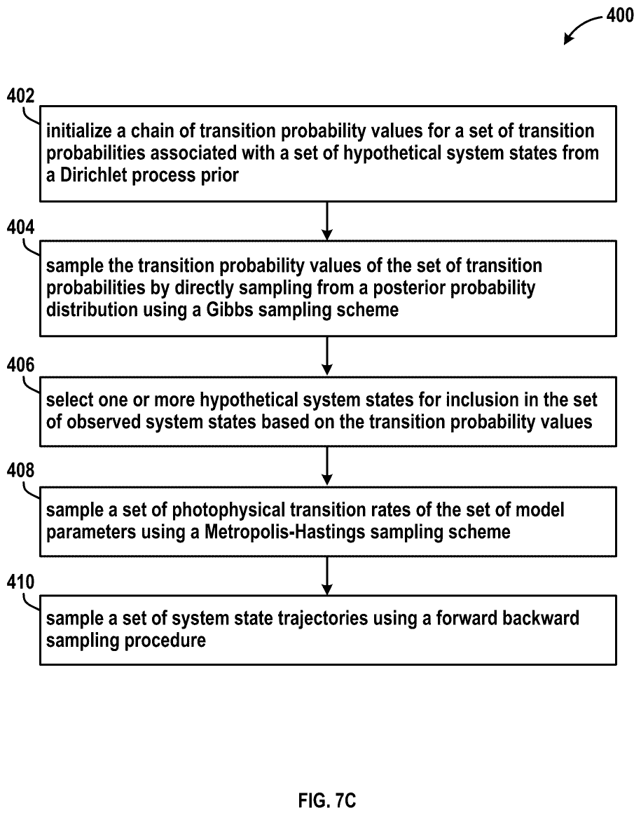

FIGS. 7A-7C are a series of process flow diagrams showing a method 200 for conducting smFRET analysis leveraging Bayesian non-parametrics as outlined herein. In particular, FIG. 7A shows a generalized outline of the method 200, which encompasses a first sub-method 300 (applicable for continuous illumination regimes, elaborated on in FIG. 7B) and a second sub-method 400 (applicable for pulsed illumination regimes, elaborated on in FIG. 7C). Method 200 (and its sub-methods 300 and 400) may be executed by the device 101 of FIG. 6 and may form part of BNP-FRET processes/services 190.

Referring to FIG. 7A, step 202 of method 200 includes accessing observation data indicative of interactions between a donor molecule and an acceptor molecule of a macromolecular complex. The observation data can include including time-series detector data indicative of photons having a wavelength within a first wavelength range (e.g., of a first color) captured at a first channel of a detector device and photons having a wavelength within a second wavelength range (e.g., of a second color) captured at a second channel of the detector device over time.

Step 204 of method 200 includes iteratively sampling (e.g., by a Markov Chain Monte Carlo (MCMC) sampling procedure) a set of probability values associated with values of a set of model parameters from a measurement model, including: a set of transition rates among superstates of a composite representing interactions between the macromolecular complex and FRET dyes; and a set of observed system states of the macromolecular complex. The measurement model is constructed using a nonparametric Bayesian formulation of a system-FRET Master Equation (e.g., Eq. (1)) descriptive of an evolution of the composite.

Step 206 of method 200 includes jointly inferring, based on the set of probability values and the observation data, a set of most probable values of the set of model parameters that are associated with a highest likelihood of observing the observation data.

Notably, step 204 may be divided into sub-steps. For continuous illumination, step 204 may be performed using method 300 outlined in FIG. 7B. For pulsed illumination (or under similar regimes), step 204 may be performed using method 400 outlined in FIG. 7C.

Referring to FIG. 7B, step 302 of method 300 includes iteratively sampling the set of transition rates using a Metropolis-Hastings sampling scheme. Step 302 can encompass steps 304-310. Step 304 can include initializing a chain of samples for each transition rate by drawing random values from a corresponding prior distribution for the transition rates. The prior distribution can include a Gamma prior (see Eq. (69)). Step 306 can include drawing, for an iteration of a plurality of iterations, a new value for the set of transition rates from a proposal distribution. Step 308 can include determining, for the iteration, an acceptance probability associated with the new value. Step 310 can include accepting or rejecting the new value for inclusion in the set of transition rates based on the acceptance probability.

Step 312 of method 300 can include determining a set of observed system states of the macromolecular complex based on load values for each load of a plurality of loads. Step 312 can encompass steps 314 and 316. Step 314 can include initializing load values for a plurality of loads using a Bernoulli process prior (see Eqs. (71) and (72)) each load representing a hypothetical system state. Step 316 can include sampling, for each load of the plurality of loads, a load value from a Bernoulli formulation (see Bernoulli formulation of Eq. (72) in Section 3.2.1) of a conditional posterior probability distribution of the measurement model that jointly incorporates the set of transition rates and the plurality of loads. Because the measurement model incorporates the set of transition rates to sample load values, steps 302-310 should be applied prior to step 316. If the load value for a load is a first value, this indicates that a corresponding hypothetical system state is active and is included in the set of observed system states; likewise, if the load value for a load is a second value, this indicates that a corresponding hypothetical system state is inactive and is to be excluded from the set of observed system states.

Following conclusion of method 300, step 206 of method 200 may be applied to infer the set of most probable values of the set of model parameters that are associated with a highest likelihood of observing the observation data (e.g., that are “warranted by the data”).

Referring to FIG. 7C, method 400 includes steps for sampling observed system states based on transition probabilities (steps 402-406) and for sampling transition rates (step 408) under pulsed illumination (e.g., where the observation data includes photon arrival times corresponding with a plurality of illumination pulses applied to the macromolecular complex, where transitions between system states occur at a beginning of each illumination pulse). Steps 402-406 may be applied simultaneously with steps 408 and 410.

Step 402 of method 400 includes initializing a chain of transition probability values for a set of transition probabilities associated with a set of hypothetical system states from a Dirichlet process prior. Step 404 of method 400 includes sampling the transition probability values of the set of transition probabilities by directly sampling from a posterior probability distribution using a Gibbs sampling scheme. Step 406 of method 400 includes selecting one or more hypothetical system states for inclusion in the set of observed system states based on the transition probability values. A high transition probability value (e.g., the “most visited” transition probabilities) means that the associated hypothetical system state should be included within the set of observed system states, and a low transition probability value means the associated system state should be excluded from in the set of observed system states.

Step 408 of method 400 includes sampling a set of photophysical transition rates of the set of model parameters using a Metropolis-Hastings sampling scheme. Step 408 can be applied similarly to steps 304-310 of FIG. 7B. Step 410 of method 400 can include sampling a set of system state trajectories using a forward backward sampling procedure.

Following conclusion of method 400, step 206 of method 200 may be applied to infer the set of most probable values of the set of model parameters that are associated with a highest likelihood of observing the observation data (e.g., that are “warranted by the data”).

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

1. A method, comprising:
accessing observation data indicative of interactions between a donor molecule and an acceptor molecule of a macromolecular complex;
iteratively sampling a set of probability values associated with values of a set of model parameters from a measurement model, including:
a set of transition rates among superstates of a composite representing interactions between the macromolecular complex and FRET dyes; and
a set of observed system states of the macromolecular complex; and
jointly inferring, based on the set of probability values and the observation data, a set of most probable values of the set of model parameters that are associated with a highest likelihood of observing the observation data.

2. The method of claim 1, the observation data including time-series detector data indicative of photons having a wavelength within a first wavelength range captured at a first channel of a detector device and photons having a wavelength within a second wavelength range captured at a second channel of the detector device over time.

3. The method of claim 1, further comprising:
applying a Markov Chain Monte Carlo sampling scheme to iteratively sample probability values associated with values of the set of model parameters of the measurement model, the measurement model being constructed using a nonparametric Bayesian formulation of a system-FRET Master Equation descriptive of an evolution of the composite.

4. The method of claim 1, further including:
determining the set of observed system states by sampling, for each load of a plurality of loads representing a hypothetical system state, a load value from a Bernoulli formulation of a conditional posterior probability distribution of the measurement model that jointly incorporates the set of transition rates and the plurality of loads, the macromolecular complex having been subjected to a continuous illumination scheme.

5. The method of claim 1, further comprising:
iteratively sampling the set of transition rates using a Metropolis-Hastings sampling scheme.

6. The method of claim 1, the observation data further including photon arrival times corresponding with a plurality of illumination pulses applied to the macromolecular complex, where transitions between system states occur at a beginning of each illumination pulse.

7. The method of claim 6, further comprising:
initializing a chain of transition probability values for a set of transition probabilities associated with a set of hypothetical system states from a Dirichlet process prior;
sampling the transition probability values of the set of transition probabilities by directly sampling from a posterior probability distribution using a Gibbs sampling scheme; and
selecting one or more hypothetical system states for inclusion in the set of observed system states based on the transition probability values.

8. The method of claim 6, further comprising:
sampling a set of photophysical transition rates of the set of model parameters using a Metropolis-Hastings sampling scheme; and
sampling a set of system state trajectories using a forward backward sampling procedure.

9. A system, comprising:
a processor in communication with a memory, the memory including instructions executable by the processor to:
access observation data indicative of interactions between a donor molecule and an acceptor molecule of a macromolecular complex, the macromolecular complex having been subjected to a continuous illumination scheme;
iteratively sample a set of probability values associated with values of a set of model parameters from a measurement model, including:
a set of transition rates among superstates of a composite representing interactions between the macromolecular complex and FRET dyes; and
a load value for each load of a plurality of loads, the load value being sampled from a Bernoulli formulation of a conditional posterior probability distribution of the measurement model that jointly incorporates the set of transition rates and the plurality of loads, each load of the plurality of loads representing a hypothetical system state;
determine a set of observed system states of the macromolecular complex based on load values for each load of the plurality of loads; and
jointly infer, based on the set of probability values and the observation data, a set of most probable values of the set of model parameters that are associated with a highest likelihood of observing the observation data.

10. The system of claim 9, the observation data including time-series detector data indicative of photons having a wavelength within a first wavelength range captured at a first channel of a detector device and photons having a wavelength within a second wavelength range captured at a second channel of the detector device over time.

11. The system of claim 9, the memory including instructions executable by the processor to:
apply a Markov Chain Monte Carlo sampling scheme to iteratively sample probability values associated with values of the set of model parameters of the measurement model, the measurement model being constructed using a nonparametric Bayesian formulation of a system-FRET Master Equation descriptive of an evolution of the composite.

12. The system of claim 9, the load value for a load of the plurality of loads being a first value indicating that a corresponding hypothetical system state is active and is included in the set of observed system states.

13. The system of claim 9, the load value for a load of the plurality of loads being a second value indicating that a corresponding hypothetical system state is inactive and is excluded from the set of observed system states.

14. The system of claim 9, the memory including instructions executable by the processor to:
iteratively sample the set of transition rates using a Metropolis-Hastings sampling scheme.

15. A system, comprising:
a processor in communication with a memory, the memory including instructions executable by the processor to:
access observation data indicative of interactions between a donor molecule and an acceptor molecule of a macromolecular complex;
iteratively sample a set of probability values associated with values of a set of model parameters from a measurement model, including:
a set of transition rates among superstates of a composite representing interactions between the macromolecular complex and FRET dyes; and
a set of transition probability values for a set of transition probabilities associated with a set of hypothetical system states, sampled from a posterior probability distribution using a Gibbs sampling scheme;
select one or more hypothetical system states for inclusion in a set of observed system states of the macromolecular complex based on the set of transition probability values; and
jointly infer, based on the set of probability values and the observation data, a set of most probable values of the set of model parameters that are associated with a highest likelihood of observing the observation data.

16. The system of claim 15, the observation data including time-series detector data indicative of photons having a wavelength within a first wavelength range captured at a first channel of a detector device and photons having a wavelength within a second wavelength range captured at a second channel of the detector device over time.

17. The system of claim 15, the memory including instructions executable by the processor to:
apply a Markov Chain Monte Carlo sampling scheme to iteratively sample probability values associated with values of the set of model parameters of the measurement model, the measurement model being constructed using a nonparametric Bayesian formulation of a system-FRET Master Equation descriptive of an evolution of the composite.

18. The system of claim 15, the observation data further including photon arrival times corresponding with a plurality of illumination pulses applied to the macromolecular complex, where transitions between system states occur at a beginning of each illumination pulse.

19. The system of claim 15, the memory including instructions executable by the processor to:
initialize a chain of transition probability values for the set of transition probabilities associated with the set of hypothetical system states from a Dirichlet process prior.

20. The system of claim 15, the memory further including instructions executable by the processor to:
sample a set of photophysical transition rates of the set of model parameters using a Metropolis-Hastings sampling scheme; and
sample a set of system state trajectories using a forward backward sampling procedure.
